(19) United States
(12) Patent Application Publication
(10) Pub. No.: US 2026/0106715 A1
(43) Pub. Date: Apr. 16, 2026

(54) SIGNALING FOR ADAPTATION OF DOWNLINK CONTROL CHANNEL

(71) Applicant: Samsung Electronics Co., Ltd., Suwon-si (KR)

(72) Inventors: Ebrahim MolavianJazi, San Jose, CA (US); Aristides Papasakellariou, Houston, TX (US)

(21) Appl. No.: 19/341,564

(22) Filed: Sep. 26, 2025

Related U.S. Application Data
(60) Provisional application No. 63/706,461, filed on Oct. 11, 2024.

(51) Int. Cl. H04L 5/00; H04W 72/232

(52) U.S. Cl. CPC H04L 5/0053; H04W 72/232

(57) ABSTRACT

Apparatuses and methods for signaling for adaptation of a downlink control channel. A method for a user equipment (UE) includes receiving, via a first radio resource control (RRC) information element, first information for a number of control resource sets (CORESETs) and receiving, via a first downlink control information (DCI) or a first medium access control (MAC) control element (CE), second information for a first number of indexes from the set of indexes. Each CORESET is associated with a respective index from a set of indexes and a respective set of parameters for reception of a physical downlink control channel (PDCCH). The method further includes determining, based on the second information, first CORESETs, from the number of CORESETs, that are associated with the first number of indexes and receiving a first PDCCH in a first CORESET, from the first CORESETs, based on a respective set of parameters.

### CROSS REFERENCE TO RELATED APPLICATIONS AND CLAIM OF PRIORITY

The present application claims priority under 35 U.S.C. § 119(e) to U.S. Provisional Patent Application No. 63/706,461 filed on Oct. 11, 2024, which is hereby incorporated by reference in their entirety.

### TECHNICAL FIELD

The present disclosure relates generally to wireless communication systems and, more specifically, the present disclosure is related to apparatuses and methods for signaling for adaptation of a downlink control channel.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to signaling for adaptation of a downlink control channel.

In one embodiment, a method for a user equipment (UE) is provided. The method includes receiving, via a first radio resource control (RRC) information element, first information for a number of control resource sets (CORESETs) and receiving, via a first downlink control information (DCI) or a first medium access control (MAC) control element (CE), second information for a first number of indexes from the set of indexes. Each CORESET is associated with a respective index from a set of indexes and a respective set of parameters for reception of a physical downlink control channel (PDCCH). The method further includes determining, based on the second information, first CORESETs, from the number of CORESETs, that are associated with the first number of indexes and receiving a first PDCCH in a first CORESET, from the first CORESETs, based on a respective set of parameters.

In another embodiment, a UE is provided. The UE includes a transceiver configured to receive, via a first RRC information element, first information for a number of CORESETs and receive, via a first DCI or a first MAC CE, second information for a first number of indexes from the set of indexes. Each CORESET is associated with a respective index from a set of indexes and a respective set of parameters for reception of a PDCCH. The UE further includes a processor operably coupled with a transceiver. The processor is configured to determine, based on the second information, first CORESETs, from the number of CORESETs, that are associated with the first number of indexes. The transceiver is further configured to receive a first PDCCH in a first CORESET, from the first CORESETs, based on a respective set of parameters.

In yet another embodiment, a base station is provided. The base station includes a transceiver configured to transmit, via a first RRC information element, first information for a number of CORESETs and transmit, via a first DCI or a first MAC CE, second information for a first number of indexes from the set of indexes. Each CORESET is associated with a respective index from a set of indexes and a respective set of parameters for reception of a PDCCH. The base station further includes a processor operably coupled with a transceiver, the processor configured to determine, based on the second information, first CORESETs, from the number of CORESETs, that are associated with the first number of indexes. The transceiver is further configured to transmit a first PDCCH in a first CORESET, from the first CORESETs, based on a respective set of parameters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example process of L1/L2 signaling that indicates a value from multiple values that are predetermined/configured for a certain CORESET parameter according to one or more embodiments of the present disclosure;

FIG. 5B illustrates an example process of L1/L2 signaling that indicates/activates a number of M≤N CORESETs from a number of N>1 configured CORESETs according to one or more embodiments of the present disclosure;

FIG. 6 illustrates an example process of L1/L2 signaling for indication of values, among corresponding higher layer configured values, for multiple groups of CORESET parameters according to one or more embodiments of the present disclosure;

FIG. 7A illustrates an example process of L1/L2 signaling for indication of a configuration index or a sub-configuration index, among multiple configurations/sub-configurations, for a CORESET according to one or more embodiments of the present disclosure;

FIG. 7B illustrates an example process of L1/L2 signaling in the form of a bitmap that activates a number of M≤N CORESETs from a number of N>1 configured CORESETs according to one or more embodiments of the present disclosure;

FIG. 8 illustrates an example process of application time for an indication by L1/L2 signaling for values of CORESET parameters according to one or more embodiments of the present disclosure;

FIG. 9 illustrates an example process of using a DCI/PDCCH as the signaling scheme for indication of a CORESET parameters according to one or more embodiments of the present disclosure;

FIG. 10 illustrates an example process of using a GC-DCI format as the signaling scheme for indication of parameters of a CORESET according to one or more embodiments of the present disclosure;

FIG. 11 illustrates an example process of using a GC-DCI format as the signaling scheme for indication of parameters of a CORESET according to one or more embodiments of the present disclosure;

FIG. 12 illustrates an example process of DCI field size determination in a GC-DCI format for indication of CORESET parameters according to one or more embodiments of the present disclosure;

FIG. 13 illustrates an example process of using a standalone UE-specific DCI format as the signaling scheme for indication of parameters of CORESETs according to one or more embodiments of the present disclosure;

FIG. 14 illustrates an example process of using a scheduling DCI format as the signaling scheme for indication of parameters of CORESETs according to one or more embodiments of the present disclosure;

FIG. 15 illustrates an example process of using a DL channel, other than a PDCCH or PDSCH, as the signaling scheme for indication of parameters of CORESETs according to one or more embodiments of the present disclosure;

FIG. 16A illustrates an example process of using the DL channel as the signaling scheme for indication of parameters of CORESETs based on an association of reception occasions of the DL channel with different CORESETs or UEs according to one or more embodiments of the present disclosure;

FIG. 16B illustrates an example multiplexing between the “DL channel” used for indication of CORESET parameters according to one or more embodiments of the present disclosure;

FIG. 16C illustrates another example of multiplexing between the “DL channel” used for indication of CORESET parameters according to one or more embodiments of the present disclosure;

FIG. 16D illustrates another example of multiplexing between the “DL channel” used for indication of CORESET parameters according to one or more embodiments of the present disclosure;

FIG. 17 illustrates an example process of a cell-specific design for the DL channel to indicate the CORESET parameters with different beams associated with different occasions or repetitions according to one or more embodiments of the present disclosure;

FIG. 18 illustrates an example process of a UE-group-specific design for the DL channel to indicate the CORESET parameters using different time/frequency occasions or different beams or cover codes for different groups of UEs according to one or more embodiments of the present disclosure;

FIG. 19 illustrates an example process of energy saving for the DL channel by higher layer disabling or L1-based skipping of the DL channel reception occasions according to one or more embodiments of the present disclosure; and

FIG. 20 illustrates an example process of energy saving for the DL channel by skipping indication provided within the information content of the new DL channel according to one or more embodiments of the present disclosure.

### DETAILED DESCRIPTION

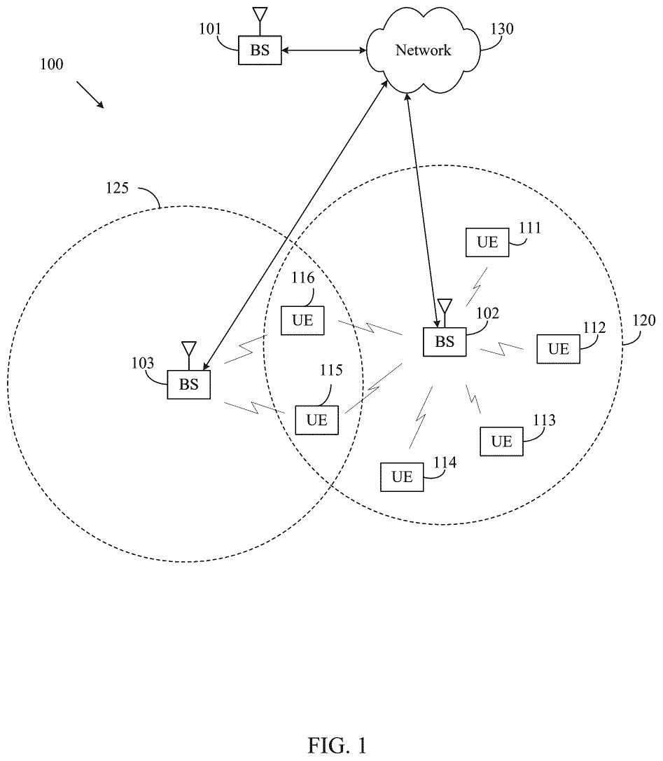

FIGS. 1-20 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 Rel-18 v18.4.0, “NR; Physical channels and modulation;” [REF 2]3GPP TS 38.212 Rel-18 v18.4.0, “NR; Multiplexing and channel coding;” [REF 3]3GPP TS 38.213 Rel-18 v18.4.0, “NR; Physical layer procedures for control;” [REF 4]3GPP TS 38.214 Rel-18 v18.4.0, “NR; Physical layer procedures for data;” [REF 5]3GPP TS 38.215 Rel-18 v18.4.0, “NR; Physical layer measurements;” [REF 6]3GPP TS 38.321 Rel-18 v18.3.0, “NR; Medium Access Control (MAC) protocol specification;” [REF 7]3GPP TS 38.331 Rel-18 v18.3.0, “NR; Radio Resource Control (RRC) protocol specification;” and [REF 8]3GPP TS 38.300 Rel-18 v18.3.0, “NR; NR and NG-RAN Overall Description; Stage 2.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and/or utilizing signaling for adaptation of a downlink control channel. In certain embodiments, one or more of the BSs 101-103 include circuitry, programing, or a combination thereof to support signaling for adaptation of a downlink control channel.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

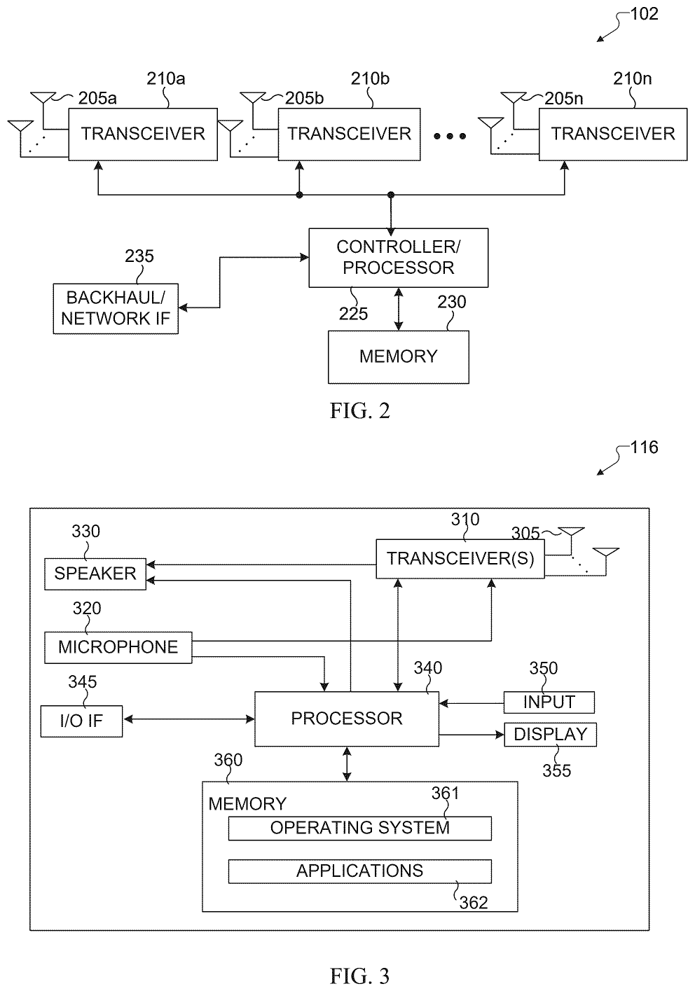

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as signaling for adaptation of a downlink control channel. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet).

The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying and/or using signaling for adaptation of a downlink control channel as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

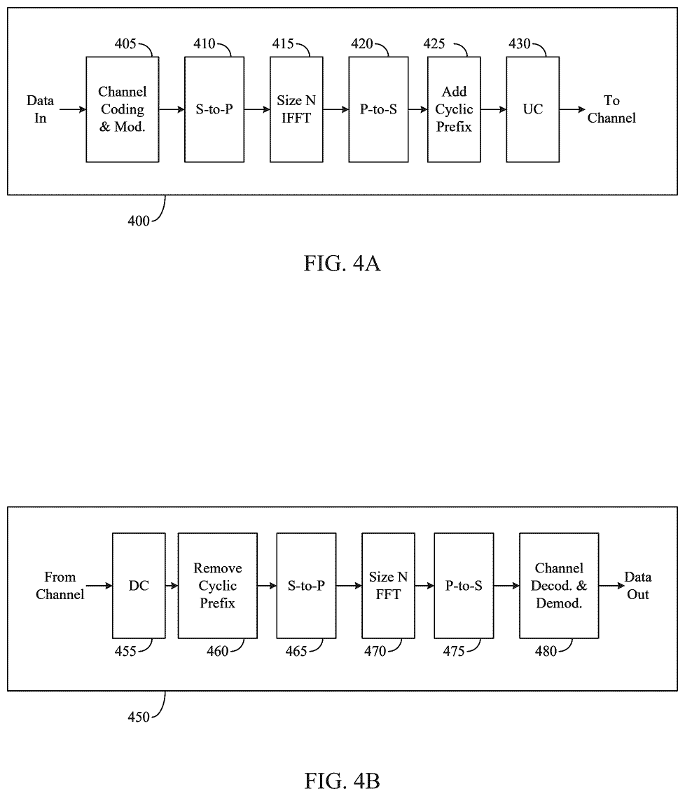

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support signaling for adaptation of a downlink control channel as described in embodiments of the present disclosure. In some embodiments, the receive path 450 is configured to support signaling for adaptation of a downlink control channel as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

In the following, unless otherwise noted, a parameter referenced in italics is provided by higher layers such as by RRC.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). A PCell is always associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

Measurement time resource(s) for SSB-based RSRP measurements may be confined within a SSB Measurement Time Configuration (SMTC). The SMTC configuration provides a measurement window periodicity/duration/offset information for UE RRM measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to all groups of resource blocks belonging to the same L2 PDU scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
MIB contains cell barred status information and essential physical layer information of the cell required to receive further system information, e.g. CORESET #0 configuration. MIB is periodically broadcast on BCH.
SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses all SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC_INACTIVE state through Paging messages, and to notify UEs in RRC_IDLE, RRC_INACTIVE and RRC_CONNECTED state of system information change and ETWS/CMAS indications through Short Messages. Both Paging messages and Short Messages are addressed with P-RNTI on PDCCH, but while the former is sent on PCCH, the latter is sent over PDCCH directly (see clause 6.5 of TS 38.331).

A set of PDCCH candidates for a UE to monitor is defined in terms of PDCCH search space sets. A search space set can be a CSS set or a USS set.

For each DL BWP configured to a UE in a serving cell, the UE can be provided by higher layer signalling with
P≤3 CORESETs if coresetPoolIndex is not provided, or if a value of coresetPoolIndex is same for all CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetId or by controlResourceSetId-v1610, where
0<p<12 if coresetPoolIndex is not provided, or if a value of coresetPoolIndex is same for all CORESETs if coresetPoolIndex is provided;
0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect
to be configured a set of resource blocks of a CORESET that includes more than four sub-sets of resource blocks that are not contiguous in frequency
any RE of a CORESET to overlap with any RE determined from
Ite-CRS-ToMatchAround or LTE-CRS-PatternList, if the UE is not provided pdcchCandidateReception-WithCRSOverlap, or
a SS/PBCH block.

If a UE is provided two TCI states indicating quasi co-location information of the DM-RS antenna port for PDCCH reception in a CORESET associated with a Type3-PDCCH CSS set, the UE may assume the quasi co-location information indicated in both of the two TCI states for the PDCCH reception in the CORESET.

For each CORESET in a DL BWP of a serving cell, a respective frequencyDomainResources provides a bitmap
if a CORESET is not associated with any search space set configured with freqMonitorLocations, the bits of the bitmap have a one-to-one mapping with non-overlapping groups of 6 consecutive PRBs, in ascending order of the PRB index in the DL BWP bandwidth of

$${N}_{R B}^{BWP}$$

PRBs with starting common RB position

$${N}_{BWP}^{start} ,$$

where the first common RB of the first group of 6 PRBs has common RB index

$$6 \cdot ⌈ {N}_{BWP}^{s t a r t} / 6 ⌉$$

if rb-Offset is not provided, or the first common RB of the first group of 6 PRBs has common RB index

$${N}_{BWP}^{s t a r t} + {N}_{R B}^{offset}$$

where

$${N}_{R B}^{offset}$$

is provided by rb-Offset.
if a CORESET is associated with at least one search space set configured with freqMonitorLocations, the first

$${N}_{RBG , set 0}^{s i z e}$$

bits of the bitmap have a one-to-one mapping with non-overlapping groups of 6 consecutive PRBs, in ascending order of the PRB index in each RB set k in the DL BWP bandwidth of

$${N}_{R B}^{BWP}$$

PRBs with starting common RB position

$$R {B}_{s 0 + k , DL}^{s t a rt , μ}$$

[6, TS 38.214], where the first common RB of the first group of 6 PRBs has common RB index

$$R {B}_{s 0 + k , DL}^{s t a rt , μ} + {N}_{R B}^{offset}$$

and k is indicated by freqMonitorLocations if provided for a search space set; otherwise, k=0.

$${N}_{R B G , s e t 0}^{s i z e} = ⌊ ( {N}_{RB , set 0}^{s i z e} - {N}_{R B}^{offset} ) / 6 ⌋ , {N}_{RB , set 0}^{s i z e}$$

is a number of available PRBs in the RB set 0 for the DL BWP, and

$${N}_{R B}^{offset}$$

is provided by rb-Offset or

$${N}_{R B}^{offset} = 0$$

if rb-Offset is not provided. If a UE is provided RB sets in the DL BWP, the UE expects that the RBs of the CORESET are within the union of the PRBs in the RB sets of the DL BWP.

For each CORESET provided by cfr-ConfigMCCH-MTCH or cfr-ConfigMCCH-MTCH-RedCap or cfr-ConfigMulticast in a CFR of a serving cell, the quantities

$${N}_{R B}^{BWP} and {N}_{BWP}^{start}$$

in this clause are replaced by the size of CFR

$${N}_{CFR}^{start}$$

and starting common RB position of CFR

$${N}_{CFR}^{start} ,$$

respectively.

For a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList and has not received a MAC CE activation command for one of the TCI states as described in [11, TS 38.321], the UE assumes that the DM-RS antenna port associated with PDCCH receptions is quasi co-located with the SS/PBCH block the UE identified during the initial access procedure, or for a most recent configured grant PUSCH transmission as described in clause 19 for a same HARQ process;
if a UE has been provided a configuration of more than one TCI states by tci-StatesPDCCH-ToAddList and tci-StatesPDCCH-ToReleaseList for the CORESET as part of Reconfiguration with sync procedure as described in [12, TS 38.331] and has not received a MAC CE activation command for one of the TCI states as described in [11, TS 38.321], the UE assumes that the DM-RS antenna port associated with PDCCH receptions is quasi co-located with the SS/PBCH block or the CSI-RS resource the UE identified during the random access procedure initiated by the Reconfiguration with sync procedure as described in [12, TS 38.331].

For a CORESET with index 0,
if the UE is provided TCI-State and followUnifiedTCI-State for the CORESET, the UE assumes that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the indicated TCI-State [6, TS 38.214]
else if the UE is provided dl-OrJointTCI-StateList and is indicated a first TCI-State and a second TCI-State, and apply-IndicatedTCIState for the CORESET
if the CORESET is associated with a Type 0/0A/2-PDCCH CSS set that has search space set index 0
if apply-IndicatedTCIState=‘first’, the UE assumes that a DM-RS antenna port for PDCCH receptions in the CORESET is quasi co-located with the reference signals provided by the first TCI-State,
if apply-IndicatedTCIState=‘second’, the UE assumes that a DM-RS antenna port for PDCCH receptions in the CORESET is quasi co-located with the reference signals provided by the second TCI-State,
if apply-IndicatedTCIState=‘none’, the UE assumes that a DM-RS antenna port for PDCCH receptions in the CORESET is quasi co-located with the one or more DL RS configured by a TCI state, where the TCI state is indicated by a MAC CE activation command for the CORESET, if any
else
if apply-IndicatedTCIState=‘first’, the UE assumes that a DM-RS antenna port for PDCCH receptions in the CORESET is quasi co-located with the reference signals provided by the first TCI-State,
if apply-IndicatedTCIState=‘second’, the UE assumes that a DM-RS antenna port for PDCCH receptions in the CORESET is quasi co-located with the reference signals provided by the second TCI-State,
if apply-IndicatedTCIState=‘both’, the UE assumes that a DM-RS antenna port for PDCCH receptions in the CORESET is quasi co-located with the reference signals provided by the first and the second TCI-State,
if apply-IndicatedTCIState=‘none’, the UE assumes that a DM-RS antenna port for PDCCH receptions in the CORESET is quasi co-located with the one or more DL RS configured by a TCI state, where the TCI state is indicated by a MAC CE activation command for the CORESET.
else, the UE assumes that a DM-RS antenna port for PDCCH receptions in the CORESET is quasi co-located with
the one or more DL RS configured by a TCI state, where the TCI state is indicated by a MAC CE activation command for the CORESET, if any, or
a SS/PBCH block the UE identified during a most recent random access procedure not initiated by a PDCCH order that triggers a contention-free random access procedure, if no MAC CE activation command indicating a TCI state for the CORESET is received after the most recent random access procedure, or a SS/PBCH block the UE identified during a most recent configured grant PUSCH transmission as described in clause 19.

For a CORESET other than a CORESET with index 0, if a UE is provided a single TCI state for a CORESET, or if the UE receives a MAC CE activation command for one or two of the provided TCI states for a CORESET, the UE assumes that the DM-RS antenna port associated with PDCCH receptions in the CORESET is quasi co-located with the one or more DL RS configured by the TCI states. For a CORESET with index 0, the UE expects that a CSI-RS configured with qcl-Type set to ‘typeD’ in a TCI state indicated by a MAC CE activation command for the CORESET is provided by a SS/PBCH block
if the UE receives a MAC CE activation command for one of the TCI states, the UE applies the activation command in the first slot that is after slot

$$k + 3 {N}_{slot}^{subframe , μ} + {2}^{μ} \cdot {k}_{mac}$$

where k is the slot where the UE would transmit a PUCCH with HARQ-ACK information for the PDSCH providing the activation command, μ is the SCS configuration for the PUCCH in the slot when the activation command is applied, and k_{mac} is a number of slots for SCS configuration μ=0 provided by kmac or k_{mac}=0 if kmac is not provided.

If a UE is provided TCI-State in dl-OrJointTCI-StateList, a DM-RS antenna port for PDCCH receptions in a CORESET, other than a CORESET with index 0, associated only with USS sets and/or Type3-PDCCH CSS sets, and a DM-RS antenna port for PDSCH receptions scheduled by DCI formats provided by PDCCH receptions in the CORESET are quasi co-located with reference signals provided by the indicated TCI-State [6, TS 38.214].

If a UE is provided followUnifiedTCI-State for a CORESET, other than a CORESET with index 0, associated at least with CSS sets other than Type3-PDCCH CSS sets, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated TCI-State.

If a UE is provided dl-OrJointTCI-StateList and is indicated a first TCI-State and a second TCI-State, and is provided apply-IndicatedTCIState for a CORESET, other than a CORESET with index 0,
if the CORESET is associated only with USS sets and/or Type3-PDCCH CSS sets
if apply-IndicatedTCIState=‘first’, the UE assumes that a DM-RS antenna port for PDCCH receptions in the CORESET is quasi co-located with the reference signals provided by the first TCI-State
if apply-IndicatedTCIState=‘second’, the UE assumes that a DM-RS antenna port for PDCCH receptions in the CORESET is quasi co-located with the reference signals provided by the second TCI-State
if apply-IndicatedTCIState=‘both’, the UE assumes that a DM-RS antenna port for PDCCH receptions in the CORESET is quasi co-located with the reference signals provided by the first TCI-State and the second TCI-State
if the CORESET is associated at least with CSS sets other than Type3-PDCCH CSS sets,
if apply-IndicatedTCIState=‘first’, the UE assumes that a DM-RS antenna port for PDCCH receptions in the CORESET is quasi co-located with the reference signals provided by the first TCI-State
if apply-IndicatedTCIState=‘second’, the UE assumes that a DM-RS antenna port for PDCCH receptions in the CORESET is quasi co-located with the reference signals provided by the second TCI-State
if apply-IndicatedTCIState=‘both’, the UE assumes that a DM-RS antenna port for PDCCH receptions in the CORESET is quasi co-located with the reference signals provided by the first TCI-State and the second TCI-State
if apply-IndicatedTCIState=‘none’, the UE assumes that a DM-RS antenna port for PDCCH receptions in the CORESET is quasi co-located with the one or more DL RS configured by a TCI state indicated by a MAC CE activation command for the CORESET

If the UE is provided dl-OrJointTCI-StateList and
is not provided coresetPoolIndex or is provided coresetPoolIndex with a value of 0 for first CORESETs on an active DL BWP of a serving cell,
is provided coresetPoolIndex with a value of 1 for second CORESETs on the active DL BWP of the serving cells, and
is provided followUnifiedTCI-State for the first and second CORESETs, that do not include a CORESET with index 0 and are associated only with USS sets and/or Type3-PDCCH CSS sets, or with CSS sets other than Type3-PDCCH CSS sets, the UE
assumes that DM-RS antenna ports for PDCCH receptions in the first and second CORESETs, and DM-RS antenna ports for PDSCH receptions scheduled by DCI formats provided by PDCCH receptions in the first and second CORESETs, are quasi co-located with the reference signals provided by indicated TCI-State specific to the first and second CORESETs, respectively
transmits PUSCH scheduled by DCI formats provided by PDCCH receptions in the first and second CORESETs using a spatial domain filter corresponding to TCI-State or TCI-UL-State specific to the first and second CORESETs, respectively.

If a UE is provided two coresetPoolIndex values 0 and 1 for first and second CORESETs, or is not provided coresetPoolIndex value for first CORESETs and is provided coresetPoolIndex value of 1 for second CORESETs, respectively, a MAC CE command activating TCI states for the first or second CORESETs [11, TS 38.321] can include coresetPoolIndex value 0 or 1
if the UE is provided SSB_MTC_AdditionalPCI, the activated TCI states for the first and/or the second CORESETs are for physCellId from ServingCellConfigCommon and the activated TCI states for either the first or the second CORESETs can be for physCellId from additionalPCI.

If a UE is provided by simultaneousTCI-UpdateList1 or simultaneousTCI-UpdateList2 up to two lists of cells for simultaneous TCI state activation, the UE applies the antenna port quasi co-location provided by one or two TCI-State each with same activated tci-StateID value, to CORESETs with a same index in all configured DL BWPs of all configured cells in a list determined from a serving cell index, where one or two tci-StateID, the CORESET index, and the serving cell index are provided by a MAC CE command.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId or by controlResourceSetId-v1610
a PDCCH monitoring periodicity of kₛ slots and a PDCCH monitoring offset of oₛ slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
a size of the group of slots is same as a size of monitoringSlotsWithinSlotGroup
for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
for a Type1-PDCCH CSS set provided by ra-SearchSpace in SIB1, the PDCCH monitoring pattern indicates only up to 1 slot in the group of slots for PDCCH monitoring
for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
number of PDCCH candidates

$${M}_{s}^{( L )}$$

per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
an indication by dci-Format0-0-AndFormat1-0 to monitor PDCCH candidates for DCI format 0_0 and DCI format 1_0
an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
an indication by dci-Format2-1 to monitor PDCCH candidates for DCI format 2_1
an indication by dci-Format2-2 to monitor PDCCH candidates for DCI format 2_2
an indication by dci-Format2-3 to monitor PDCCH candidates for DCI format 2_3
an indication by dci-Format2-4 to monitor PDCCH candidates for DCI format 2_4
an indication by dci-Format2-6 to monitor PDCCH candidates for DCI format 2_6
an indication by dci-Format2-9 to monitor PDCCH candidates for DCI format 2_9
an indication by dci-Format4-0 to monitor PDCCH candidates for DCI format 4_0
an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set,
an indication by dci-Formats to monitor PDCCH candidates either for DCI format 0_0 and DCI format 1_0, or for DCI format 0_1 and DCI format 1_1, or
an indication by dci-FormatsExt to monitor PDCCH candidates for DCI format 0_2 and DCI format 1_2, or for DCI format 0_1, DCI format 1_1, DCI format 0_2, and DCI format 1_2, or
an indication by dci-FormatsMC to monitor PDCCH candidates for one or both of DCI format 0_3 and DCI format 1_3, or
an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8
a bitmap by freqMonitorLocations, if provided, to indicate an index of one or more RB sets for the search space set s, where the MSB k in the bitmap corresponds to RB set k−1 in the DL BWP. For RB set k indicated in the bitmap, the first PRB of the frequency domain monitoring location confined within the RB set is given by

$${RB}_{s 0 + k , DL}^{start , μ} + {N}_{RB}^{offset} ,$$

where

$${RB}_{s 0 + k , DL}^{start , μ}$$

is the index of first common RB of the RB set k [6, TS 38.214], and

$${N}_{RB}^{offset}$$

is provided by rb-Offset or

$${N}_{RB}^{offset} = 0$$

if rb-Offset is not provided. For each RB set with a corresponding value of 1 in the bitmap, the frequency domain resource allocation pattern for the monitoring location is determined based on the first

$${N}_{RBG , set 0}^{size}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ}$$

[4, TS 38.211] in a frame with number n_{f} if

$$( {n}_{f} {N}_{slot}^{frame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor PDCCH candidates for search space set s for the next kₛ-Tₛ consecutive slots. If monitoringSlotsWithinSlotGroup is provided, for search space set s, the UE determines that the slot with number

$${n}_{s , f}^{μ}$$

[4, TS 38.211] in a frame with number n_{f} satisfying

$$( {n}_{f} {N}_{slot}^{frame , μ} + {n}_{s , f}^{μ} - {o}_{s} ) mod {k}_{s} = 0$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ} ,$$

and does not monitor PDCCH candidates for search space set s for the next kₛ-Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by

$$L \cdot \{ ( {Y}_{p , {n}_{s , f}^{μ}} + ⌊ \frac{{m}_{s , {n}_{CI}}^{( L )} \cdot {N}_{C C E , p}}{L \cdot {M}_{s , max}^{( L )}} ⌋ + {n}_{CI} ) mod ⌊ {N}_{C C E , p} / L ⌋ \} + i$$

where
for any CSS,

$${Y}_{p , {n}_{s , f}^{μ}} = 0 ;$$

for a USS

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per RB set
   for CORESET 0, the CCEs are obtained prior to puncturing, if any, of corresponding RBs [4, TS 38.211];
n_{CI} is
   the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
   the nCI-Value provided for the set of serving cells MC-DCI-SetofCells, if MC-DCI-SetofCells is provided;
   otherwise, including for any CSS,

$${n}_{CI} = 0$$

$${m}_{s , {n}_{CI}}^{( L )} = 0 , … , {M}_{s , {n}_{CI}}^{( L )} - 1 , where {M}_{s , {n}_{CI}}^{( L )}$$

is the number of PDCCH candidates the UE is configured to monitor for aggregation level L of a search space set s for a serving cell corresponding to n_{CI};
for any CSS,

$${M}_{s , max}^{( L )} = {M}_{s , 0}^{( L )} ;$$

for any USS,

$${M}_{s , max}^{( L )}$$

is the maximum of

$${M}_{s , {n}_{CI}}^{( L )}$$

over all configured n_{CI} values for a CCE aggregation level L of search space set s; and
the RNTI value used for n_{RNTI} is the C-RNTI.

For search space sets sᵢ and sⱼ that include searchSpaceLinkingId with same value, a UE monitors, in monitoring occasions with same index according to each of search space sets sᵢ and sⱼ in a slot, PDCCH candidates

$${m}_{{s}_{i} , {n}_{CI}}^{( L )} and {m}_{{s}_{j} , {n}_{CI}}^{( L )} , with {m}_{{s}_{i} , {n}_{CI}}^{( L )} = {m}_{{s}_{j} , {n}_{CI}}^{( L )} ,$$

for detection of a DCI format with same information. The UE expects kₛ_{ᵢ}=kₛ_{ⱼ}, oₛ_{ᵢ}=oₛ_{ⱼ}, Tₛ_{ᵢ}=Tₛ_{ⱼ},

$${M}_{{s}_{i}}^{( L )} = {M}_{{s}_{j}}^{( L )} ,$$

and a same number of non-overlapping PDCCH monitoring occasions per slot based on corresponding monitoringSymbolsWithinSlot, for search space sets sᵢ and sⱼ. For CORESET pᵢ associated with the search space set sᵢ and for CORESET pⱼ associated with the search space set sⱼ, the UE is provided tci-PresentInDCI or tci-PresentDCI-1-2 for either none or both of CORESETs pᵢ and pⱼ. For CORESET pᵢ associated with the search space set sᵢ and for CORESET pⱼ associated with the search space set sⱼ, the UE is either not provided coresetPoolIndex value of 1 for any of the two CORESETs, or is provided coresetPoolIndex value of 1 for both CORESETs.

A UE can indicate by numBD-twoPDCCH-r17 a capability for counting PDCCH candidates

$${m}_{{s}_{i} , {n}_{CI}}^{( L )} and {m}_{{s}_{j} , {n}_{CI}}^{( L )}$$

either as 2 PDCCH candidates or as 3 PDCCH candidates.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP.

A UE does not expect to detect, in a same PDCCH monitoring occasion, a DCI format with CRC scrambled by a SI-RNTI, RA-RNTI, MsgB-RNTI, TC-RNTI, P-RNTI, C-RNTI, CS-RNTI, MCS-RNTI, MCCH-RNTI, G-RNTI, G-CS-RNTI, or multicast-MCCH-RNTI and a DCI format with CRC scrambled by a SL-RNTI or a SL-CS-RNTI for scheduling respective PDSCH reception and PSSCH transmission on a same serving cell.

Table 10.1-2 provides the maximum number of monitored PDCCH candidates,

$${M}_{PDCCH}^{max , slot , μ} ,$$

per slot for a UE in a DL BWP with SCS configuration μ for operation with a single serving cell.

TABLE 10.1-2
$Maximum number {M}_{PDCCH}^{max , slot , μ} of monitored PDCCH candidates per slot for a DL BWP with$
SCS configuration μ ∈ {0, 1, 2, 3} for a single serving cell

| | Maximum number of monitored PDCCH candidates per slot and per serving cell |
|---|---|
| μ | ${M}_{PDCCH}^{max , slot , μ}$ |
| 0 | 44 |
| 1 | 36 |
| 2 | 22 |
| 3 | 20 |

Table 10.1-3 provides the maximum number of non-overlapped CCEs,

$${C}_{PDCCH}^{max , slot , μ} ,$$

for a DL BWP with SCS configuration μ that a UE is expected to monitor corresponding PDCCH candidates per slot for operation with a single serving cell.

CCEs for PDCCH candidates are non-overlapped if they correspond to
different CORESET indexes, or
different first symbols for the reception of the respective PDCCH candidates.

TABLE 10.1-3
$Maximum number {C}_{PDCCH}^{max , slot , μ} of non - overlapped CCEs per slot for a DL BWP with SCS$
configuration μ ∈ {0, 1, 2, 3} for a single serving cell

| | Maximum number of non-overlapped CCEs per slot and per serving cell |
|---|---|
| μ | ${C}_{PDCCH}^{max , slot , μ}$ |
| 0 | 56 |
| 1 | 56 |
| 2 | 48 |
| 3 | 32 |

For the following procedures in this clause, downlink cells are scheduled cells on which a UE is provided search space sets.

If a UE
does not report pdcch-BlindDetectionCA, pdcch-BlindDetectionCA1, pdcch-BlindDetectionCA2, or pdcch-BlindDetectionCA3, or is not provided BDFactorR, γ=R
reports pdcch-BlindDetectionCA, pdcch-BlindDetectionCA1, pdcch-BlindDetectionCA2, or pdcch-BlindDetectionCA3, the UE can be indicated by BDFactorR either γ=1 or γ=R

If a UE is configured with

$${N}_{cells , 0}^{D L , μ} + {N}_{cells , 1}^{D L , μ}$$

downlink cells for which the UE is not provided monitoringCapabilityConfig, or is provided monitoringCapabilityConfig=r15monitoringcapability and is not provided CORESETPoolIndex, with associated PDCCH candidates monitored in the active DL BWPs of the scheduling cells using SCS configuration μ where

$${\sum }_{μ = 0}^{3} ( {N}_{cells , 0}^{D L , μ} + γ \cdot {N}_{cells , 1}^{D L , μ} ) \leq {N}_{cells}^{cap} ,$$

the UE is not required to monitor, on the active DL BWPs of the scheduling cells
more than

$${M}_{P D C C H}^{t otal , slot , μ} = {M}_{P D C C H}^{max , slot , μ}$$

PDCCH candidates or more than

$${C}_{P D C C H}^{t otal , slot , μ} = {C}_{P D C C H}^{max , slot , μ}$$

non-overlapped CCEs per slot for each scheduled cell when the scheduling cell is from the N

$${N}_{cells , 0}^{DL , μ}$$

downlink cells, or
more than

$${M}_{P D C C H}^{t otal , slot , μ} = γ \cdot {M}_{P D C C H}^{max , slot , μ}$$

PDCCH candidates or more than

$${C}_{P D C C H}^{t otal , slot , μ} = γ \cdot {C}_{P D C C H}^{max , slot , μ}$$

non-overlapped CCEs per slot for each scheduled cell when the scheduling cell is from the

$${N}_{cells , 1}^{D L , μ}$$

downlink cells
more than

$${M}_{PDCCH}^{max , slot , μ}$$

PDCCH candidates or more than

$${C}_{P D C C H}^{max , slot , μ}$$

non-overlapped CCEs per slot for CORESETs with same coresetPoolIndex value for each scheduled cell when the scheduling cell is from the

$${N}_{cells , 1}^{D L , μ}$$

downlink cells

### If a UE

is configured with

$${N}_{cells , 0}^{D L , μ} + {N}_{cells , 1}^{D L , μ}$$

downlink cells for which the UE is not provided monitoringCapabilityConfig, or is provided monitoringCapabilityConfig=r15monitoringcapability and is not provided coresetPoolIndex,
with associated PDCCH candidates monitored in the active DL BWPs of the scheduling cell(s) using SCS configuration μ, where

$${\sum }_{μ = 0}^{3} ( {N}_{cells , 0}^{D L , μ} + γ \cdot {N}_{cells , 1}^{D L , μ} ) > {N}_{cells}^{c a p} ,$$

and
a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , slot , μ} = ⌊ {N}_{cells}^{c a p} \cdot {M}_{P D C C H}^{max , slot , μ} \cdot ( {N}_{cells , 0}^{D L , μ} + γ \cdot {N}_{cells , 1}^{D L , μ} ) / {\sum }_{j = 0}^{3} ( {N}_{cells , 0}^{D L , j} + γ \cdot {N}_{cells , 1}^{D L , j} ) ⌋$$

PDCCH candidates or more than

$${C}_{PDCCH}^{total , slot , μ} = ⌊ {N}_{cells}^{c a p} \cdot {C}_{P D C C H}^{max , slot , μ} \cdot ( {N}_{cells , 0}^{D L , μ} + γ \cdot {N}_{cells , 1}^{D L , μ} ) / {\sum }_{j = 0}^{3} ( {N}_{cells , 0}^{D L , j} + γ \cdot {N}_{cells , 1}^{D L , j} ) ⌋$$

non-overlapped CCEs per slot on the active DL BWP(s) of scheduling cell(s) from the

$${N}_{cells , 0}^{D L , μ} + {N}_{cells , 1}^{D L , μ}$$

downlink cells.

For each scheduled cell from the

$${N}_{cells , 0}^{DL , μ}$$

downlink cells, the UE is not required to monitor on the active DL BWP with SCS configuration μ of the scheduling cell more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot.

For each scheduled cell from the

$${N}_{cells , 1}^{DL , μ}$$

downlink cells, the UE is not required to monitor on the active DL BWP with SCS configuration μ of the scheduling cell
more than

$$min ( γ \cdot {M}_{PDCCH}^{max , slot , μ} , {M}_{PDCCH}^{total , slot , μ} )$$

PDCCH candidates or more than

$$min ( γ \cdot {C}_{PDCCH}^{max , slot , μ} , {C}_{PDCCH}^{total , slot , μ} )$$

non-overlapped CCEs per slot
more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot for CORESETs with same coresetPoolIndex value

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for certain cases as specified in TS 38.213 [REF3] or monitors PDCCH according to the search space sets applied in SSSG.

In PDCCH skipping, a field in DCI format, such as a DCI format 0_1/0_2/0_3 that schedules PUSCH transmission, or a DCI format 1_1/1_2/1_3 that schedules PDSCH reception, can also include a PDCCH monitoring adaptation field that indicates to the UE to skip PDCCH monitoring according to Type-3 CSS sets and USS sets for a time duration, such as a number of slots.

In SSSG switching, the UE can be configured multiple, such as 3, SSSGs, and a field in a DCI format, such as a DCI format 2_0 can indicate an applicable/active SSSG, from the multiple SSSGs, for PDCCH monitoring. For example, the UE does not monitor PDCCH according to search space sets that are not included in the indicated SSSG. A timer may be also configured for SSSG switching.

Spectral efficiency (SE) is one of the key performance indicator (KPIs) for a wireless system. Among other factors, an increase in SE can be achieved by decreasing the system overhead, such as RSs and control signaling, that assist with scheduling and reception/transmission of the data.

As resources allocated for control signaling, such as for the PDCCH, cannot be used for data transmission, it is beneficial to maximize the use of control resources and reduce the resource allocation to control signaling when few or no PDCCH is to be transmitted.

In 4G LTE, PDCCH is transmitted in a control region that spans the entire carrier bandwidth and starts in the second OFDM symbol of a slot/subframe and can have a duration of 1 or 2 or 3 symbols. A physical control format indicator channel (PCFICH) is used to indicate the number of OFDM symbols (among values 1, 2, or 3) for the control region. The PCFICH is transmitted in the first OFDM symbol of every slot/subframe, and using 16 REs or 4 REGs that are evenly distributed across the carrier bandwidth. Therefore, LTE PCFICH enables a dynamic indication of the control region in time domain.

In 5G NR, PDCCH is transmitted in a control resource set (CORESET) with a time domain resource allocation (from 1 or 2 or 3 symbols) and a frequency domain resource allocation (using a bitmap with CCE granularity to indicate parts of or the entire bandwidth of a DL BWP) that is configured by higher layers, such as SIB or RRC signaling. As such, there is fine granularity of resource allocation for CORESET in 5G NR, but there is no support for dynamic indication of the CORESET parameters.

Similar considerations can apply to other CORESET parameters beyond time-frequency resource allocation, such as TCI state or interleaving.

Embodiments of the present disclosure recognize that there is a need to increase SE by adapting the resource allocation for DL control signaling to the cell load, traffic profile, and so on. Embodiments of the present disclosure also recognize that there is a need for dynamic indication of CORESET parameters. Embodiments of the present disclosure also recognize that such adaptation needs to be achieved while maintaining a flexible resource allocation with fine granularity for DL control signaling.

The present disclosure provides methods and apparatus to enable increased SE by dynamic indication of parameters for DL control signaling.

The embodiments may apply to any deployments, verticals, or scenarios including in FR1, FR2, FR3, FR4, with enhanced mobile broadband (eMBB), ultra reliable low latency communications (URLLC) and industrial internet of things (IIoT), massive machine-type communications (mMTC) and IoT including LTE NB-IoT or NR IoT or Ambient IoT (A-IoT), with AI/ML operation, with sidelink/vehicle to anything (V2X) communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multi-cast broadcast services (MBS), with integrated sensing and communication (ISAC) operation, and so on.

Embodiments of the disclosure are summarized in the following and are fully elaborated further herein. Combinations of the embodiments are also applicable but are not described in detail for brevity.

Various embodiments of the present disclosure provide for dynamic indication and update of PDCCH/CORESET parameters. In one embodiment, a UE can receive L1/L2 signaling that indicates or updates one or more parameters associated with PDCCH receptions, such as CORESET parameters, PDCCH configuration parameters, search space configuration parameters, and so on. Such L1/L2 signaling can indicate a value from multiple previously configured values, or can overwrite/update with an indicated value (a) an initial or default or fallback value or (b) a value provided by higher layers, or (c) a previously indicated value by previous L1/L2 signaling. Instead of indicating a parameter, the L1/L2 signaling can indicate a sub-set from a set of CORESET indexes (or a set of CORSET configuration indexes) for use in subsequent PDCCH monitoring occasions. For example, a UE can be configured with a number N of CORESET indexes (or a number N of CORESET configuration indexes), and the L1/L2 signaling can indicate a combination of M CORESET indexes (or M CORESET configuration indexes) from the N CORESET indexes (respectively, from the N CORESET configuration indexes).

Various embodiments of the present disclosure provide for parameters from the PDCCH/CORESET configuration to be dynamically indicated. In one embodiment, L1 or L2 signaling can indicate CORESET/PDCCH parameters, including one or more of: time-domain resource allocation, such as CORESET duration or starting symbol; frequency-domain resource allocation, such as a bitmap or resource indicator value (RIV) or an RB-level offset for the CORESET; parameters for resource interleaving, such as cce-REG-MappingType; or DCI modulation order.

Various embodiments of the present disclosure provide for methods for dynamic indication or update of the PDCCH/CORESET parameters. In one embodiment, the UE can receive L1/L2 signaling that provides indication or update for multiple CORESET/PDCCH parameters, as previously described. In a first approach (referred to as ‘parameter-level indication’), the L1/L2 signaling provides a separate indication for each of the multiple parameters (including joint indication for some of the multiple parameters), or multiple separate L1/L2 signaling are used to provide separate indications for the multiple parameters (one-to-one or one-to-many). In a second approach (referred to as ‘config-level indication’), the UE can be provided multiple configurations or multiple sub-configurations for parameters related to PDCCH receptions or to CORESETs, each configuration/sub-configuration includes one set of values for the multiple parameters, and L1/L2 signaling indicates an index for an applicable configuration or sub-configuration. In a third approach (referred to as ‘CORESET-level indication’), the UE can be configured multiple CORESETs, and L1/L2 signaling can indicate, by a bitmap or by a CORESET combination index (where each CORESET combination refers to a configured subset or collection of CORESETs), a number of ‘active’ CORESETs from the multiple configured CORESETs.

Various embodiments of the present disclosure provide for application time for dynamic indication of the PDCCH/CORESET parameters. In one embodiment, the UE applies an L1/L2 signaling for indication of CORESET parameters after a processing time, from a time when the UE receives the L1/L2 signaling or from a time that the UE would transmit a PUCCH with HARQ-ACK information for the L1/L2 signaling. The UE continues to apply the L1/L2 signaling for a set or number of slots or until receiving a next L1/L2 signaling providing a new indication for the CORESET parameters.

Various embodiments of the present disclosure provide for restrictions on L1/L2 indication of the PDCCH/CORESET parameters. In one embodiment, there may be restrictions on CORESETs for which dynamic indication by L1/L2 signaling applies to certain CORESET parameters. For example, the UE may not expect multiple predetermined or configured values for one or more certain parameters of a CORESET #0, such as a CORESET #0 in an initial BWP, that is associated with receptions of a cell-defining SSB (CD-SSB). For example, parameters of a CORESET with index 0 in an initial DL BWP can be indicated by a MIB.

Various embodiments of the present disclosure provide for configurations and procedures to handle inconsistency between L1/L2 indication of the PDCCH/CORESET parameters and associated search space sets. In one embodiment, an association of CSS/USS sets with a CORESET can be impacted by an L1/L2 signaling that indicates parameters for the CORESET or for PDCCH/DCI reception. The gNB can ensure that L1/L2 signaling for CORESET parameters is consistent with higher layer configuration for the associated search space sets, or the UE is predetermined certain procedures to handle such inconsistencies. Alternatively, a linkage between CSS/USS sets with the CORESET can be flexible to allow for a CSS/USS set to be associated with a CORESET only for certain parameter values or only for certain configuration/sub-configuration indexes for the CORESET. In a further alternative, parameters for a search space set, such as a starting symbol of a USS set or possibly of a USS set, can also be indicated or updated by an L1/L2 signaling (e.g., same L1/L2 signaling as for CORESET adaptation, or a separate L1/L2 signaling).

Various embodiments of the present disclosure provide for rate matching indication for PDSCH based on L1/L2 indication of the PDCCH/CORESET parameters. In one embodiment, a UE rate matches a PDSCH around time/frequency resources allocated for a CORESET based on a last L1/L2 signaling for the CORESET/PDCCH parameters, or an L1/L2 signaling for CORESET/PDCCH parameters can update, overwrite, or complement the configured or activated rate matching patterns.

Various embodiments of the present disclosure provide for using DCI/PDCCH for indication of PDCCH/CORESET parameters. In a first scheme, a DCI/PDCCH can be used for providing information for PDCCH/CORESET parameters. The DCI format can be a group-common DCI (GC-DCI) format that a UE receives according to a CSS set, or can be a UE-specific DCI, such as a standalone DCI format or a DCI format scheduling PDSCH reception or PUSCH transmission that the UE receives according to a USS set. The UE can be configured an RNTI, such as CRI-RNTI (CORESET information RNTI), that scrambles a CRC of the DCI format. A CSS/USS set for a DCI format associated with CRI-RNTI can be separate from other CSS/USS sets associated with other DCI formats. The UE can receive PDCCHs providing the DCI format associated with CRI-RNTI in a CORESET with parameters (except possibly for an associated TCI state) configured by higher layers, or indicated by a previous L1/L2 signaling or based on a default set of parameters, such as a first slot for a reference system frame number, or a predetermined number/set of CCEs in a CORESET, such as the first N (e.g., N=4 or 8) CCEs of the CORESET. A UE does not expect to apply indications provided by the GC-DCI to PDCCH receptions that are in monitoring occasions (MOs) that start earlier than a predefined time from the end of the PDCCH reception (or from the start of the PDCCH reception) providing the GC-DCI format.

Various embodiments of the present disclosure provide for sing GC-DCI in a CSS set for indication of PDCCH/CORESET parameters. In a first realization of the first scheme, a group-common DCI (GC-DCI) format for indication of CORESET/PDCCH parameters can be based on a CRI-RNTI, such as by a CSS configuration that is associated with the GC-DCI format. The GC-DCI format can include multiple information blocks that are associated with multiple CORESET IDs or associated with multiple CORESETs of an indicated CORESET combination, or are associated with CORESETs of multiple UEs or multiple UE groups. A UE can be configured one or more position-in-DCI corresponding to the one or more information blocks of the GC-DCI format that are associated with the one of more indicated CORESETs of the UE, or corresponding to a first information block of the GC-DCI format that is associated with a first CORESET, such as a CORESET with smallest index (among the indicated CORESETs). A UE can be configured a number of bits for each of the multiple information blocks, or corresponding fields thereof, or the UE can assume that a number of bits for each of the multiple information blocks, or corresponding fields thereof, is same as that identified for an information block, or corresponding fields thereof, associated with the UE. Alternatively, the UE may be provided only information of number of bits for information blocks associated with CORESETs configured/activated for the UE.

Various embodiments of the present disclosure provide for using UE-specific/scheduling DCI in a USS set for indication of PDCCH/CORESET parameters. In a second realization of the first scheme, a UE-specific DCI format provides an indication of CORESET/PDCCH parameters, wherein the UE receives the UE-specific DCI in a UE-specific search space (USS) set. The UE-specific DCI format can be: a standalone DCI format that is dedicated to indication of CORESET parameters, and can have a CRC that is scrambled with a CRI-RNTI configured to the UE, or a scheduling DCI format associated with a UE-specific RNTI, such as a C-RNTI or MCS-C-RNTI, or another UE-specific DCI format that is also used for other indications. The standalone DCI format can include multiple information blocks corresponding to multiple CORESETs. The scheduling DCI format can include a dedicated field for CORESET parameter indication or can repurpose certain first fields (e.g., one or more of RV, NDI, MCS, HARQ process number or HPN, TDRA, and so on) to indicate the CORESET parameters while using certain second fields (e.g., one or more of FDRA, TDRA, and so on) for validation. The scheduling DCI format can indicate a CORESET ID to which the parameter values are applied, or can provide the parameter values for a same CORESET in which the PDCCH providing the scheduling DCI format is received, without CORESET ID indication. Alternatively, the DCI format can indicate an index of a CORESET combination (i.e., a configured subset of a set of CORESETs that are configured or activated for the UE) along with separate parameters for each CORESET from the CORESET combination or common parameters that apply to different CORESETs of the CORESET combination. In a different alternative, the DCI format can provide a bitmap (or one or more fields) that includes multiple parameter sets or information blocks corresponding to different CORESETs in ascending order (or descending order) of the CORESET ID, without indicating the corresponding CORESET IDs.

Various embodiments of the present disclosure provide for using MAC-CE for indication of PDCCH/CORESET parameters. In a second scheme, a MAC-CE is used for providing information of the PDCCH/CORESET parameters to a UE. The MAC-CE can be UE-specific and provided by a PDSCH that is scheduled by a UE-specific DCI format or by a SPS PDSCH. Alternatively, the MAC-CE can be provided by a groupcast/multicast PDSCH that is scheduled by a groupcast/multicast DCI format or is provided by a groupcast/multicast SPS PDSCH.

Various embodiments of the present disclosure provide for using a DL physical channel as the signaling scheme for indication of PDCCH/CORESET parameters. In a third scheme, a DL channel other than a PDCCH and PDSCH, is used for providing information of the PDCCH/CORESET parameters, such as for the existence or parameters of one or more CORESETs over a time period such as a configured or indicated number of slots or in a time period between consecutive reception occasions of the DL channel. Information content of the DL channel can indicate one or both of a UE ID and a CORESET ID to which a certain field or block of the information content of the DL channel applies. Alternatively, there can be a predetermined or configured association among fields/blocks of the information content with different UE IDs or CORESET IDs, or association among time/frequency/spatial/code-domain resource allocation of the new DL channel, such as reception occasions of the DL channel, with UE IDs or UE group IDs or CORESET IDs or CORESET combination IDs. Time-domain resource allocation of the DL channel can be in a first symbol or in a configured symbol of a slot, and may additionally be based on a frame/slot periodicity and a frame/slot offset. Frequency-domain allocation of the DL channel can be contiguous in terms of a starting RB/RE index (or RB/RE group index) and a number of allocated RBs/REs (or groups thereof) or can be non-contiguous in terms of a number of sets of contiguous RBs/REs (or RB/RE groups), such as N=2 or 4 sets each with M=2 or 6 contiguous RBs, with a certain gap or separation that is same or separate/different for different sets of RBs, with or without interleaving, or can be based on a bitmap for flexible allocation. The information provided by the DL channel can be encoded, such as by a Reed-Muller code or a polar code, or be provided by selecting a sequence from a predefined set of sequences.

Various embodiments of the present disclosure provide for cell-specific design of the DL channel for indication of CORESET parameters. In a first realization of the third scheme, the DL channel is cell-specific with information content that applies to any UE in the cell. The DL channel can include a number of N fields or groups of fields, corresponding to N CORESETs, and each UE in the cell applies a first field or group of fields to a first-index CORESET, a second field or group of fields to a second-index CORESET, and so on. The value of N can be configured by higher layers or can be predetermined in the specifications of system operation. A UE in the cell may apply the indications regardless of whether or not the first-index CORESET for a first UE is same as a first-index CORESET for a second UE, and so on. For example, indications can be common, while the underlying CORESETs may be same or different. Alternatively, the first field or the first group of fields are associated with CORESET #1, the second field or the second group of fields are associated with CORESET #2, and so on, and a UE applies certain fields/groups of fields for which the associated CORESET is applicable/configured to the UE (e.g., a UE discards the second field/group of fields when the UE is not configured CORESET #2). The information provided by the DL channel (may or) may not include a CRC or use an RNTI. To accommodate different UEs in the cell, the DL channel can be repeated with multiple spatial beams (e.g., SSB indexes or TCI states) in multiple time/frequency resources or resource groups.

Various embodiments of the present disclosure provide for UE-group-specific design of the DL channel for indication of CORESET parameters. In a second realization of the third scheme, the DL channel for indication of CORESET parameters is UE-group-specific, with information content that applies to any UE in a corresponding UE group. A UE-group-specific RNTI, such as CRI-RNTI, may be used to scramble a CRC for the encoded information content of the DL channel. To multiplex the DL channel for different groups of UEs, different time/frequency resources, such as different slot offsets or starting RB, can be configured to different groups of UEs (that is, TDM or FDM), or each group of UEs can be configured a different spatial relation (such as SSB index or TCI state), a different orthogonal cover code (OCC), or a different cyclic shift (that is, SDM or CDM).

Various embodiments of the present disclosure provide for UE-specific design of the DL channel for indication of CORESET parameters. In a third realization of the third scheme, the DL channel is UE-specific with information content that applies to only one UE in the cell. Various design aspects can be similar to those in embodiments described herein, except that corresponding configurations and indication can be UE-specific, such as for RNTI, time/frequency resource allocation, beam determination, cyclic shift or cover code, and so on, possibly with some UE-specific modifications.

Various embodiments of the present disclosure provide for energy saving aspects for the DL channel for indication of CORESET parameters. In one embodiment, the UE can receive higher layer configuration or L1/L2 signaling or other information that indicates whether the DL channel is enabled or disabled, or whether certain reception occasions of the DL channel can be skipped. In some example, the gNB may skip transmission of the DL channel in certain monitoring occasions without indication to the UE, thereby energy saving at the network (NW), while the UE monitors different monitoring occasions of the DL channel. Such designs can prevent the DL channel to be an always-on channel, and therefore, provide UE power saving gains and/or network energy saving gains. When the DL channel is disabled or skipped, the UE monitors PDCCH in the configured CORESETs based on the last configured/indicated values or based on default/fallback values for the CORESET parameters. In addition, the UE can be predetermined or configured or indicated to rate match a PDSCH reception around T/F resources associated with such DL channel. For example, when the DL channel is disabled or is absent for one or more occasions or slots, higher layer configuration or scheduling DCI format for the PDSCH (or activation DCI format for SPS PDSCH) may indicate to skip rate matching around T/F resources associated with the DL channel.

Various embodiments of the present disclosure provide for UE determination of PDCCH/CORESET parameters without gNB indication. In a fourth scheme, the UE determines the PDCCH/CORESET parameters without any indication or signaling from the gNB, such as by blind decoding respective values of the CORESET parameters among predetermined or configured respective sets of values.

Various embodiments of the present disclosure provide for UE determination of PDCCH/CORESET parameters using physical properties of PDCCH such as phase rotation. In a fifth scheme, the UE determines the PDCCH/CORESET parameters based on physical properties of PDCCHs that the UE receives, such phase rotation applied to PDCCH REs relative to that for PDCCH DMRS REs.

In various embodiments or examples throughout the present disclosure, a 6G base station (6G gNB) or a 5G/4G gNB can be replaced with other corresponding network nodes, such as 6G IAB or 6G NCR or 6G reconfigurable intelligent surface (RIS), or such as 5G NCR or IAB node, or a 4G relay or repeater node. In various embodiments, a 6G UE or a 5G/4G UE can operate in relation with multiple network nodes corresponding to a certain RAT (same RAT as that for the UE, or different RAT than that for the UE), such as both a 6G gNB and a 6G IAB/NCR/RIS, or both a 5G gNB and a 5G IAB/NCR, or both a 4G eNB and 4G relay/repeater node.

In various embodiments and examples throughout the present disclosure, a 6G/5G gNB or a 4G eNB can refer to a central unit (CU) or a distributed unit (DU) or a remote/radio unit (RU) or a transmission-reception point (TRP) or other architectural units or functional/logical entities for a corresponding base station, or a variation or collection or combination thereof.

Various embodiments of the present disclosure provide for L1/L2 signaling for indication of PDCCH/CORESET parameters. In one embodiment, the UE can receive L1/L2 signaling to indicate or update one or more parameters associated with PDCCH receptions, such as CORESET parameters, PDCCH configuration parameters, search space set configuration parameters, and so on. Such L1/L2 signaling can indicate a value, from a set of multiple configured values, or can overwrite with an indicated value (a) an initial or default or fallback value, (b) a value provided by higher layers or (c) a previously indicated value by a previous L1/L2 signaling. Support for such CORESET adaptation can be an optional UE capability.

Various embodiments, methods, procedures, and examples throughout the disclosure are described in terms of CORESET parameters. Such embodiments, methods, procedures, and examples also apply to search space parameters, PDCCH reception or DCI decoding parameters, and so on. Such embodiments, methods, procedures, and examples can also apply generally to any higher layer configuration. Such embodiments, methods, procedures, and examples can also apply to other parameters for other signals or channels, such as for SSB, PDSCH, PUSCH, PUCCH, PRACH, CSI-RS, TRS, DL PRS, SRS, SRS for positioning, LP-SS, LP-WUS, DL WUS (such as sequence-based or channel-coding-based DL WUS using OFDM or OOK modulation), DL discovery signal (DS) or discovery channel (DCH), UL WUS, and so on. Accordingly, such methods can be used for dynamic L1/L2-based indication or adaptation of parameters for various signals or channels or procedures, that are otherwise configured by higher layers such as RRC or SIB or are predetermined in the specifications of system operation.

In various embodiments and examples of the present disclosure, higher layer signaling or higher layer indication can refer to configuration, indication or signaling of parameters via RRC or system information such as SIB1 or SIBx with x>1. For example, RRC signaling can be UE-specific/dedicated or UE-group-specific or UE-common/cell-specific. For example, an RRC information element can be UE-specific/dedicated or UE-group-specific or UE-common/cell-specific.

In various embodiments and examples of the present disclosure, L1/L2 signaling may refer to a DCI format in a PDCCH, such as a PDCCH monitored in a CORESET according to a search space set, for example, a UE-specific search space (USS) set or a common search space (CSS) set. For example, the DCI format can be a scheduling DCI format that schedules PDSCH or PUSCH and also provides a corresponding L1/L2 indication. For example, the DCI format can be a standalone DCI format. For example, the DCI format can be a UE-group-specific DCI format, such as group-common DCI (GC-DCI) format, or a cell-specific DCI format, such as a paging DCI or a DCI format associated with a CSS set and a cell-specific or predetermined RNTI value. In various embodiments and examples of the present disclosure, L1/L2 signaling may additionally or alternatively refer to a different channel or a different signal, including a sequence-based signal, wherein parameters of the sequence (such as root sequence index, phase rotation, cyclic shift, correlation index, and so on) are used to provide the L1/L2 indication.

In various embodiments and examples of the present disclosure, the term indication can refer to L1/L2 signaling for providing a value for a parameter or a group of parameters, such as a CORESET parameter or a group of CORESET parameters. For example, a parameter can be a number of symbols for a CORESET. For example, a parameter can be a number of RBs for a CORESET. Other examples for the CORESET/PDCCH parameter are subsequently described in embodiments herein. For example, the specifications of system operation or higher layers can provide multiple values for the parameter. For example, the L1/L2 signaling can indicate certain value, from the multiple values, to be applied for the parameter. Instead of indicating a parameter, the L1/L2 signaling can indicate a sub-set from a set of CORESET indexes for use in subsequent PDCCH monitoring occasions. For example, a UE can be configured with a number N of CORESET indexes, and the L1/L2 signaling can indicate parameters associated with a combination of M CORESET indexes from the N CORESET indexes. Parameters for a specific CORESET, such as a CORESET with index 0 in an initial DL BWP, may not be updated by the L1/L2 signaling. For example, parameters of a CORESET with index 0 in an initial DL BWP can be indicated by a MIB.

In various embodiments and examples of the present disclosure, the term update can refer to L1/L2 signaling for providing a new value for a parameter or new values for a group of parameters to overwrite/reset a previous value for the parameter or previous values for the group of parameters. For example, a previous parameter value can be one that is provided by a previous L1/L2 signaling, or a value provided by higher layer configuration.

In various examples, the terms indicate, and update can be used interchangeably. In various realizations, the term ‘indicate’ (and variations thereof) can also include ‘update’ (and variations thereof).

Various combinations can be considered for L1/L2 indication of CORESET parameters:
No higher layer configuration for a parameter, and L1/L2 indicates a value from a predetermined set of values for the parameter; or
Higher layers configure a value from multiple predetermined values, and L1/L2 overwrites the configured value with another value from the multiple predetermined values; or
Higher layers configure multiple values, and L1/L2 indicates a value from the multiple configured values.
Higher layers configure N CORESETs and corresponding indexes and L1/L2 indicates a combination of M≤N indexes for CORESETs to be used for a next time period

In a first realization, the specifications include multiple predetermined values or a predetermined format for a CORESET parameter, and L1/L2 indicates a value from the multiple predetermined values or based on the predetermined format. For example, higher layers such as an RRC signaling that configure a CORESET may not provide any value for the CORESET parameter, and a value is indicated by L1/L2 signaling.

For example, the UE applies an initial value or a default/fallback value for the parameter from a time the CORESET is configured until the UE receives L1/L2 signaling that indicates a first value for the parameter (or until a processing/application time associated with the L1/L2 signaling, for example, until N symbols or slots after reception of the L1/L2 signaling or N symbols or slots after transmission of HARQ-ACK information in response to the L1/L2 signaling, wherein a value of N can be a UE capability or predetermined in the specifications or configured by higher layers). For example, the initial/default/fallback value is predetermined in the specifications of the system operation, such as a smallest (or largest) value from the multiple predetermined values, or a smallest index (or largest index) value from the multiple predetermined values. For example, a CORESET duration of 2 symbols (or 1 symbol) can be a default. For example, an initial/default value for frequency-domain allocation of the CORESET can be same as that for a CORESET #0 in an initial DL BWP.

In a second realization, higher layers can configure an initial value, from multiple predetermined values or from a predetermined structure for a CORESET parameter, and L1/L2 signaling can overwrite the initial configured value. For example, the UE is configured a first value from a set of predetermined values of {1, 2, 3} for the CORESET duration, and the UE receives L1/L2 signaling that indicates a second value from the set predetermined values that overwrites the first value. For example, the UE is configured a first bitmap or RIV (see embodiments herein) by higher layers, and L1/L2 signaling indicates a second bitmap or RIV that overwrites the first bitmap or RIV.

In a third realization, higher layers configure multiple values for a CORESET parameter, and L1/L2 signaling indicates a value from the multiple configured values. For example, the UE is configured values {2, 3} for a CORESET duration, and the UE receives an L1/L2 indication for a value from the two configured values. For example, the UE is configured 4 bitmaps or RIVs for frequency allocation of a CORESET (see embodiments herein), and the UE receives L1/L2 signaling that indicates a bitmap or RIV for the CORESET.

For example, as in the first realization, the UE applies an initial value or a default/fallback value for the parameter from a time the CORESET is configured until the UE receives L1/L2 signaling that indicates a first value for the parameter. For example, higher layers can indicate or activate the initial value. For example, the UE can be provided higher layer configuration such as ‘firstActiveXYZ’ to provide the initial value for a CORESET parameter XYZ. For example, the initial/default/fallback value is predetermined in the specifications, such as a smallest (or largest) value from the multiple configured values, or a smallest index (or largest index) value from the multiple configured values.

For example, for frequency resource allocation of a CORESET, an initial/default/fallback value can be a resource allocation that is an intersection of the multiple configured resource allocations, such as an intersection of the multiple configured bitmaps or multiple configured RIV values for the corresponding CORESET.

In a fourth realization, a UE can be configured by higher layers with N>1 CORESETs and corresponding N indexes. L1/L2 signaling can then indicate a combination of M≤N indexes and the UE can then determine to receive PDCCH according to the M CORESETs corresponding to the M indexes. For example, L1/L2 signaling indicates indexes of the M ‘active’ CORESETs. For example, L1/L2 signaling provides a bitmap, with one bit associated with each CORESET ID, wherein a value ‘1’ indicates that a corresponding CORESET is indicated, and a value ‘0’ indicates that the corresponding CORESET is not indicated. For example, the UE can be configured a number of CORESET combinations, wherein each CORESET combination includes a respective subset of CORESETs from a set of CORESETs configured to the UE, or from a UE-common/cell-specific set of CORESETs. For example, L1/L2 signaling can indicate an index of a CORESET combination from the configured number of CORESET combinations. A CORESET with index 0 may or may not be included in the set of CORESETs that can be indicated for PDCCH receptions by the L1/L2 signaling. For example, the CORESET with index 0 may not be included when the UE operates in an initial DL BWP and may be included when the UE does not operate in the initial DL BWP. For example, the CORESET with index 0 may never be included in the set of CORESETs that can be indicated for PDCCH receptions by the L1/L2 signaling and the UE always receives PDCCH in the CORESET with index 0. In such case, the L1/L2 signaling may indicate zero CORESETs for PDCCH receptions. In another example, L1/L2 signaling always includes an indication for COERSET #0 among indicated/activated CORESETs. In another example, an L1/L2 signaling for update of CORESET #0 can be via a paging DCI format or a cell-specific DCI format associated with a CSS set and/or with a predetermined or configured RNTI that is UE-common/cell-specific, or can be via a UE-common/cell-specific sequence-based signal, such as DL WUS. For example, an L1/L2 signaling (or an occasion for reception of the L1/L2 signaling) to update CORESET #0 can be separate from an L1/L2 signaling (or an occasion for reception of the L1/L2 signaling) to update other CORESETs.

For example, the UE can be configured a first, second, and third CORESET having indexes of 1, 2, and 3. L1/L2 signaling can indicate the CORESET with index 2 for subsequent PDCCH receptions. Then, the UE receives PDCCH in the CORESET with index 2 and does not receive PDCCH in the CORESETs with index 1 and 3. If the UE has search space sets associated with CORESETs with index 1 and 3, those search space sets are disabled for PDCCH receptions.

For example, the N CORESETs are referred to as configured CORESETs, and the M CORESETs that are indicated by L1/L2 signaling are referred to as “active” CORESETs (or “activated” CORESETs).

For example, a UE can report one or both of a first capability for a maximum number of configured CORESETs, and a second capability for a maximum number of active/activated CORESETs. For example, the UE can report a first value for the first capability such as M E {4, 6, 8, 12, 16}CORESETs. For example, a UE can report a second value for the second such as N E {1, 2, 3, 4, 5}. For example, it is predetermined in the specifications of system operation whether the first/second values reported by the UE capability, or corresponding values configured to the UE can include or exclude a CORESET with index #0.

For example, after receiving a higher layer configuration for N configured CORESETs and before receiving a first/earliest L1/L2 signaling that indicates M active CORESETs from the N configured CORESETs, in one option, the UE does not monitor PDCCH according to any of the N configured CORESETs. For example, the UE monitors PDCCH only according to a CORESET with index #0. In another option, the UE monitors PDCCH according to a predetermined set of M CORESETs from the N configured CORESETs, referred to as M ‘first active’ CORESETs or M initial CORESETs, such as M CORESETs with smallest indexes among the N configured CORESETs. In another option, such set of M first-active CORESETs or M initial CORESETs can be configured by higher layers. For example, when a configuration for a CORESET parameter includes multiple values, and before receiving any L1/L2 signaling, the UE can receive PDCCH in the CORESET based on a default value of the parameter that is indicated in the RRC/SIB configuration, or based on a predetermined default value, such as a smallest (or largest) configured value, or a value with a smallest (or largest) index/order count.

In another example, N configured CORESETs can be grouped into multiple, such as 2-4 CORESET groups. For example, each CORESET can be assigned one CORESET group ID (or possibly multiple CORESET group IDs). For example, L1/L2 signaling can indicate an active group of CORESETs for a time duration, or for duration of CORESET switching timer, or until reception of a next L1/L2 signaling or higher layer configuration that indicates a different active group of CORESETs. For example, the UE monitors PDCCH in the active group of CORESETs, and according to search space sets that are associated with the active group of CORESETs. For example, before receiving a first/earliest L1/L2 signaling, the UE monitors PDCCH in a group of CORESETs with group index 0, or in an ‘initial’ or ‘first active’ group of CORESETs as configured by higher layers. For example, the UE decrements a CORESET switching timer by one after each slot. For example, the UE resets the CORESET switching timer when the UE detects a DCI format provided by a PDCCH in a CORESET among the active group of CORESETs. For example, when the CORESET switching timer expires, the UE starts to monitor PDCCH in a CORESET group with index 0, or in a ‘default’ CORESET group as configured by higher layers.

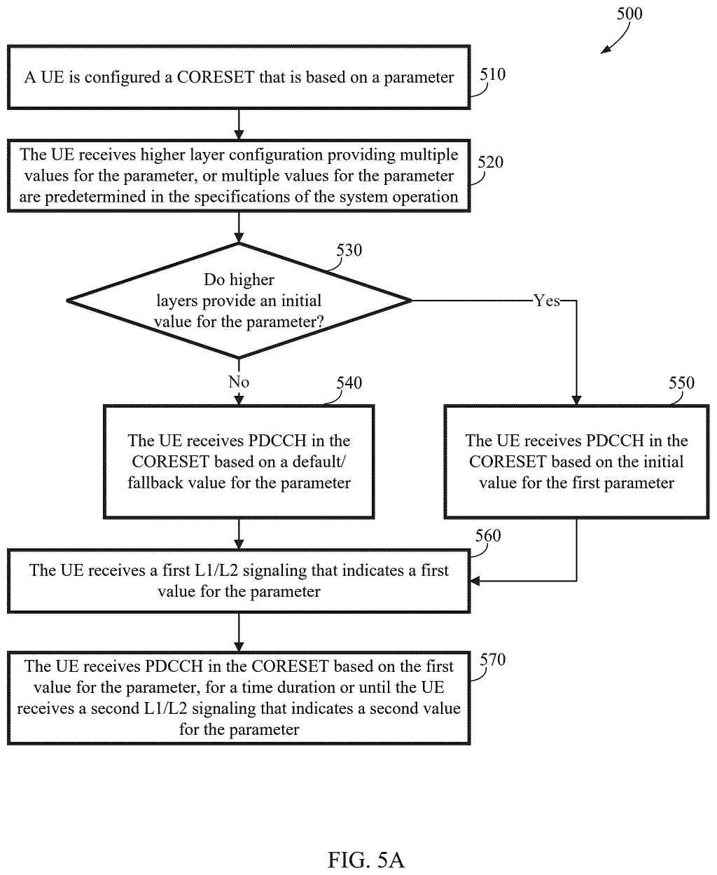

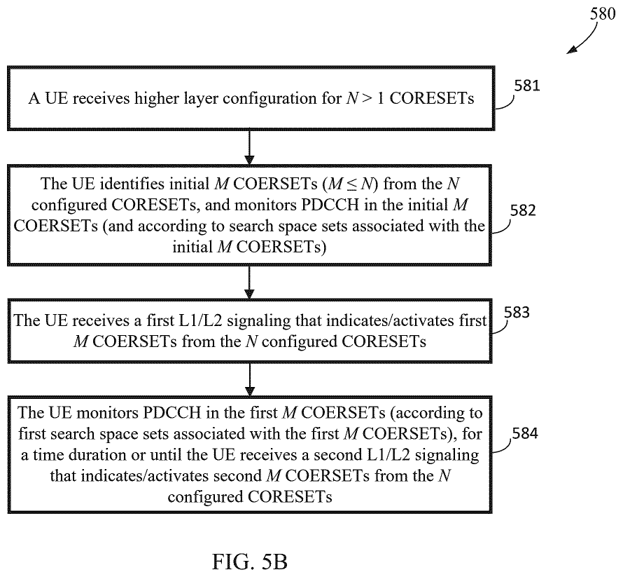

FIG. 5A illustrates an example process 500 of L1/L2 signaling that indicates a value from multiple values that are predetermined/configured for a certain CORESET parameter according to one or more embodiments of the present disclosure. The process 500 of FIG. 5A can be performed by any of the UEs 111-116 of FIG. 1, such as the UE 116 of FIG. 3, and a corresponding method can be performed by any of the BSs 101-103 of FIG. 1, such as BS 102 of FIG. 2. The process 500 is for illustration only and other embodiments can be used without departing from the scope of the present disclosure.

The process 500 begins with the UE being configured a CORESET wherein the CORESET includes a parameter (e.g., time duration, frequency allocation, RB-level offset, interleaving, modulation type, and so on), 510. The UE receives higher layer configuration providing multiple values for the parameter or multiple values for the parameter are predetermined in the specifications of the system operation, 520. The UE determines whether or not higher layers provide an initial value for the parameter, 530. If the UE determines that the higher layers do not provide an initial value for the parameter, the UE receives PDCCH in the CORESET based on a default/fallback value for the first parameter, 540. If the UE determines that the higher layers provides the initial value for the parameter, the UE receives PDCCH in the CORESET based on the initial value for the parameter, 550. The UE receives a first L1/L2 signaling that indicates a first value for the parameter, 560. The UE receives PDCCH in the CORESET based on the first value for the parameter, for a time duration or until the UE receives a second L1/L2 signaling that indicates a second value for the parameter, 570.

For example, the UE can be configured an “update timer” for one or more CORESET parameter or for all parameters in a CORESET. For example, the UE starts or restarts the timer when the UE receives L1/L2 signaling that indicates or updates a value of the corresponding CORESET parameter. For example, if the corresponding timer expires and the UE has not received any L1/L2 signaling that indicates or updates the corresponding CORESET parameter, the UE applies a default or fallback value for the corresponding CORESET parameter.

For example, the UE can be configured a single timer for multiple (including all) CORESET parameters, and the UE restarts the timer each time the UE receives L1/L2 signaling for any one of the multiple CORESET parameters. For example, the UE applies corresponding default or fallback values for the multiple CORESET parameters when the timer expires, and the UE has not received any L1/L2 signaling for indication or update of any of the multiple CORESET parameters.

FIG. 5B illustrates an example process 580 of L1/L2 signaling that indicates/activates a number of M≤N CORESETs from a number of N>1 configured CORESETs according to one or more embodiments of the present disclosure. The process 580 of FIG. 5B can be performed by any of the UEs 111-116 of FIG. 1, such as the UE 116 of FIG. 3, and a corresponding method can be performed by any of the BSs 101-103 of FIG. 1, such as BS 102 of FIG. 2. The process 580 is for illustration only and other embodiments can be used without departing from the scope of the present disclosure.

The process 580 begins with the UE receiving higher layer configuration for N>1 CORESETs, 581. The UE identifies initial M CORESETs (M≤N) from the N configured CORESETs, and monitors PDCCH in the initial M CORESETs (according to search space sets associated with the initial M CORESETs), 582. The UE receives a first L1/L2 signaling that indicates/activates first M CORESETs from the N configured CORESETs, 583. The UE monitors PDCCH in the first M CORESETs (according to first search space sets associated with the first M CORESETs), for a time duration or until the UE receives a second L1/L2 signaling that indicates/activates second M CORESETs from the N configured CORESETs, 584.

Various embodiments of the present disclosure provide for PDCCH/CORESET configuration parameters indicated by L1/L2 signaling. In one embodiment, CORESET/PDCCH parameters that can be indicated by L1/L2 signaling include one or more of: time-domain resource allocation, such as CORESET duration or starting symbol for search space monitoring; frequency-domain resource allocation, such as a bitmap or resource indicator value (RIV) or an RB-level offset for the CORESET; parameters for resource interleaving, such as cce-REG-MappingType; or a modulation type for DCI provided by PDCCH receptions in the CORESET.

In a first example, a time-domain resource allocation of a CORESET can be indicated or updated with L1/L2 signaling. For example, the UE can be configured, by higher layers, multiple values for a time duration or a number of consecutive OFDM symbols for CORESET, such as values {1, 2, 3} symbols or {1, 2, 3, 6} symbols. For example, a L1/L2 signaling can use 2 bits to indicate one value from the 3 or 4 configured values.

For example, multiple values of monitoringSymbolsWithinSlot to indicate a starting symbol within slot for PDCCH monitoring according to a search space set can be configured by higher layers or can be predetermined in the specifications of system operation, and L1/L2 signaling can indicate a value from the multiple values. For example, the UE applies an indicated value to a search space set with an indicated index, or to any search space set associated with a CORESET. For example, a field with 4 bits can indicate a value from a set {0, 1, 2, . . . , 13}. For example, a bitmap with 14 bits can indicate multiple symbols within a slot.

In a second example, a frequency domain allocation of a CORESET can be indicated or updated with L1/L2 signaling. For example, a UE can be configured, by higher layers, multiple bitmaps for frequency resources associated with a CORESET, such as a bitmap including 45 bits with each bit corresponding to one CCE (or one REG) including a predetermined number of RBs/PRBs, for example, 6 RBs/PRBs, to address the entire carrier/BWP bandwidth, such as 270 RBs. For example, the CCE/REG size or the bitmap size can be different in 6G to address larger carrier/BWP bandwidth. For example, the CCE/REG size or the bitmap size can depend on a frequency band or a frequency range (such as FR1, FR2, FR3, and so on) associated with the CORESET.

For example, higher layers can configure 2 bitmaps or 4 bitmaps, and L1/L2 signaling can use 1 or 2 bits to indicate or update the frequency allocation for the CORESET by indicating a bitmap index from the 2 or 4 configured bitmaps, respectively. For example, different granularity, such as RBG, can be used for the CORESET bitmap.

For example, instead of bitmaps, a different scheme may be used for the frequency allocation of a CORESET, such as contiguous allocation. For example, the CORESET resources can be in terms of a starting RB/RBG/REG/CCE and a number of contiguously allocated RBs/RBGs/REGs/CCEs. For example, the start parameter and the length/number parameter can be configured and indicated separately or jointly.

For example, frequency resources of a CORESET can be configured using multiple, such as 2 or 4, values for the starting index in terms of RB/RBG/REG/CCE, or using multiple, such as 2 or 4, values for the resource length or number of RBs/RBGs/REGs/CCEs. For example, the UE can receive L1/L2 signaling that indicates a starting resource index from the 2 or 4 configured starting indexes, and a resource length from the 2 or 4 configured resource lengths.

For example, the start Nₛₜₐᵣₜ and the length/number L parameters can be jointly encoded into a single parameter, such as resource indication value (RIV). For example,

$$if ( L - 1 ) \leq ⌊ \frac{B W}{2} ⌋ then RIV = BW ( L - 1 ) + {N}_{s t a r t} , and$$

$$if ( L - 1 ) > ⌊ \frac{B W}{2} ⌋ then RIV = BW ( BW - L + 1 ) + ( B W - 1 - {N}_{s t a r t} ) .$$

Herein, BW is the size of the carrier/BWP bandwidth in terms of RBs/RBGs/REGs/CCEs, and L+Nₛₜₐᵣₜ shall not exceed BW.

For example, the UE can be configured 2 or 4 different RIV values for the CORESET, and can receive L1/L2 signaling that indicates an RIV value from the 2 or 4 configured RIV values.

In another example, the frequency allocation can be different in different symbols. For example, the L1/L2 signaling can indicate one value for the time duration, from the multiple configured time durations, and a number of bitmaps or RIV values, from the multiple configured bitmaps or RIV values, wherein the number is associated with (for example, equal to) the indicated time duration. For example, for a duration of 2 or 3 symbols, the UE can receive an indication with 2 or 3 bitmaps or RIVs, such that the first bitmap applies to the first symbol in the CORESET, and the second bitmap or RIV applies to the second symbol in the CORESET, and so on.

For example, an RB-level-offset parameter, rb-Offset, for the CORESET resource allocation can be indicated by L1/L2 signaling. Such indication can be beneficial, at least when a granularity of the frequency-domain resource allocation for the bitmap or for the RIV is coarser than an RB, such as on the level of CCEs (e.g., 6 REGs/RBs). For example, the RB-level-offset parameter, rb-Offset, can be configured by higher layers to enable an RB-level shift for the CORESET relative to a first RB of the carrier/BWP. In one example, L1/L2 signaling can also indicate or update one value from multiple configured values for rb-Offset. In another example, such indication for rb-Offset can be separate from the indication of the bitmap or RIV for the CORESET. In another example, such indication for rb-Offset can be joint with the bitmap or RIV, such as indication of a pair of values for (bitmap, rb-Offset) or (RIV, rb-Offset). In another example, there is a linkage between the configured bitmaps or RIV values with the configured rb-Offset values. For example, higher layers configure a separate rb-Offset value for each bitmap or RIV value, and the UE can determine an applicable rb-Offset from the bitmap or RIV value indicated by the L1/L2 signaling.

Similar methods can apply for other granularities of resource allocation for a CORESET, such as RE-level offset.

In a third example, a CORESET parameter for resource interleaving, such as cce-REG-MappingType, can be indicated by L1/L2 signaling or can be determined based on the L1/L2 signaling. For example, 2 values can be configured for cce-REG-MappingType and parameters included therein, such as one or more of {reg-BundleSize, interleaverSize, shiftIndex}, and L1/L2 signaling can indicate one value from the 2 configured values. In another example, L1/L2 signaling can indicate a presence or absence (enabling or disabling) of interleaving for a corresponding CORESET.

In another example, higher layers can configure a separate value for cce-REG-MappingType (and parameters included therein, such as one or more of {reg-BundleSize, interleaverSize, shiftIndex}) for each time duration value or for each bitmap or RIV value, or for each group of combination or pairs thereof, configured for a CORESET. For example, when an L1/L2 signaling indicates a value from the multiple configured values or from the configured pairs of values for the time or frequency resource allocation for the CORESET, the UE determines a corresponding value for the parameter cce-REG-MappingType (and parameters included therein, such as one or more of {reg-BundleSize, interleaverSize, shiftIndex}).

In a fourth example, other CORESET or search space parameters such as modulation type can be included, and L1/L2 signaling can indicate a value for the modulation type or can enable or disable certain modulation types. For example, a CORESET or a search space set or PDCCH candidates within a search space set can be configured with {QPSK, 16QAM} as modulation types for DCI provided by PDCCH receptions in the CORESET, and L1/L2 signaling can indicate one or both of QPSK and 16 QAM as applicable modulation types for the CORESET. When only one modulation type is indicated, the UE decodes the DCIs provided by PDCCHs based on the indicated modulation type, such as only QPSK or only 16 QAM. When both modulation types are indicated by the L1/L2 signaling, the UE may perform blind decoding to determine the applicable modulation type, or the UE may be provided additional information, for example, in the search space set configuration, to determine an applicable modulation type for DCI provided by a PDCCH candidate.

For example, QPSK can be a default modulation scheme for DCI decoding provided by PDCCH receptions, and L1/L2 signaling can enable or disable 16 QAM an as an additional applicable modulation type for different CSS/USS sets that are associated with a CORESET. In another example, L1/L2 signaling can be on the level of search space set (instead of CORESET), and can indicate whether 16 QAM is enabled or disabled for a certain CSS/USS set with an indicated index.

In a fifth example, a parameter can be a TCI state, such as a DL TCI state or a joint DL/UL TCI state, for a corresponding CORESET or search space set. For example, an indicated TCI state can be applicable only for the CORESET/PDCCH reception, or can be applicable to a predetermined or configured list of various signals or channels.

In a sixth example, a parameter can be for enabling/disabling (or presence/absence) of a CORESET and corresponding search space sets. For example, a value 0 indicates that a corresponding CORESET is not present and corresponding search space sets are disabled for PDCCH monitoring. For example, the UE does not monitor PDCCH according to the indicated search space sets.

In various realizations, a predetermined set of CORESET parameters can be provided by higher layers without any L1/L2 indication. For example, such parameters can include: a DM-RS scrambling sequence initialization value by pdcch-DMRS-ScramblingID; a precoder granularity for the PDCCH DM-RS precoder by precoderGranularity; TRP/RRH/DU/RU association parameters such as coresetPoolIndex; and TCI application parameters such as followUnifiedTCI-State or applyIndicatedTCI-State. Therefore, a UE commonly applies values provided by higher layers for such CORESET parameters irrespective of any L1/L2 indication of parameters as previously described, for example, for time/frequency resource allocation of the CORESET.

When a UE is configured more than one CORESETs, and the UE receives L1/L2 signaling to indicate one or more parameters for some of the CORESETs, the UE can identify which CORESET from the more than one CORESETs the L1/L2 signaling is applicable for. For example, the UE can be provided a CORESET ID for which the indication or update of parameters is applicable, or the UE can determine an applicable CORESET ID from the signaling method, as subsequently described in embodiments herein.

Various embodiments of the present disclosure provide for methods for indication of PDCCH/CORESET parameters. In one embodiment, the UE can receive L1/L2 signaling that provides an indication for multiple CORESET/PDCCH parameters, as previously described. In a first approach (referred to as ‘parameter-level indication’), the L1/L2 signaling provides a separate indication for each of the multiple parameters (including joint indication for some of the multiple parameters), or multiple separate L1/L2 signaling are used to provide separate indications for the multiple parameters (one-to-one or one-to-many). In a second approach (referred to as ‘config-level indication’), the UE can be provided multiple configurations or multiple sub-configurations for PDCCH or CORESET parameters, wherein each configuration/sub-configuration includes one set of values for the multiple parameters, and L1/L2 signaling indicates an index for an applicable configuration or sub-configuration for the PDCCH or CORESET parameters. In a third approach (referred to as ‘CORESET-level indication’), the UE can be configured multiple CORESETs, and L1/L2 signaling can indicate, by a bitmap or by indicating a CORESET combination index, a number of ‘active’ CORESETs from the multiple configured CORESETs.

According to the first approach (referred to as ‘parameter-level indication’), L1/L2 signaling provides parameter-specific or parameter-group-specific indication or update for the multiple CORESET parameters. For example, L1/L2 signaling can include a first field for the indication of a first parameter or a first group of parameters, a second field for the indication of a second parameter or a second group of parameters, and so on.

For example, there can be one-to-one correspondence among fields of the L1/L2 signaling associated with a certain CORESET and the multiple CORESET parameters to be indicated. For example, a first field correspond to CORESET duration, a second field corresponds to frequency-domain bitmap or RV, a third field corresponds to RB offset, a fourth field corresponds to resource interleaving, and a fifth field corresponding to the modulation type of DCI provided by PDCCH receptions in the CORESET.

In a variation to the first approach, there can be a one-to-many correspondence among fields of the L1/L2 signaling associated with a certain CORESET and the multiple CORESET parameters to be indicated or updated. For example, a first group of CORESET parameters can be jointly encoded into a first single index that points to a first row from a first table, wherein the first row includes a first combination/tuple of values for the first parameters, and the table includes a first number of such rows. For example, a second group of CORESET parameters can be jointly encoded into a second single index that points to a second row from a second table, wherein the second row includes a second combination/tuple of values for the second parameters, and the table includes a second number of such rows. In one example, the tables directly include values for the corresponding parameters. In another example, the tables include indexes to the values (instead of the values themselves) for the corresponding parameters, and the UE determines an associated value by first determining a value index from the table row, and then determining the value based on the value index from a configuration provided for the corresponding parameter.

For example, the time parameters and the frequency parameters for a CORESET can be jointly configured and indicated. For example, higher layer signaling indicates multiple pairs of (time duration, frequency bitmap) or multiple pairs of (time duration, frequency RIV), or possibly including rb-Offset, and then L1/L2 signaling can indicate a pair from the multiple pairs. For example, 2 or 4 such pairs are configured by higher layers and L1/L2 signaling can indicate one such pair from the 2 or 4 configured pairs.

For example, a first pair can indicate a CORESET allocation with more symbols and fewer RBs, such as 2 or 3 symbols with 36 RBs in each symbol, and a second pair can indicate a CORESET allocation with fewer symbols and more CCEs, such as 1 symbol with 144 RBs. For example, the first pair can be beneficial for maximizing a PDCCH coverage for the CORESET while the second pair can be beneficial for minimizing scheduling latency for PDCCH in the CORESET.

In another example, a DCI format or MAC-CE can indicate both an applicable TCI state and the time-frequency resource allocation for a CORESET.

In another example, a combination of these variations can apply, such as a first field being jointly applicable for time-frequency resource allocation (possibly including RB-level offset or resource interleaving) and a separate second field being applicable only for indicating a modulation order for DCI provided by PDCCH receptions in the CORESET.

In another variation to the first approach, the UE can receive separate L1/L2 signaling for each parameter or each group of parameters, such as a first L1/L2 signaling for a first parameter or a first group of parameters, and a second L1/L2 signaling for a second parameter or a second group of parameters associated with a CORESET.

For example, the UE can receive a DCI format or a MAC-CE to indicate a TCI state applicable for PDCCH receptions associated with the CORESET, from a list of TCI states configured by higher layers. For example, the DCI format or the MAC-CE for the TCI state indication can be provided separately from an L1/L2 signaling to indicate other CORESET parameters such as time or frequency resource allocation for the CORESET, as previously described.

In another variation, a field in the L1/L2 signaling can indicate a corresponding value for more than one CORESETs. For example, a same value (e.g., a same time duration) can apply to different configured or activated CORESETs or may apply to different CORESETs indicated by respective CORESET IDs or by a bitmap or by an index of a CORESET combination.

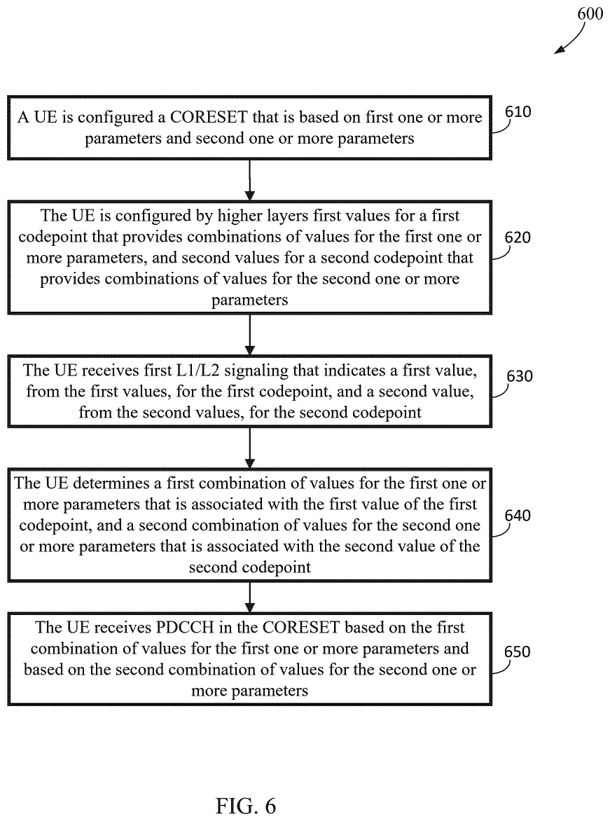

FIG. 6 illustrates an example process 600 of L1/L2 signaling for indication of values, among corresponding higher layer configured values, for multiple groups of CORESET parameters according to one or more embodiments of the present disclosure. The process 600 of FIG. 6 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 600 is for illustration only and other embodiments can be used without departing from the scope of the present disclosure.

The process 600 begins with the UE being configured a CORESET that is based on first one or more parameters and second one or more parameters, 610. The UE is configured by higher layers first values for a first codepoint that provides combinations of values for the first one or more parameters, and second values for a second codepoint that provides combinations of values for the second one or more parameters, 620. The UE receives first L1/L2 signaling that indicates a first value, from the first values, for the first codepoint, and a second value, from the second values, for the second codepoint, 630. The UE determines a first combination of values for the first one or more parameters that is associated with the first value of the first codepoint, and a second combination of values for the second one or more parameters that is associated with the second value of the second codepoint, 640. The UE receives PDCCH in the CORESET based on the first combination of values for the first one or more parameters and based on the second combination of values for the second one or more parameters, 650.

According to the second approach (referred to as ‘config-level indication’), a UE can be configured multiple separate configurations for a CORESET ID, wherein each of the multiple configurations provides a set of values for the CORESET parameters, including parameters that are different among the multiple configurations, and parameters that are same across the different configurations. The multiple configuration can be part of the CORESET configuration and then a separate configuration of the CORESET ID for each of the multiple configurations is not needed. For example, each configuration provides a single value for each CORESET parameter. For example, L1/L2 signaling can indicate an index of a configuration, among the multiple indexes for respective multiple configurations, for the corresponding CORESET ID. For example, to receive PDCCH in the corresponding CORESET, the UE applies the parameter values that are associated with the indicated configuration for the CORESET.

For example, for a given CORESET ID, a first configuration includes one or more of the following:
the CORESET ID,
a first index for the first configuration,
a first value for CORESET duration,
a first value for the frequency resource bitmap or RIV,
a first value for RB-level offset,
a first value for resource interleaving,
a first value for PDCCH modulation type,
a first value for TCI state,
a first value to indicate or not the configuration as an initial/first-active configuration,
a value for pdcch-DMRS-ScramblingID,
a value for precoderGranularity,
a value for coresetPoolIndex,
a value for followUnifiedTCI-State,
a value for applyIndicatedTCI-State;
   and, for the same given CORESET ID, a second configuration includes one or more of the following:
the CORESET ID,
a second index for the second configuration,
a second value for CORESET duration,
a second value for the frequency resource bitmap or RIV,
a second value for RB-level offset,
a second value for resource interleaving,
a second value for PDCCH modulation type,
a second value for TCI state,
a second value to indicate or not the configuration as an initial/first-active configuration,
the [same] value for pdcch-DMRS-ScramblingID,
the [same] value for precoderGranularity,
the [same] value for coresetPoolIndex,
the [same] value for followUnifiedTCI-State,
the [same] value for applyIndicatedTCI-State.

In a variation to the second approach, certain CORESET parameters that are shared among the multiple configurations are provided by a ‘common’ configuration for the corresponding CORESET. For example, the UE can be configured, for the corresponding CORESET ID, multiple sub-configurations that include values only for parameters are that are different among the sub-configurations.

For example, the ‘common’ configuration for a given CORESET ID provides single values for one or more of {pdcch-DMRS-ScramblingID, precoderGranularity, coresetPoolIndex, followUnifiedTCI-State, applyIndicatedTCI-State} that are applied irrespective of an indicated/applicable sub-configuration.

For example, for a given CORESET ID, a first sub-configuration includes one or more of the following (the CORESET ID can be excluded if the sub-configuration is part of the CORESET configuration):
the CORESET ID, if applicable
a first index for the first sub-configuration,
a first value for CORESET duration,
a first value for the frequency resource bitmap or RIV,
a first value for RB-level offset,
a first value for resource interleaving,
a first value for PDCCH modulation type,
a first value for TCI state,
a first value to indicate or not the sub-configuration as an initial/first-active sub-configuration;
   and, for the same given CORESET ID, a second sub-configuration includes one or more of the following (the CORESET ID can be excluded if the sub-configuration is part of the CORESET configuration):
the CORESET ID, if applicable
a second index for the second sub-configuration,
a second value for CORESET duration,
a second value for the frequency resource bitmap or RIV,
a second value for RB-level offset,
a second value for resource interleaving,
a second value for PDCCH modulation type,
a second value for TCI state,
a second value to indicate or not the sub-configuration as an initial/first-active sub-configuration.

For example, the UE can receive L1/L2 signaling that indicates an index of a sub-configuration for a CORESET. For example, the UE monitors and receives PDCCH in the CORESET based on the parameters in the ‘common’ configuration for the CORESET and the parameters provided by the indicated sub-configuration for the CORESET. In another example, no ‘common’ configuration is present, and the UE can be configured separate/different parameters for all CORESET parameters, including one or more of {pdcch-DMRS-ScramblingID, precoderGranularity, coresetPoolIndex, followUnifiedTCI-State, applyIndicatedTCI-State}.

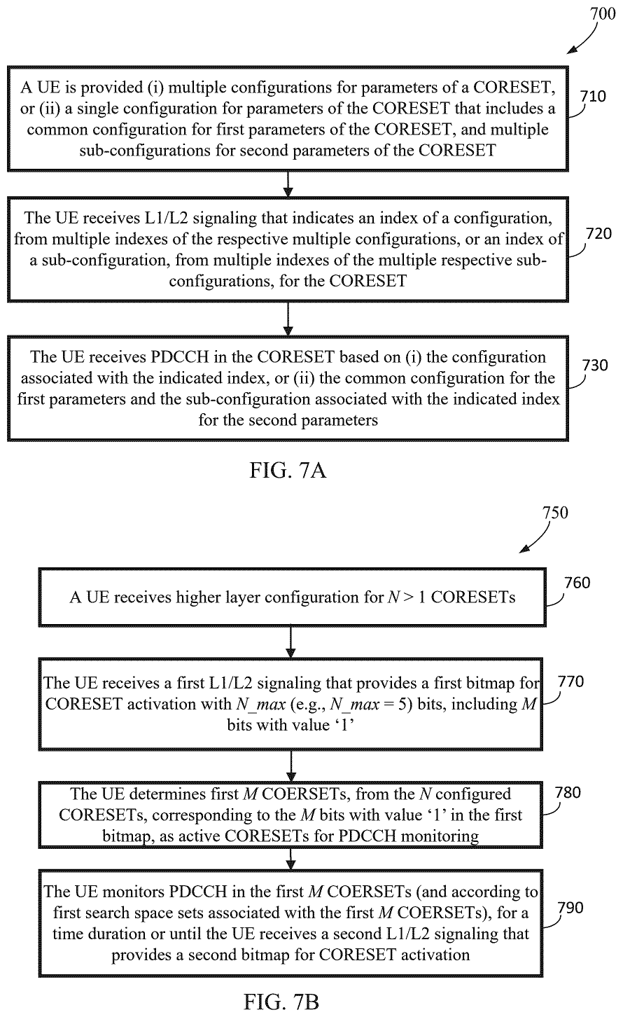

FIG. 7A illustrates an example process 700 of L1/L2 signaling for indication of a configuration index or a sub-configuration index, among multiple configurations/sub-configurations, for a CORESET according to one or more embodiments of the present disclosure. The process 700 of FIG. 7A can be performed by any of the UEs 111-116 of FIG. 1, such as the UE 116 of FIG. 3, and a corresponding method can be performed by any of the BSs 101-103 of FIG. 1, such as BS 102 of FIG. 2. The process 700 is for illustration only and other embodiments can be used without departing from the scope of the present disclosure.

The process 700 begins with the UE being provided (i) multiple configurations for parameters of a CORESET, or (ii) a single configuration for parameters of the CORESET that includes a common configuration for first parameters of the CORESET, and multiple sub-configurations for second parameters of the CORESET, 710. The UE receives L1/L2 signaling that indicates an index of a configuration, from multiple indexes of the respective multiple configurations, or an index of a sub-configuration, from multiple indexes of the respective multiple sub-configurations, for the CORESET, 720. The UE receives PDCCH in the CORESET based on (i) the configuration associated with the indicated index, or (ii) the common configuration for the first parameters and the sub-configuration associated with the indicated index for the second parameters, 730.

According to the third approach (referred to as ‘CORESET-level indication’), L1/L2 signaling indicates or activates a number of CORESETs from multiple configured CORESETs. For example, the UE is configured N>1 CORESETs, and L1/L2 signaling indicates or activates M≤N CORESETs from the N configured CORESETs. For example, the N>1 CORESETs may include a CORESET with index #0 or may exclude a CORESET with index #0, as previously described in embodiments herein. For example, L1/L2 signaling can be in terms of a bitmap with N bits, wherein a value ‘0’ indicates that a corresponding CORESET is not activated, and a value ‘1’ indicates that a corresponding CORESET is activated for PDCCH monitoring.

For example, to preserve a size of a bitmap, the bitmap can include a predetermined or configured number of N_max bits, such as 5 bits, independent of a number N of CORESETs configured to a UE. For example, a UE applies the bits of a bitmap based on an index of configured CORESETs to the UE, such as first bit corresponding to a CORESET index #1, a second bit corresponding to a CORESET index #2, and so on. For example, when the UE is not configured a CORESET with index #2, the UE discards a corresponding bit in the bitmap or discard corresponding information fields or blocks. In another example, a UE applies the bits of the bitmap in ascending order of CORESET IDs, independent of a value of such indexes, for example, a first bit corresponding to a configured CORESET with smallest index, a second bit corresponding to a configured CORESET with second smallest index, and so on. For example, when N_max>N, the UE discards (N_max−N) bits that do not correspond to indexes of the CORESETs configured to the UE (for the former example), or discards (N_max−N) LSBs of the bitmap (for the latter example).

In one example, the bitmap can include any number of is and thereby activate any number of CORESET, that is, 0≤M≤N or 0<M≤N. In another example, the UE can report a maximum number M_max of active CORESETs, wherein M_max≤N or M_max<N. For example, the UE expects that a number of 1s in the bitmap, and thereby a number of activated CORESETs, does not exceed a reported value M_max.

In one example, search space sets are associated only with active CORESETs, instead of configured CORESETs. For example, an association of CORESET IDs with search space sets can be configured by higher layers, while an association of the CORESETs with CORESET IDs (for the purpose of search space association) can be flexible based on a bitmap for CORESET activation. For example, the UE determines CORESET indexes based on an ordering of is in a bitmap for CORESET activation.

For example, the UE can be configured search space sets that are associated with CORESET ID values in a set {0, 1, 2} or {0, 1, 2, 3, 4}. For example, a bitmap can include a number N_max of bits that is larger than a maximum CORESET ID. For example, the UE determines a CORESET index #1 in the search space associations to be a CORESET corresponding to a first bit location in the bitmap that has a value ‘1’. For example, the UE determines a CORESET index #2 in the search space associations to be a CORESET corresponding to a second bit location in the bitmap that has a value ‘1’, and so on. For example, the UE determines a CORESET index #0 to be always active without any indication by the bitmap, or can be a CORESET corresponding to a zero-th bit location in the bitmap that has a value ‘1’.

FIG. 7B illustrates an example process 750 of L1/L2 signaling in the form of a bitmap that activates a number of M≤N CORESETs from a number of N>1 configured CORESETs according to one or more embodiments of the present disclosure. The process 750 of FIG. 7B can be performed by any of the UEs 111-116 of FIG. 1, such as the UE 116 of FIG. 3, and a corresponding method can be performed by any of the BSs 101-103 of FIG. 1, such as BS 102 of FIG. 2. The process 750 is for illustration only and other embodiments can be used without departing from the scope of the present disclosure.

The process 750 begins with the UE receiving higher layer configuration for N>1 CORESETs, 760. The UE receives a first L1/L2 signaling that provides a first bitmap for CORESET activation with N_max (e.g., N_max=5) bits, including M bits with value ‘1’, 770. The UE determines first M CORESETs, from the N configured CORESETs, corresponding to the M bits with value ‘1’ in the first bitmap, as active CORESETs for PDCCH monitoring, 780. The UE monitors PDCCH in the first M CORESETs (and according to first search space sets associated with the first M CORESETs), for a time duration or until the UE receives a second L1/L2 signaling that provides a second bitmap for CORESET activation, 790.

For indication of any CORESET/PDCCH parameter such as those previously described in embodiments herein and for any signaling method such as those previously described in embodiments herein, various L1/L2 signaling schemes can be used, for example:
a PDCCH such as a group-common DCI (GC-DCI) format in a common search space (CSS), or a UE-specific DCI format in a UE-specific search space (USS) set, or
a DL MAC-CE in a PDSCH, or
a DL channel, other than a PDCCH or PDSCH, to provide the parameters for CORESET/PDCCH,
a DL signal, based on a sequence with OFDM waveform, wherein parameters of the sequence/DL signal provide the parameters or indications for CORESET/PDCCH reception,
   as subsequently described in the embodiments herein, respectively.

Various embodiments of the present disclosure provide for application time for the indication of PDCCH/CORESET parameters. In one embodiment, the UE applies an L1/L2 signaling for indication of CORESET parameters after a processing time, from a time when the UE receives the L1/L2 signaling or from a time that the UE would transmit a PUCCH with HARQ-ACK information to acknowledge a reception of the L1/L2 signaling. The UE continues to apply the L1/L2 signaling for a number of slots or until the UE receives a next L1/L2 signaling providing an indication for the CORESET parameters.

For example, the UE applies an indication from L1/L2 signaling of CORESET parameters starting from a same slot and a same symbol where the L1/L2 signaling is received. In another example, the UE applies the indication after a slot offset or symbol offset, such as N slots or M symbols, from a slot and symbol where the UE receives the L1/L2 signaling. For example, the values of slot offset N or symbol offset M can be based on a UE capability, or based on higher layer configuration, or can be predetermined in the specifications. For example, the UE starts to the apply the indication from a first symbol of a next slot after reception of the L1/L2 signaling.

For example, the UE applies the indication from the L1/L2 signaling after a time for a potential transmission of a channel with HARQ-ACK information, such as a PUCCH or a PUSCH, to acknowledge a correct reception of the indication. For example, the HARQ-ACK information and corresponding resource for the channel can be UE-specific, for example, at least when the L1/L2 signaling is UE-specific. For example, the HARQ-ACK information and corresponding resource for the channel can be UE-group-specific, for example, at least when the L1/L2 signaling is UE-group-specific. For example, the resource for the channel can be shared among UEs in the UE group. For example, a UE in the UE-group transmits a NACK in the shared resource for the channel when the UE cannot correctly receive or decode the indication, otherwise the UE does not transmit the channel in the resource.

For example, the UE applies the indication from the L1/L2 signaling N slots or M symbols after a time for a potential transmission of associated HARQ-ACK information, wherein the values of slot offset N or symbol offset M can be based on a UE capability, or based on higher layer configuration, or are predetermined in the specifications. For example, the slot offset can be

$$3 {N}_{slot}^{subframe , μ} .$$

For example, the UE applies the indication starting from a slot

$$k + 3 {N}_{slot}^{subframe , μ}$$

where k is the slot where the UE would transmit a channel with HARQ-ACK information associated with the indication and μ is the SCS configuration for the channel transmission. In another example, the UE applies the L1/L2 signalling from a first/earliest slot that is after the slot

$$k + 3 {N}_{slot}^{subframe , μ} .$$

For example, the offset

$$3 {N}_{slot}^{subframe , μ}$$

can be replaced with a different predetermined or configured offset.

For example, the UE applies the indication for a set of slots or slot patterns or a duration or number of slots configured by higher layers or indicated by the L1/L2 signaling. In another example, the UE applies the indication until reception of a next L1/L2 signaling that provides an indication of the CORESET parameters.

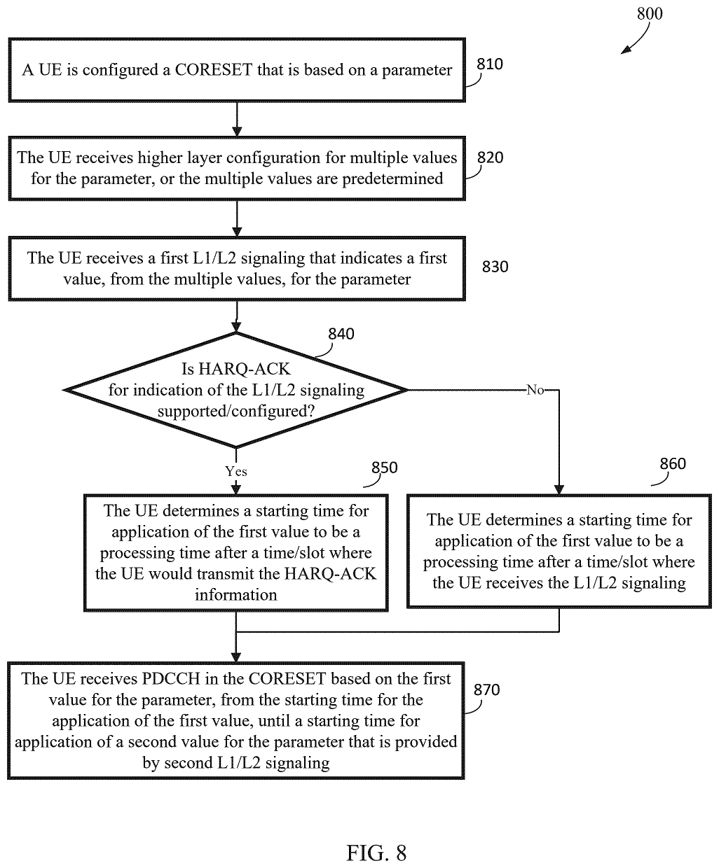

FIG. 8 illustrates an example process 800 of application time for an indication by L1/L2 signaling for values of CORESET parameters according to one or more embodiments of the present disclosure. The process 800 of FIG. 8 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 800 is for illustration only and other embodiments can be used without departing from the scope of the present disclosure.

The process 800 begins with the UE being configured a CORESET that is based on a parameter, 810. The UE receives higher layer configuration for multiple values of the parameter, or the multiple values are predetermined, 820. The UE receives a first L1/L2 signaling that indicates a first value, from the multiple values, for the parameter, 830. The UE determines whether HARQ-ACK information for the indication of the L1/L2 signaling is enabled, 840. If the UE determines that HARQ-ACK information is enabled, the UE determines a starting time for application of the first value to be a processing time after a time/slot where the UE would transmit the HARQ-ACK information, 850. If the UE determines that HARQ-ACK information is disabled, the UE determines a starting time for application of the first value to be a processing time after a time/slot where the UE receives the L1/L2 signaling, 860. The UE receives PDCCH in the CORESET based on the first value for the parameter, from the starting time for the application of the first value, until a starting time for application of a second value for the parameter that is provided by second L1/L2 signaling, 870.

Various embodiments of the present disclosure provide for restrictions on L1/L2 indication of the PDCCH/CORESET parameters. In one embodiment, there may be restrictions on CORESETs for which an indication by L1/L2 signaling applies to a certain CORESET parameter. For example, the UE may not expect to use one of multiple values for one or more predetermined parameters of a CORESET, such as a CORESET #0 in a BWP, such as an initial BWP, for example, an initial BWP that is associated with a cell-defining SSB (CD-SSB). For example, such CORESET update may not apply to a CORESET #0 or a different CORESET that is used for reception of broadcast/common PDCCH, such as for reception of PDCCH/DCI that schedules one or more of SIB, paging, RAR, and so on. In another example, an update for such CORESETs can be also possible, and provided by UE-common/cell-specific DCI format, such as by an RRC/SIB reconfiguration or by a paging DCI or PEI DCI or a DL wake-up DCI format, or by a sequence-based DL wake-up (WUS) signal.

For example, an indication of CORESET parameters via L1/L2 signaling can apply to any CORESET configured to a UE. For example, the UE determines whether an indication by L1/L2 signaling applies to a parameter of a CORESET based on whether multiple values are predetermined or are configured by higher layers for the parameter. For example, when the UE receives by higher layers a configuration providing multiple values for the parameter, the UE determines that an indication by L1/L2 signaling applies to the CORESET. For example, when the UE receives a higher layer configuration providing a single value for a CORESET parameter, the UE determines that an indication by L1/L2 signaling does not apply to the parameter for the CORESET.

In another example, there can be restrictions, such as by the specifications of system operation, on CORESETs for which an indication by L1/L2 signaling is applicable for a given CORESET parameter or for any/all CORESET parameter. For example, the specifications of system operation can preclude an indication by L1/L2 signaling (other than PBCH/MIB) for values of certain parameters of a certain CORESET.

For example, the specifications may preclude an indication of L1/L2 signaling for one or more (or all) of duration, frequency allocation, RB-level offset, interleaving, or modulation type, for a certain CORESET, such as a CORESET with index 0 (CORESET #0). In one example, such restrictions apply to any CORESET #0 in any BWP or associated with any SSB. In another example, such restriction applies only to a CORESET #0 in a BWP (such as an initial BWP) that is associated with a cell-defining SSB (CD-SSB). For example, the specifications may not preclude such indication by L1/L2 signaling to apply for a CORESET #0 in a BWP that is associated with a non-cell-defining SSB (NCD-SSB). For example, the UE does not expect to be configured with multiple values for parameters of a CORESET #0, such as a CORESET #0 in an initial BWP or in a BWP associated with CD-SSB.

Various embodiments of the present disclosure provide for configurations and procedures to handle inconsistency between L1/L2 indication of the PDCCH/CORESET parameters and associated search space sets. In one embodiment, an association of CSS/USS sets with a CORESET can be impacted by an L1/L2 signaling that indicates parameters for the CORESET or for PDCCH/DCI reception. The gNB can ensure that L1/L2 signaling for CORESET parameters is consistent with higher layer configuration for the associated search space sets, or the UE is predetermined certain procedures to handle such inconsistencies. Alternatively, a linkage between CSS/USS sets with the CORESET can be flexible to allow for a CSS/USS set to be associated with a CORESET only for certain parameter values or only for certain configuration/sub-configuration indexes for the CORESET.

In a first option, the UE expects that the parameters configured for CSS/USS set are consistent with any of the multiple configured values for the CORESET/PDCCH parameters.

For example, the UE expects that a CORESET duration indicated by L1/L2 signaling is such that PDCCH monitoring occasions (MOs) configured in any CSS/USS set associated with the CORESET, as derived based on the monitoringSymbolsWithinSlot do not cross the slot boundaries, or do not overlap with each other.

For example, the UE does not expect that symbol indexes {1, 12} are configured for monitoringSymbolsWithinSlot for a CSS/USS set associated with a CORESET and that L1/L2 signaling indicates a duration of 3 symbols for the CORESET, so that 12+3>14 would cross the slot boundary. For example, the UE does not expect that symbol indexes {1, 3} are configured for monitoringSymbolsWithinSlot for a CSS/USS set associated with a CORESET and that L1/L2 signaling indicates a duration of 3 symbols for the CORESET, so that 1+3>3 would result in overlap of PDCCH MOs.

For example, the UE does not expect that L1/L2 signaling indicates a duration and/or a frequency allocation for a CORESET that would include fewer CCEs than that configured by a number of PDCCH candidates and a corresponding aggregation level (AL) for some of the CSS/USS sets associated with the CORESET. For example, when a search space associated with the CORESET configures 4 PDCCH candidates with AL=8, the UE expects that the CORESET includes at least 4*8=32 CCEs or 32*6=192 REGs. For example, the UE does not expect that L1/L2 signaling indicates a duration and/or frequency allocation for the CORESET that results in less than 192 REGs, such as less than 192 RBs for a 1-symbol CORESET, or less than 192/2=96 RBs for a 2-symbol CORESET, or less than 192/3=64 RBs for a 3-symbol CORESET.

In a second option, the specifications of system operations predetermine UE procedures to handle inconsistency events wherein a value indicated by L1/L2 signaling for a CORESET/PDCCH parameter is not consistent with the parameters configured for some of CSS/USS sets associated with the CORESET.

For example, when L1/L2 signaling indicates a CORESET duration value that results in first PDCCH MOs of a CSS/USS set associated with the CORESET to cross a slot boundary, the UE discards/drops the first PDCCH MOs, that is, the UE does not monitor PDCCH in the CORESET according to the CSS/USS set in the first PDCCH MOs. In another example, such dropping rule applies only when the first PDCCH MOs overlap with second PDCCH MOs (such as second PCCH MOs associated with the same CSS/USS set or additionally/alternatively second PDCCH MOs associated with a different CSS/USS set) in a next/adjacent slot. For example, when the first PDCCH MOs do not overlap with any PDCCH MOs in a next/adjacent slot, the UE continues to monitor PDCCH in the CORESET according to the CSS/USS set in the first PDCCH MOs.

For example, when L1/L2 signaling indicates a CORESET duration value that results in first PDCCH MOs of a CSS/USS set associated with the CORESET to overlap with second PDCCH MOs associated with the same CSS/USS set, the UE discards/drops the first PDCCH MOs or the second PDCCH MOs, that is, the UE does not monitor PDCCH in the CORESET according to the CSS/USS set in the first PDCCH MOs or in the second PDCCH MOs. In one example, the UE does not monitor PDCCH in none of the first PDCCH MOs nor the second PDCCH MOs. In another example, the UE does not monitor PDCCH in only one of the first PDCCH MOs or the second PDCCH MOs, for example, drop the PDCCH MOs that start later (or earlier) in a slot.

For example, when indicated CORESET parameters result in a small CORESET that cannot accommodate large AL values, some PDCCH candidates can be dropped. For example, when L1/L2 signaling indicates a time duration or a frequency allocation for a CORESET that does not result in sufficient number of CCEs/REGs to support a configured number of PDCCH candidates for one or more AL values, the UE can drop some or all of the PDCCH candidates for the corresponding one or more AL values.

For example, the UE drops a first PDCCH candidate (that is, the UE does not monitor the first PDCCH candidate) for a first AL value when the first PDCCH candidate overlaps with a second PDCCH candidate for the first AL (or for a second AL value), wherein the first and second PDCCH candidates are associated with a same CSS/USS set. For example, the first PDCCH candidate has a larger index than the second PDCCH candidate. For example, the first AL is larger than the second AL value.

For example, the UE drops the PDCCH candidates:
first, in descending order of PDCCH candidates within an AL value, and
second, in descending (or ascending) order of AL value.

For example, dropping can be per AL value (instead of per PDCCH candidate). For example, when first PDCCH candidates of a USS/CSS set for a first AL value overlap with second PDCCH candidates of the USS/CSS set for the first AL value (or for a second AL, such as with a smaller AL value), the UE drops any/all PDCCH candidates of the USS/CSS set for the first AL value.

For example, dropping can be per search space set (instead of per PDCCH candidate or per AL value). For example, when first PDCCH candidates of a USS/CSS set for a first AL value overlap with second PDCCH candidates of the USS/CSS set for the first AL value (or for a second AL, such as with a smaller AL value), the UE does not monitor PDCCH according to the USS/CSS set, that is, the UE drops all configured PDCCH candidates of the USS/CSS set for all configured AL value.

In another variation, a re-distribution method may be applied instead of dropping the PDCCH candidates. For example, when the UE determines that first CCEs corresponding to first PDCCH candidates associated with a first AL value, such as a larger AL value, overlap with second CCEs corresponding to second PDCCH candidates associated with the first AL value (or associated with a second AL value, such as a smaller AL value), the UE determines third CCEs for the first PDCCH candidates. For example, the UE determines the third CCEs based on a modified formula for search space equation. For example, the third CCEs are those corresponding to third PDCCH candidates associated with a third AL value, such as a smallest AL configured to the UE for a corresponding USS/CSS set. For example, the first PDCCH candidates for the first/large CCE AL may be distributed among third PDCCH candidates for third CCE ALs that can be supported (for example, starting from a smallest CCE AL.

In a third option, the UE can be configured a CSS/USS set that is associated with certain values of configuration/sub-configuration index for a CORESET, or for certain parameter values for the CORESET.

For example, when a UE is configured multiple configurations or multiple sub-configurations with different indexes for a CORESET, as previously described in embodiments herein, the UE can be configured a CSS/USS set that is associated with first configurations or sub-configurations with first indexes, and is not associated with second configurations or sub-configurations with second indexes. For example, the UE expects that the first configurations or sub-configurations for the CORESET are consistent with higher layer configuration for the CSS/USS set, while the second configurations or sub-configurations may not be consistent with the CSS/USS set.

For example, a higher layer configuration for a CSS/USS set includes, in addition to a controlResourceSetId information element (IE), also a controlResourceSeConfigtId IE or controlResourceSetSubConfigId IE that can take one or multiple values/indexes for the corresponding CORESET.

For example, a higher layer configuration for a CSS/USS set includes one or multiple values/indexes for a controlResourceSetId information element (IE) that refer to one or more of the ‘configured’ CORESETs, and the UE monitors PDCCH according to the CSS/USS set in an ‘active’ CORESET from the one or multiple ‘configured’ CORESETs associated with the one or multiple values/indexes. For example, the UE expects that the one or more of the ‘configured’ CORESETs are consistent with the CSS/USS set.

For example, when L1/L2 signaling indicates a configuration index or a sub-configuration index for a CORESET or an ‘active’ CORESET ID that is not associated with a CSS/USS set, the UE does not monitor PDCCH in the CORESET according to the CSS/USS set. For example, when a CSS/USS set is associated with multiple CORESET IDs, and more than one of the associated CORESETs are ‘active’ CORESETs, in one option, the UE monitors PDCCH according to CSS set/USS set in a CORESET with smallest (or largest) index among the associated ‘active’ CORESETs, while in another option, the UE monitors PDCCH according to CSS set/USS set in all of such associated ‘active’ CORESETs.

Various embodiments of the present disclosure provide for rate matching indication for PDSCH based on L1/L2 indication of the PDCCH/CORESET parameters. In one embodiment, a UE rate matches a PDSCH around time/frequency resources allocated for a CORESET based on a last L1/L2 signaling for indication or update of the CORESET/PDCCH parameters. Alternatively, an L1/L2 signaling for CORESET/PDCCH parameters can update, overwrite, or complement the configured or activated rate matching patterns.

In a first realization, when a UE is provided a rate matching (RM) pattern that is associated with a CORESET, such as when a patternType in a RateMatchPattern configuration indicates a controlResourceSetId, and a DCI format for scheduling a PDSCH indicates the RM pattern or a RM group including the RM pattern to be activated, the UE rate matches around time/frequency resources of the CORESET based on a last/latest L1/L2 signaling that indicates the CORESET parameters, such as for CORESET duration or frequency allocation of the CORESET, or indicates a configuration or sub-configuration index for the CORESET.

In a second realization, a rate matching (RM) pattern associated with a CORESET can include a baseline time/frequency resource allocation for the CORESET, such as one associated with intersection of multiple time/frequency resource allocations configured for the CORESET. For example, L1/L2 signaling indicates additional time/frequency resources to be activated for rate matching PDSCH around.

In a third realization, L1/L2 signaling can additionally include index or associated RM patterns or RM pattern groups that are updated or overwritten by the L1/L2 signaling. For example, L1/L2 signaling indicates activated CORESETs among multiple configured CORESETs, and when a scheduling DCI format indicates a rate matching pattern associated with a CORESET ID among the activated CORESETs, the UE rate matches the PDSCH around the T/F resources of the corresponding CORESET. Alternatively, when a scheduling DCI format indicates a rate matching pattern associated with a CORESET ID that is not among the activated CORESETs, the UE need not rate match the PDSCH around T/F resources of the corresponding CORESET, and such T/F resources are available for PDSCH reception.

Various embodiments of the present disclosure provide for using DCI/PDCCH for indication of the PDCCH/CORESET parameters. In a first scheme, a DCI/PDCCH can be used for providing information of PDCCH/CORESET parameters. The DCI format can be a group-common DCI (GC-DCI) format that the UE receives according to a CSS set, or can be using a UE-specific DCI, such as a standalone DCI format or a scheduling DCI format that the UE receives according to a USS set. The UE can be configured an RNTI, such as CRI-RNTI (CORESET information RNTI), that scrambles a CRC of the DCI format. A CSS/USS set for a DCI format associated with CRI-RNTI can be separate from other CSS/USS sets associated with other DCI formats. The UE can receive PDCCHs providing the DCI format associated with CRI-RNTI in a CORESET with parameters that are configured by higher layers, or are indicated by L1/L2 signaling. Monitoring occasions (MOs) for the GC-DCI can be separately configured from MOs for other DCI formats.

Various methods and examples that are subsequently described apply at least when a DCI format for indication of CORESET parameters is a GC-DCI format with corresponding PDCCH monitoring according to a CSS set, or a UE-specific standalone DCI format, with corresponding PDCCH monitoring according to a USS set, that is not used for scheduling the corresponding UE. The GC-DCI format may also provide indications for purposes other for an adaptation of CORESET parameters. For example, certain methods and examples may also apply even when a DCI format is a UE-specific scheduling DCI format, while additional methods for using scheduling DCI formats are subsequently described in embodiments herein.

For example, a DCI format that provides an indication of values for CORESET parameters includes a CRC of 16 bits or 24 bits, that is scrambled with an RNTI, such as CRI-RNTI (CORESET information RNTI) that can be represented, for example, by 16 bits. For example, a value of the CRI-RNTI is provided by higher layers, such as by a configuration of a CSS/USS set that is associated with the DCI format. For example, a configuration for CRI-RNTI can be UE-specific or UE-group-specific or UE-common/cell-specific. For example, a length of the CRC can be predetermined in the specifications or can be configured by higher layers. For example, when such configuration is not provided, the UE assumes a default value, such as 16 bits (or 24 bits), for the length of the CRC.

For example, a CSS/USS set for a DCI format associated with CRI-RNTI is separate from other CSS/USS sets configured to the UE. For example, the CSS set is not associated with any other DCI format. In another example, a CSS/USS set associated with the DCI format associated with CRI-RNTI can be further associated with one or more other DCI formats.

For example, the UE can monitor a PDCCH that provides the DCI format associated with CRI-RNTI with a single decoding operation (single PDCCH candidate), or with a small number of decoding operations (small number of PDCCH candidates, such as 2 or 4 PDCCH candidates). For example, CCEs for the DCI format with CRI-RNTI can be predetermined in the specifications, such as the first 4 CCEs in the CORESET, or can be configured by higher layers. For example, first CCEs for the DCI format with CRI-RNTI is known (predetermined/configured) to the UE, the first CCEs puncture other CCEs in the CORSET that are used for PDCCHs providing other DCI formats.

For example, an initial value Y_{p,-1} of a hash function in the search space equation can be Y_{p,-1}=n_{RNTI} equal to CRI-RNTI, instead of Y_{p,-1}=0, for PDCCH monitoring in the CSS/USS set associated with the DCI format associated with CRI-RNTI. For example, a search space equation for PDCCH monitoring can be

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

with parameters as previously described, except for Y_{p,-1}=n_{RNTI} that is described earlier.

In one example, monitoring occasions (MOs) for a PDCCH that provides the DCI format associated with CRI-RNTI are separate from MOs for other PDCCHs that provide other DCI formats. For example, when the UE monitors PDCCH for the DCI format associated with CRI-RNTI, the UE does not expect to monitor PDCCHs according to other USS sets or CSS sets and may drop such PDCCH candidates, when any. For example, the UE does not expect to be configured to monitor PDCCHs for the DCI format associated with CRI-RNTI in MOs that overlap with MOs for monitoring PDCCHs at least according to USS sets or Type-3 CSS. For example, the UE can monitor PDCCH according to other CSS sets or USS sets in MOs that have at least a gap of N symbols or M slots from MOs where the UE monitors PDCCH providing the DCI format associated with CRI-RNTI. For example, a value of N or M can be based on a UE capability for a processing time or application time for the DCI format. For example, a value N or M is predetermined in the specifications. For example, such separation or time gap applies only to USS sets and Type-3 CSS set, and may not apply to other CSS sets such as Type-0/0A/1/1A/2/2A. For example, the latter CSS sets can be associated with a CORESET #0 with higher layer configured parameters, and the DCI format is not applicable for CORESET #0, as previously described in embodiments herein.

In other examples, MOs for a PDCCH that provides the DCI format associated with CRI-RNTI can partially or fully overlap with MOs for other PDCCHs that provide other DCI formats. For example, MOs for the CSS/USS set associated with CRI-RNTI can partially or fully coincide with MOs for other CSS sets or USS sets for the UE.

For example, the UE does not expect to apply an indication of parameters for a CORESET, wherein the indication is provided by the DCI format associated with CRI-RNTI, to PDCCH receptions according to USS sets or CSS sets that (i) are associated with the CORESET, and (ii) partially or fully overlap, when applicable, with PDCCH MOs for the DCI format associated with CRI-RNTI.

For example, the UE does not expect to apply an indication of parameters for a CORESET, wherein the indication is provided by the DCI format associated with CRI-RNTI, to PDCCH receptions according to USS sets or CSS sets that (i) are associated with the CORESET, and (ii) have PDCCH MOs that are earlier than a minimum time gap from PDCCH MOs for the DCI format associated with CRI-RNTI, when applicable. For example, the minimum time gap can be based on the processing/application timeline as previously described.

For example, for reception of such PDCCHs, the UE applies parameter values that are indicated by a last indication in a last DCI format (associated with CRI-RNTI) that was correctly received, or by a last configuration, or applies default/fallback parameter values. For example, such UE behavior applies at least when a processing time or application time for an indication of CORESET parameters by a DCI format is non-zero, such as one or more symbols.

For example, the UE can indicate a capability whether the UE can support PDCCH MOs for the CSS/USS set associated with the DCI format with the CRI-RNTI that are partially or fully overlapped with, or are within a minimum time gap from, PDCCH MOs for other CSS sets or USS sets.

Various options can be considered for a CORESET where a UE monitors PDCCHs for the DCI format associated with the CRI-RNTI.

In a first option, the CORESET has no parameters that are based on an indication by L1/L2 signaling, except possibly for a TCI state associated with the CORESET. For example, various parameters for that CORESET are configured by higher layers, and are not indicated or updated by L1/L2 signaling. In one example, a dedicated CORESET, such as a CORESET with one symbol, is configured for the DCI format with CRI-RNTI. In another example, the UE can also monitor other DCI formats in a CORESET in which the UE monitors the DCI format with CRI-RNTI.

In a second option, the CORESET associated with the CSS/USS set for the DCI format with the CRI-RNTI can be based on parameters that are indicated by L1/L2 signaling, such as a last/latest DCI format associated with CRI-RNTI. In one example, the UE monitors/receives PDCCHs in the CORESET based on the last/latest correctly received higher layer configuration or indication by the DCI format for the CORESET parameters. For example, the UE monitors PDCCH for the DCI format associated with the CRI-RNTI based on a CORESET duration or a frequency allocation bitmap or RIV that is provided by a last/latest RRC configuration or indication by the DCI format. For example, N_{CCE,p} in the search space formula and thereby indexing of CCEs for determining a PDCCH candidate according to the CSS/USS set can be based on a last/latest RRC configuration or indication by the DCI format for the CORESET duration or the frequency allocation bitmap or RIV.

In a third example, the UE monitors PDCCH in the CORESET based on default or fallback values for the CORESET parameters. For example, the UE receives the PDCCH based on smallest value or smallest index value configured for the CORESET parameter, or based on an intersection of values configured for the CORESET parameter, as previously described in embodiments herein. For example, the UE monitors PDCCH for the DCI format associated with the CRI-RNTI based on a shortest CORESET duration and a smallest index frequency allocation bitmap or RIV (or smallest RIV value) that is configured by higher layers for the CORESET, or based on an intersection of different configured bitmaps or intersection of RBs/CCEs that are indicated by different configured RIV values. For example, the UE assumes PDCCH reception for the DCI format associated with the CRI-RNTI only in one first symbol of the CORESET, or only in a certain number of CCEs in the CORESET, such as only one first CCE or only first 4 CCEs (or first 8 CCEs) of the CORESET, wherein the number can be predetermined in the specifications or can be provided by higher layers. For example, N_{CCE,p} in the search space formula and thereby indexing of CCEs for determining a PDCCH candidate (according to the CSS/USS set associated with CRI-RNTI) can be based on such default values.

In a fourth option, for a CORESET where the UE monitors PDCCH for detection of the DCI format associated with CRI-RNTI, and for first parameters of the CORESET, higher layer configuration can provide first values that are used for monitoring and reception of first PDCCHs that provide the DCI format associated with CRI-RNTI, and can separately provide second values that are configured for indication by the DCI format of the first parameters and are used for monitoring and reception of second PDCCHs that provide other DCI formats in the same CORESET. For example, the UE can be configured a first duration or time pattern for the CORESET for reception of the DCI format associated with CRI-RNTI, and second durations or time pattern for the CORESET that are indicated by the DCI format associated with CRI-RNTI and are used for monitoring/reception of other DCI formats in the CORESET. For example, the first duration or time pattern can be included in the second durations or time patterns or can be different/separate from the second durations or time patterns. Similar, for the frequency allocation bitmap or RIV value, and other CORESET parameters. The fourth option applies at least when MOs for the DCI format with CRI-RNTI is different from MOs for other DCI formats.

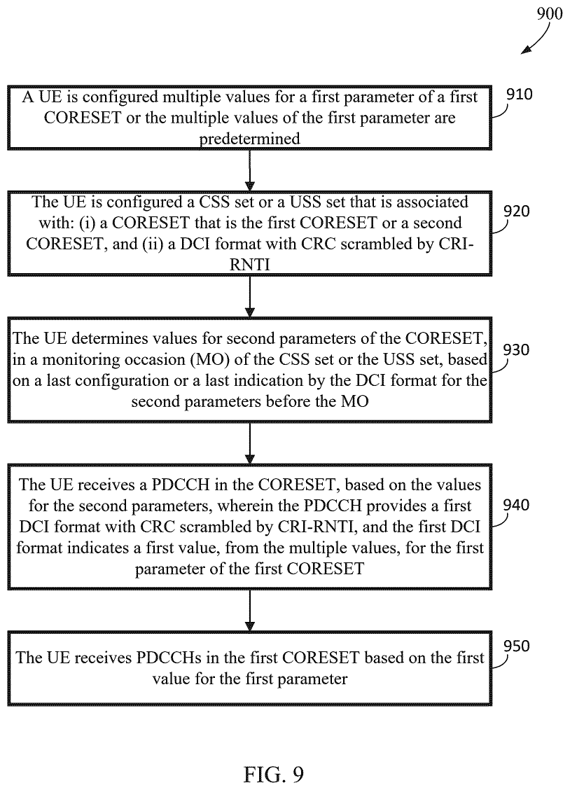

FIG. 9 illustrates an example process 900 of using a DCI/PDCCH as the signaling scheme for indication of a CORESET parameters according to one or more embodiments of the present disclosure. The process 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 900 is for illustration only and other embodiments can be used without departing from the scope of the present disclosure.

The process 900 begins with the UE being configured multiple values for a first parameter of a first CORESET or the values of the first parameter are predetermined, 910. The UE is configured a CSS set or a USS set that is associated with: (i) a CORESET that is the first CORESET or a second CORESET, and (ii) a DCI format with CRC scrambled by CRI-RNTI, 920. The UE determines values for second parameters of the CORESET, in a monitoring occasion (MO) of the CSS set or the USS set, based on a last configuration or a last indication by the DCI format for the second parameters before the MO, 930. The UE receives a PDCCH in the CORESET, based on the values for the second parameters, wherein the PDCCH provides a first DCI format with CRC scrambled by CRI-RNTI, and the first DCI format indicates a first value, from the multiple values, for the first parameter of the first CORESET, 940. The UE receives PDCCHs in the first CORESET based on the first value for the first parameter, 950.

A size for the DCI format associated with CRI-RNTI can be configured to a UE by higher layers, or can be determined by the UE based on a predetermined list of fields for the DCI format, such as those subsequently described in embodiments herein, and by additional zero-padding, if any is applicable. For example, the number of bits for a field, from the list of fields, can be predetermined in the specifications or can be indicated by higher layers.

In one example, the UE does not expect a size of the DCI format associated with CRI-RNTI to be smaller than a smallest size of a DCI format configured to the UE, such as a fallback DCI format, such as DCI format 0_0/1_0 in NR, used for scheduling at least prior to the UE establishing RRC-dedicated configuration with a serving gNB. For example, when a size of the DCI format associated with CRI-RNTI is smaller than a size of a DCI format 0_0/1_0, the UE appends a number of zeros to the DCI format associated with CRI-RNTI until the DCI format size is same as a size of the fallback DCI format, such as DCI format 0_0/1_0. In another example, a size of the DCI format associated with CRI-RNTI can be larger than a size of a shortest DCI format configured to the UE. For example, when necessary, the UE appends a number of zeros to the DCI format associated with CRI-RNTI until the DCI format size is same as a size of a smallest-size DCI format that is larger than the DCI format associated with CRI-RNTI.

Various embodiments of the present disclosure provide for using group-common DCI (GC-DCI) in a CSS set for indication of PDCCH/CORESET parameters. In a first realization of the first scheme, a group-common DCI (GC-DCI) format for indication of CORESET/PDCCH parameters can be based on a UE-group-common CRI-RNTI and PDCCH candidates providing the GC-DCI can be determined according to a CSS set. The GC-DCI format can include multiple information blocks that are associated with multiple CORESET IDs, or multiple CORESET group IDs, or one or more CORESET combinations or are associated with CORESET(s) of multiple UEs. At least for the latter method, the UE can be configured a same number of bits for each of the multiple information blocks, or corresponding fields thereof, or the UE can assume that a number of bits for each of the multiple information blocks, or corresponding fields thereof, is same as that identified for an information block, or corresponding fields thereof, associated with the UE.

In one method, the GC-DCI includes a number of information blocks, wherein each block is associated with a certain CORESET. For example, a first information block is for a first CORESET, e.g. CORESET with index of 1, a second information block is for a second CORESET, e.g. CORESET with index of 2, and so on. A CORESET with a given index may or may not be configured for a UE. For example, a UE can be configured a CORESET with index 2 and not be configured a CORESET with index 1, and the UE applies the second information block to the CORESET with index 2, and does not apply the first information block to any CORESET. Alternatively, for example, any UE that is configured a same CRI-RNTI applies the information fields/blocks in such order to CORESETs the UE is configured with, for example, the UE applies a first information block to a configured CORESET with smallest index, a second information block to a configured CORESET with second smallest index, and so on.

For example, a first information block is for a CORESET index #0 (such as a CORESET #0), a second information block is for a CORESET index #1, and so on. In another example, the indication by the GC-DCI format may not be applicable to a CORESET with index #0, as previously described in embodiments herein, at least when the CORESET with index #0 is in the initial DL BWP. For example, a first information block is for a CORESET index #1, a second information block is for a CORESET index #2, and so on.

Such a method can be beneficial, for example, when a same CORESET is shared among multiple UEs, and an indication of CORESET parameters can apply to the multiple UEs. For example, a CORESET index #1 is same for both a UE #1 and a UE #2 that receive a GC-DCI format with a same CRI-RNTI.

Alternatively, different UEs that receive a same GC-DCI format may not share some of the CORESETs, and only apply the corresponding indications to corresponding CORESETs. For example, a CORESET index #1 for a UE #1 may be different from a CORESET index #1 for a UE #2 that receives a same GC-DCI with a same CRI-RNTI. For example, indications in the GC-DCI are shared, for example, to achieve more efficient signaling overhead, while underlying values or corresponding CORESETs can be different.

For example, the following information is provided by means of the GC-DCI format with CRC scrambled by CRI-RNTI:
information block 0 for CORESET index #0, if applicable,
information block 1 for CORESET index #1,
information block 2 for CORESET index #2,
. . . ,
information block (N−1) for CORESET index #(N−1).

For example, the GC-DCI includes a predetermined number N of information blocks, such as N=5 information blocks corresponding to 5 CORESET, or a number N of information blocks in a GC-DCI can be configured by higher layers.

For example, when a UE is configured fewer CORESETs than a predetermined/configured number of information blocks, the UE discards the remaining information blocks. For example, when a UE is configured 2 CORESETs, and the GC-DCI includes 5 information blocks, the UE applies the indications provided by the first 2 information blocks (or provided by the 2 information blocks with same indexes as the configured CORESET IDs for the UE) to the 2 configured CORESETs, and discards the remaining 3 information blocks.

For example, when a UE is configured a larger number of CORESETs than a predetermined/configured number of information blocks in the GC-DCI, the UE applies the indications to respective configured CORESETs, based on the corresponding indexes, and does not apply dynamic indication to other configured CORESETs. For example, when a UE is configured 5 CORESETs with indexes #0, #1, #2, #3, and #4, and the GC-DCI includes only 4 information blocks that are, for example, associated with the first four CORESET indexes, the UE applies the indications provided by the 4 information blocks to the first 4 configured CORESETs, such as 4 configured CORESETs with the smallest indexes or with same indexes as the information block indexes (#0, #1, #2, and #3). For example, the UE does not apply any indication for parameters associated with CORESET index #4. For example, to monitor and receive PDCCH in CORESET #4, the UE applies previously configured or indicated parameter values, or applies initial/default/fallback values, as previously described in embodiments herein.

For example, each information block of the GC-DCI can include one or more of the following fields:
a first value for a first parameter of the CORESET/PDCCH, such as, CORESET duration, using e.g., 2 bits,
a second value for a second parameter of the CORESET/PDCCH, such as a frequency allocation bitmap or RIV for the CORESET, if applicable, using e.g., 2 bits,
a third value for a third parameter of the CORESET/PDCCH, such as for an RB-level offset for the CORESET, using e.g. 2-3 bits,
a fourth value for a fourth parameter of the CORESET/PDCCH, such as for a presence or absence of REG interleaving, using e.g. 1 bit, or for values of for one or more of cce-REG-MappingType, reg-BundleSize, interleaverSize, shiftIndex, using e.g., 2-3 bits,
a fifth value for a fifth parameter of the CORESET/DCI/PDCCH, such as for an applicable modulation type, for example, enabling or disabling 16 QAM for DCI reception, using e.g., 1 bit.

In another example, each information block of the GC-DCI can include the following field:
a configuration index or a sub-configuration index, using, e.g., 2-3 bits.
   wherein different configurations or configuration indexes for a CORESET/PDCCH is previously described in embodiments herein.

In a variation, an information block of the GC-DCI can also include a CORESET ID to indicate a corresponding CORESET associated with the information block. For example, the UE applies indications provided by an information block when the UE is configured a CORESET with the indicated CORESET ID, otherwise the UE discards the information block.

In a further example, each information block includes only one bit to indicate activation or deactivation of a corresponding CORESET. For example, the GC-DCI is a single bitmap to activate a number M of CORESETs from a number N of configured CORESETs, as previously described in embodiments herein. For example, the GC-DCI scrambled by CRI-RNTI can include the following fields:
first bit to activate or deactivate a CORESET index #0, if applicable,
second bit to activate or deactivate a CORESET index #1,
third bit to activate or deactivate a CORESET index #2,
. . . ,
N_max-th bit to activate or deactivate a CORESET index #(N_max−1).

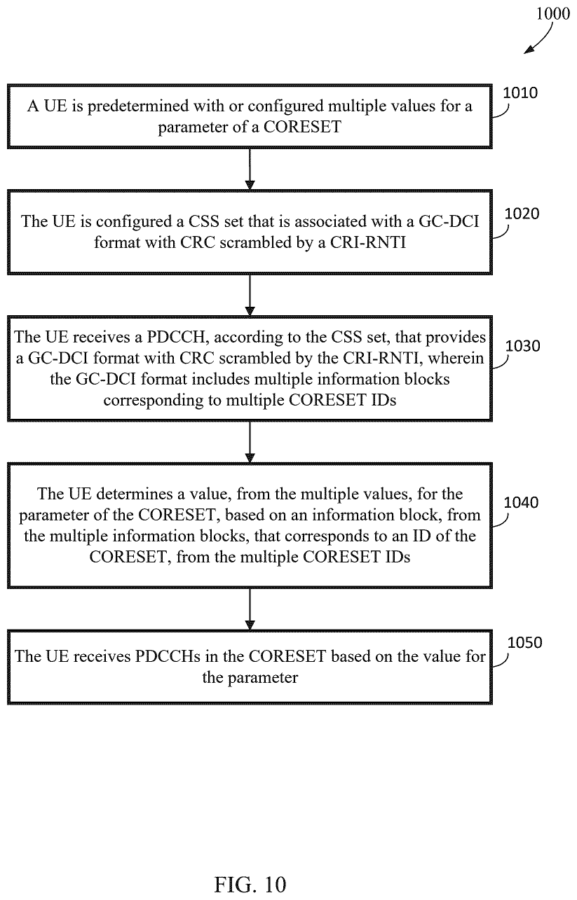

FIG. 10 illustrates an example process 1000 of using a GC-DCI format as the signaling scheme for indication of parameters of a CORESET, wherein blocks of the GC-DCI format correspond to different CORESETs according to one or more embodiments of the present disclosure. The process 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1000 is for illustration only and other embodiments can be used without departing from the scope of the present disclosure.

The process 1000 begins with the UE being predetermined with or configured multiple values for a parameter of a CORESET, 1010. The UE is configured a CSS set that is associated with a GC-DCI format with CRC scrambled by CRI-RNTI, 1020. The UE receives a PDCCH, according to the CSS set, that provides a GC-DCI format with CRC scrambled by the CRI-RNTI, wherein the GC-DCI format includes multiple information blocks corresponding to multiple CORESET IDs, 1030. The UE determines a value, from the multiple values, for the parameter of the CORESET, based on an information block, from the multiple information blocks, that corresponds to an ID of the CORESET, from the multiple CORESET IDs, 1040. The UE receives PDCCHs in the CORESET based on the value for the parameter, 1050.

In another method for the first realization of the first scheme, the GC-DCI format includes a number of information blocks, wherein each block is associated with a certain UE from UEs that are configured a same CRI-RNTI. For example, a first block is associated with a first UE, a second block is associated with a second UE, and so on.

Such method can be beneficial, for example, when different UEs that share a same CRI-RNTI are configured one or more separate CORESETs, or configured separate CORESET parameter values, such that separate indication for each UE can be more flexible or can have less signaling overhead.

For example, the following information is transmitted by means of the GC-DCI format with CRC scrambled by CRI-RNTI:
information block 1 (corresponding to UE #1),
information block 2 (corresponding to UE #2),
. . . ,
information block N (corresponding to UE #N).

In one example, a CSS set configuration for the GC-DCI format for a UE includes a positionInDCI information element (IE) that indicates a first/starting bit of an information block corresponding to the UE within in the GC-DCI format. In another example, a CSS set configuration for the GC-DCI provides an index for an information block that is associated with a UE. In yet another example, a CSS set configuration for the GC-DCI provides a UE index, among the group of UEs that share a same CRI-RNTI, and the GC-DCI includes a UE index at the beginning of each information block to indicate a UE that the information block is associated with.

In one example, the UE is associated only one block in a GC-DCI to indicate parameters for one CORESET for the UE, for example, by providing only one value of positionInDCI IE or one block index value or one UE index value. In another example, the UE is associated only one block in the GC-DCI, while the information block includes a bitmap corresponding to different CORESETs of the UE, or provides a CORESET combination index, and possibly associated CORESET parameters. In another example, the CSS configuration for the UE can provide multiple values of positionInDCI IE or multiple block index values, or the UE includes the configured UE index, among the UE group, multiple times in an instance of the GC-DCI format, and the UE is associated with the corresponding multiple information blocks from the GC-DCI format to indicate parameters for multiple CORESETs associated with the UE.

In one example, each information block can refer to a UE group, instead of an individual UE, such as information block 1 for a UE group #1, information block 2 for UE group #2, and so on.

For example, the GC-DCI is provided in a CSS that is monitored by multiple groups of UEs.

For example, an information block of the GC-DCI format can include one or more of the following fields:
a UE index or a UE group index, if applicable, using, e.g., 4 bits (to accommodate a group of 16 UEs or to indicate a group of UEs among 16 groups of UEs),
a CORESET ID or a CORESET group ID or a CORESET combination ID, using e.g. 2-3 bits,
a first value for a first CORESET/PDCCH parameter, such as, CORESET duration, using e.g., 2 bits,
a second value for a second CORESET/PDCCH parameter, such as a frequency allocation bitmap or RIV for the CORESET, if applicable, using e.g., 2 bits
a third value for a third parameter of the CORESET/PDCCH, such as for an RB-level offset for the CORESET, using e.g. 2-3 bits,
a fourth value for a fourth parameter of the CORESET/PDCCH, such as for a presence or absence of REG interleaving, using e.g. 1 bit, or for values of for one or more of cce-REG-MappingType, reg-BundleSize, interleaverSize, shiftIndex, using e.g., 2-3 bits,
a fifth value for a fifth parameter of the CORESET/DCI/PDCCH, such as for an applicable modulation type, for example, enabling or disabling 16 QAM for DCI reception, using e.g., 1 bit.

For example, a value in an information block can be an explicit indication that the CORESET is not used, and then the search space sets associated with the CORESET are disabled. Alternatively, certain fields in an information block, such as a value of zero symbols for CORESET duration or zero RBs for frequency allocation of the CORESET, can indicate that the CORESET is not present/use and that corresponding search space sets are disabled.

In another example, an information block of the GC-DCI format can include one or more of the following fields:
a UE index or a UE group index, if applicable, using, e.g., 4 bits (to accommodate a group of 16 UEs or to indicate a group of UEs among 16 groups of UEs),
a CORESET ID, using e.g. 2-3 bits, and
a configuration index or a sub-configuration index (as previously described in embodiments herein, using, e.g., 2-3 bits.

In a further example, an information block of the GC-DCI format can include one or more of the following fields:
a UE index or a UE group index, if applicable, using, e.g., 4 bits (to accommodate a group of 16 UEs or to indicate a group of UEs among 16 groups of UEs),
a bitmap for CORESET activation or a CORESET combination index (as previously described in embodiments herein), using e.g. 5-6 bits.

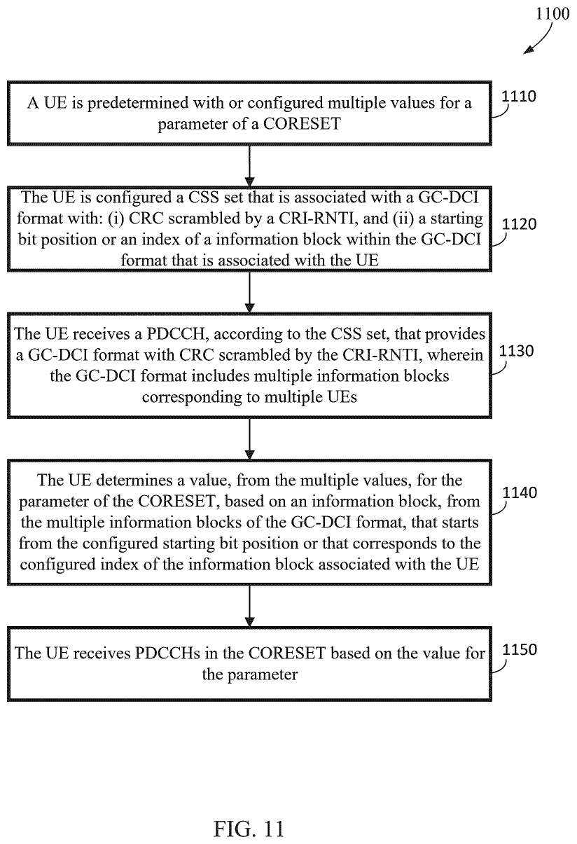

FIG. 11 illustrates an example process 1100 of using a GC-DCI format as the signaling scheme for indication of parameters of a CORESET, wherein blocks of the GC-DCI format correspond to different UEs according to one or more embodiments of the present disclosure. The process 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1100 is for illustration only and other embodiments can be used without departing from the scope of the present disclosure.

The process 1100 begins with the UE being predetermined with or configured multiple values for a parameter of a CORESET, 1110. The UE is configured a CSS set that is associated with a GC-DCI format with: (i) CRC scrambled by a CRI-RNTI, and (ii) a starting bit position or an index of an information block within the GC-DCI format that is associated with the UE, 1120. The UE receives a PDCCH, according to the CSS set, that provides a GC-DCI format with CRC scrambled by the CRI-RNTI, wherein the GC-DCI format includes multiple information blocks corresponding to multiple UEs, 1130. The UE determines a value, from the multiple values, for the parameter of the CORESET, based on an information block, from the multiple information blocks of the GC-DCI format, that starts from the configured starting bit position or that corresponds to the configured index of the information block associated with the UE, 1140. The UE receives PDCCHs in the CORESET based on the value for the parameter, 1150.

For various methods, such as the first method and the second method that were previously described, various fields in an information block such as the first CORESET/PDCCH parameter, the second CORESET/PDCCH parameter, and so on, are from a list of the CORESET/PDCCH parameters, such as those previously described in embodiments herein. For example, the first/second/ . . . parameters that are included in the GC-DCI format are predetermined in the specifications, or a presence of a field in the GC-DCI can be configurable by higher layers, such as in a CSS set configuration for the GC-DCI format for a UE. For example, when a field is configured to be present (respectively, absent) in an information block associated with a UE, the UE assumes that the field is also present (respectively, absent) in other information blocks included in the GC-DCI format.

For example, a number of bits allocated for indication of the CORESET ID or indication of each of the first/second/ . . . parameters can be predetermined in the specifications, or can be provided by higher layer configuration for the UE, such as RRC configuration for the corresponding CORESET/PDCCH parameter, or can be based on a higher layer configuration assumed for other UEs corresponding to other information blocks. For example, the UE can assume that a size for each field in any information block of the GC-DCI is same as a size of a corresponding field in an information block corresponding to the UE. For example, the UE is configured 2 values for CORESET duration, or 2 bitmaps or RIVs for frequency allocation of a CORESET, thereby requiring 1 bit for the field, and the UE assumes that the corresponding field has a size of 1 bit also for other information blocks in the GC-DCI format, corresponding to other UEs sharing a same CRI-RNTI.

In another example, the UE can be configured a size/number of bits for a field in the information block, separate from a higher layer configuration for a corresponding parameter for the UE. For example, the UE can be configured 2 values for CORESET duration, or for 2 bitmaps or RIVs for frequency allocation of a CORESET, thereby requiring only 1 bit for the UE in the GC-DCI, while the UE can be independently configured 2 bits for the CORESET duration field or the CORESET frequency allocation (for example, to accommodate other UEs with 3 or 4 configured values for CORESET duration or for CORESET frequency allocation). For example, when a size that a UE determines for a field is smaller than a configured size/number of bits for the field, the UE appends zeros to the field until a size of the field is same as the configured size for the field.

For example, a size (number of bits) of an information block, associated with a UE, in the GC-DCI can be predetermined in the specifications of the system operation or can be based on higher layer configuration. For example, different information blocks have a same size. For example, a UE is configured an assumed/nominal size or an actual size for information blocks corresponding to other UEs or that size is predetermined in the specifications of the system operation. For example, an actual size of an information block cannot exceed a corresponding assumed/nominal size for the corresponding block. For example, when the actual size of an information block exceeds a corresponding assumed/nominal size for the information block, a number of zeros are appended to the information block until a size of the information block is equal to the assumed/nominal size.

For example, the UE can be configured one or multiple position-in-DCI values, and respective one or more number-of-bits values. For example, the UE determines one or more information blocks in the DCI format in bit positions that are determined based on the respective position-in-DCI values and number-of-bits values (e.g., an information block starts in bit position 40 and the information block spans 8 bits).

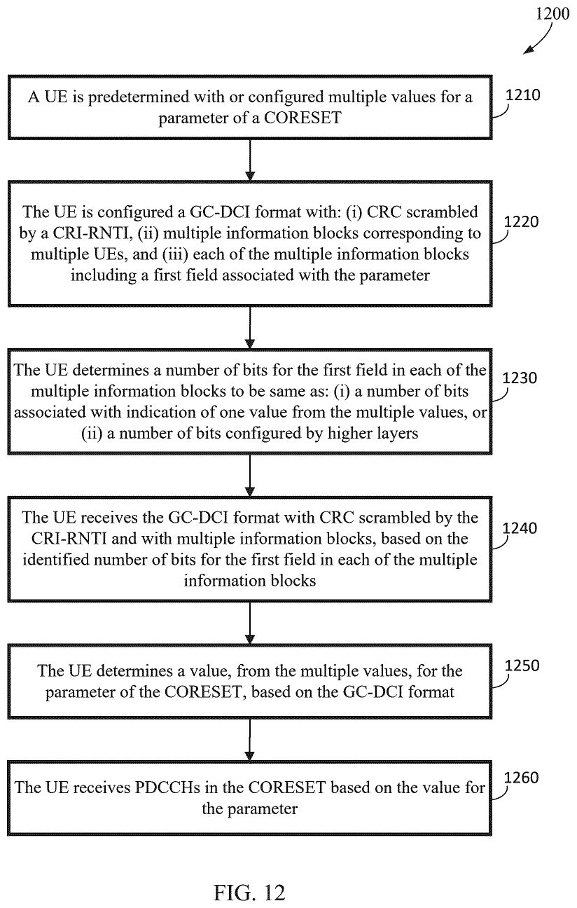

FIG. 12 illustrates an example process 1200 of DCI field size determination in a GC-DCI format for indication of CORESET parameters according to one or more embodiments of the present disclosure. The process 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1200 is for illustration only and other embodiments can be used without departing from the scope of the present disclosure.

The process 1200 begins with the UE being predetermined with or configured multiple values for a parameter of a CORESET, 1210. The UE is configured a GC-DCI format with: (i) CRC scrambled by a CRI-RNTI, (ii) multiple information blocks corresponding to multiple UEs, and (iii) each of the multiple information blocks including a first field associated with the parameter, 1220. The UE determines a number of bits for the first field in each of the multiple information blocks to be same as: (i) a number of bits associated with indication of one value from the multiple values, or (ii) a number of bits configured by higher layers, 1230. The UE receives the GC-DCI format with CRC scrambled by the CRI-RNTI and with multiple information blocks, based on the identified number of bits for the first field in each of the multiple information blocks, 1240. The UE determines a value, from the multiple values, for the parameter of the CORESET, based on the GC-DCI format, 1250. The UE receives PDCCHs in the CORESET based on the value for the parameter, 1260.

The second method above can be extended to apply to multiple groups of UEs, instead of multiple (individual) UEs. For example, a first information block of the GC-DCI format is for indication of parameters of a first CORESET to a first group of UEs, a second information block is for indication of parameters of a second CORESET to a second group of UEs, and so on. For example, multiple groups of UEs share a same CRI-RNTI value and are configured a same CSS set for monitoring the corresponding GC-DCI format.

Various embodiments of the present disclosure provide for using UE-specific/scheduling DCI in a USS set for indication of the PDCCH/CORESET parameters. In a second realization of the first scheme, a UE-specific DCI format provides an indication of CORESET/PDCCH parameters, wherein the UE receives the UE-specific DCI in a UE-specific search space (USS) set. The UE-specific DCI format can be:
a standalone DCI format that is dedicated to indication of CORESET parameters, and can have a CRC that is scrambled with a new, UE-specific CRI-RNTI configured to the UE, or
a scheduling DCI format associated with a UE-specific RNTI, such as a C-RNTI or MCS-C-RNTI, or another UE-specific DCI format that is also used for other indications.

The standalone DCI format can include multiple information blocks corresponding to multiple CORESETs. The scheduling DCI format can include a dedicated field for CORESET parameter indication or can repurpose certain first fields to indicate the CORESET parameters while using certain second fields for validation. The scheduling DCI format can indicate a CORESET ID to which the parameter values are applied, or can provide the parameter values for a same CORESET in which the scheduling DCI format is received, without CORESET ID indication.

For example, the following information is transmitted by means of a standalone, UE-specific DCI format with CRC scrambled by a UE-specific CRI-RNTI (or possibly by C-RNTI or MCS-C-RNTI):
DCI format indicator, if applicable,
information block 0 for CORESET index #0, if applicable,
information block 1 for CORESET index #1,
information block 2 for CORESET index #2,
. . . ,
information block (N−1) for CORESET index #(N−1).

For example, an applicable RNTI, from CRI-RNTI or C-RNTI or MCS-C-RNTI, is predetermined in the specifications of system operation. For example, the UE-specific CRI-RNTI is provided by higher layers, such as by a USS configuration that is associated with the standalone DCI format.

For example, the DCI format indicator field is applicable when the CRC is scrambled with an RNTI such as C-RNTI or MCS-C-RNTI, that is also used for certain other DCI formats, and when a size of the DCI format can be same as that for the certain other DCI formats. Accordingly, the UE can use the DCI format indicator to distinguish the DCI format from those other DCI formats.

For example, information block 0 is present when CORESET #0 can have parameters that are dynamically indicated or updated. For example, when parameters for CORESET #0 are not dynamically indicated or updated, as previously described in embodiments herein, information block 0 is not present in the DCI format.

For example, the DCI format includes a number N of information blocks that is same as a number of CORESETs that the UE is configured with, except possibly for CORESET #0, as previously described. For example, a number of information blocks in the DCI format can be configured independent of a number of CORESETs configured to the UE. For example, the DCI format includes a predetermined number of information blocks, such as a maximum supported number of CORESETs, for example, 3 or 5.

For example, various methods and examples, as previously described in embodiments herein, for fields within each information block, size of the information blocks, and size of a DCI format (such as a GC-DCI format) associated with CRI-RNTI, can be also applicable to a UE-specific DCI format that is used for dynamic indication of CORESET parameters. For example, a UE-specific DCI format can include a bitmap for CORESET activation, as previously described in embodiments herein.

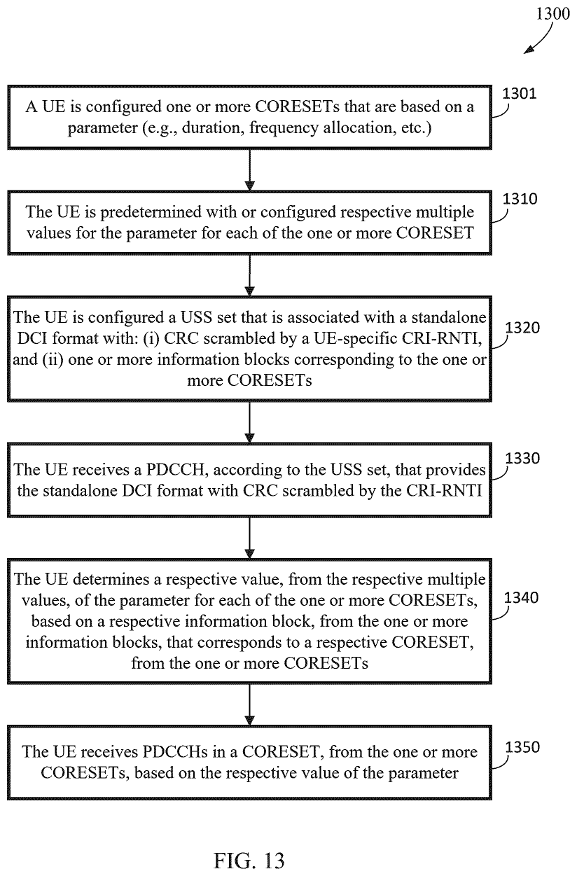

FIG. 13 illustrates an example process 1300 of using a standalone UE-specific DCI format as the signaling scheme for indication of parameters of CORESETs according to one or more embodiments of the present disclosure. The process 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1300 is for illustration only and other embodiments can be used without departing from the scope of the present disclosure.

The process 1300 begins with the UE being configured one or more CORESETs that are based on a parameter (e.g., duration, frequency allocation, etc.), 1301. The UE is predetermined with or configured respective multiple values for the parameter for each of the one or more CORESET, 1310. The UE is configured a USS set that is associated with a standalone DCI format with: (i) CRC scrambled by a UE-specific CRI-RNTI, and (ii) one or more information blocks corresponding to the one or more CORESETs, 1320. The UE receives a PDCCH, according to the USS set, that provides the standalone DCI format with CRC scrambled by the CRI-RNTI, 1330. The UE determines a respective value, from the respective multiple values, of the parameter for each of the one or more CORESETs, based on a respective information block, from the one or more information blocks, that corresponds to a respective CORESET, from the one or more CORESETs, 1340. The UE receives PDCCHs in a CORESET, from the one or more CORESETs, based on the respective value of the parameter, 1350.

In a variation, the UE may not use a standalone DCI format (that is, an entire UE-specific DCI format) for indication of CORESET parameters for a single UE. For example, a scheduling DCI format, such as a DCI format 0_0/1_0, or 0_1/1_1, or 0_2/1_2, or 0_3/1_3, can include one or multiple fields to indicate parameters for a CORESET (or possibly multiple CORESET) that is configured to the UE. For example, the one or multiple fields can be same as, or a subset of, those in an information block of a GC-DCI format associated with CRI-RNTI, as previously described. For example, a field in a scheduling DCI format can be a bitmap for CORESET activation, as previously described in embodiments herein. In another example, some or all of the fields for CORESET parameter indication can be combined in a single field, and a value of the single field is a codepoint that indicates values for the respective some or all of the fields for CORESET parameter indication or the singe field is a bitmap for CORESET activation.

In another example, first one or more fields from a DCI format, such as a scheduling DCI format, can be repurposed to provide an indication for CORESET parameters. For example, second one or more fields from the (scheduling) DCI format can be used for validation of the repurposing. For example, the second one or more fields can include an FDRA field that can take all 0s or all is based on a corresponding FDRA type. For example, the first one or more fields can include a bitmap by appending one or more of the following fields: MCS, RV, NDI, HARQ process number (HPN) at least for a first transport block of a PDSCH and possibly also for a second TB of the PDSCH, or for a first/only TB of a PUSCH. For example, the first one or more fields can also include other fields such as TDRA, antenna port (AP) field, precoder indication field, and so on. For example, the scheduling DCI format, when used with repurposing, may not schedule a PDSCH or a PUSCH on a corresponding cell and may only be used for indication of CORESET parameters. Alternatively, the DCI format may schedule a PDSCH or a PUSCH while certain parameters for the PDSCH reception or for PUSCH transmission (such as those that are otherwise indicated by the repurposed/validation fields) are determined based on default or fallback values.

For example, a CORESET for which parameters are indicated can be same as a CORESET in which the UE receives a PDCCH that provides the scheduling DCI format. For example, an indication of CORESET ID is not needed. In another example, the CORESET can be different from a CORESET in which the UE receives the PDCCH, and the scheduling DCI format can include an indication of the CORESET ID to which the indication of CORESET parameters apply. For example, indication of CORESETs is for a scheduling cell or for a cell whose cell index is indicated by the L1/L2 signaling, such as by the scheduling DCI format or a standalone/GC-DCI format for CORESET adaptation.

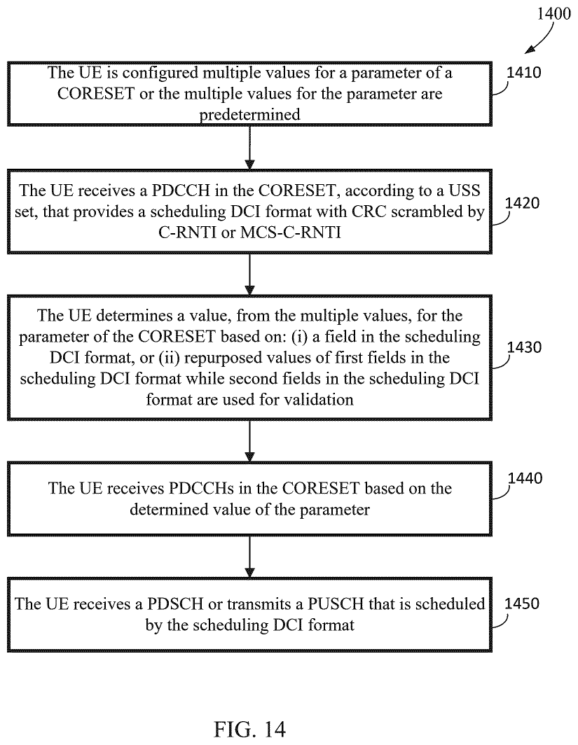

FIG. 14 illustrates an example process 1400 of using a scheduling DCI format as the signaling scheme for indication of parameters of CORESETs according to one or more embodiments of the present disclosure. The process 1400 of FIG. 14 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1400 is for illustration only and other embodiments can be used without departing from the scope of the present disclosure.

The process 1400 begins with the UE being configured multiple values for a parameter of a CORESET or the multiple values for the parameter are predetermined, 1410. The UE receives a PDCCH in the CORESET, according to a USS set, that provides a scheduling DCI format with CRC scrambled by C-RNTI or MCS-C-RNTI, 1420. The UE determines a value, from the multiple values, for the parameter of the CORESET based on: (i) a field in the scheduling DCI format, or (ii) repurposed values of first fields in the scheduling DCI format while second fields in the scheduling DCI format are used for validation, 1430. The UE receives PDCCHs in the CORESET based on the determined value of the parameter, 1440. The UE receives a PDSCH or transmits a PUSCH that is scheduled by the scheduling DCI format, 1450.

Various embodiments of the present disclosure provide for using DL MAC-CE as the signaling scheme for indication of the PDCCH/CORESET parameters. In a second scheme, a DL MAC-CE is used for providing information of the PDCCH/CORESET parameters. The DL MAC-CE can be UE-specific and provided by a PDSCH that is scheduled by a UE-specific DCI format or by a SPS PDSCH. Alternatively, the DL MAC-CE can be a UE-group-common MAC-CE that applies to multiple UEs of a UE group, and is provided by a groupcast/multicast PDSCH that is scheduled by a groupcast/multicast DCI format or is provided by a SPS PDSCH that is shared among the UE group.

In one example, the UE can receive a DL MAC-CE that indicates CORESET parameters for one or multiple CORESETs that are configured to the UE. For example, the DL MAC-CE is UE-specific.

For example, the (UE-specific) DL MAC-CE is provided in a PDSCH that is scheduled by a UE-specific scheduling DCI format. For example, the UE receives the DCI format in a PDCCH that the UE receives according to a USS set. For example, the UE receives the PDCCH in a CORESET, from the multiple CORESETs, using methods that were previously described in embodiments herein, for example, by using CORESET parameters based on a last/latest indicated parameters for the CORESET. In one example, the DL MAC-CE includes indication for parameters of only the CORESET in which the UE receives the DCI that schedules the PDSCH providing the DL MAC-CE.

For example, the UE can receive the (UE-specific) DL MAC-CE in a SPS PDSCH that is configured by higher layers and activated by higher layers or by L1/L2 signaling.

For example, the UE applies the indicated parameter values for the corresponding CORESETs, after a processing time from the PDSCH reception that provides the MAC-CE or after a processing time from a PUCCH transmission with HARQ-ACK information for the PDSCH, as previously described in embodiments herein.

In another example, a UE-group-common MAC-CE can provide information of CORESET parameters for one or more CORESETs of different UEs. For example, the MAC-CE includes a first field or a first set of fields for a first UE, and a second field or a second set of fields for a second UE, and so on.

For example, the DL MAC-CE is provided by a groupcast/multicast PDSCH that is scheduled by a UE-group-specific DCI format. For example, the PDSCH does not provide any DL-SCH, or the PDSCH provides a group-common DL-SCH, such as groupcast/multicast data.

For example, the DL MAC-CE provides multiple indications, corresponding to multiple UE, for indication of parameters of a CORESET that in which the UE receives the DCI format that scheduled the PDSCH that provides the DL MAC-CE.

For example, the DL MAC-CE multiple indications for parameters of more than one CORESETs corresponding to multiple UEs.

For example, when first UEs, from the multiple UEs, fail to receive or decode the PDSCH, the first UEs transmit a NACK, with or without an indication of a UE ID, in a channel, such as a PUCCH or PUSCH, using resources that can be shared among the multiple UEs. For example, second UEs, from the multiple UEs, that correctly receive the PDSCH (and did not provide a NACK) can apply respective indications for CORESET parameters that are provided by the DL MAC-CE after a processing time from the PDSCH reception or after a processing time from providing an acknowledgement/transmission of the PUCCH resource, as previously described in embodiments herein.

In a variation, a SPS PDSCH can be shared among multiple UEs, and the DL MAC-CE is provided in the shared SPS PDSCH.

In various examples for using a DL MAC-CE, the information content of the DL MAC-CE can be one or multiple fields to indicate values for parameters of a CORESET, with or without indication of CORESET ID, as previously described in embodiments herein. The information content of the DL MAC-CE can include such indication for one or multiple CORESETs.

Various embodiments of the present disclosure provide for using a new DL physical channel (or signal) as the signaling scheme for indication of the PDCCH/CORESET parameters. The following embodiments and examples describe a “DL channel”, while such methods also apply to a DL signal, such as a DL wake-up signal (WUS) or other sequence-based DL signal for indication of CORESET adaptation. In a third scheme, a DL channel, different from PDCCH and PDSCH, is used for providing information of the PDCCH/CORESET parameters, such as one or more CORESETs corresponding to one or more UEs. Information content of the DL channel can indicate one or both of a UE ID and a CORESET ID to which a certain field or block of the information content applies. Alternatively, there can be a predetermined or configured association among fields/blocks of the information content with different UE IDs or CORESET IDs, or association among time/frequency/spatial/code-domain resource allocation of the DL channel, such as reception occasions of the DL channel, with UE IDs or CORESET IDs. Time-domain resource allocation of the DL channel can be in a first symbol or a configured symbol of a slot or of a CORESET, and based on a frame/slot periodicity, and a frame/slot offset. Frequency-domain allocation of the DL channel can be contiguous in terms of a starting RB/RE index (or RB/RE group index) and a number of allocated RBs/REs (or groups thereof) or can be non-contiguous in terms of a number of sets of contiguous RBs/REs (or RB/RE groups), such as M=2 or 4 or 8 sets each with N=2, 3, or 6 RBs, with a certain gap or separation that is same in between different sets of RBs, with or without interleaving, or can be based on a bitmap for flexible allocation. The information provided by the DL channel can be encoded or can be indicated by a selection of a sequence from a predetermine set of sequences.

The information content of the DL channel can be one or multiple fields to indicate values for parameters of a CORESET, such as by separate or joint indication of parameter values or by indicating configuration index or sub-configuration index, with or without explicit indication of CORESET ID for example when the information provides indication of parameters for multiple CORESETs, or by indicating a bitmap for CORESET activation as previously described in embodiments herein. The information content of the DL channel can include such indication for one or multiple CORESETs.

For example, the DL channel can include a number, such as 5, fields or groups of fields, corresponding to a number of 5 CORESETs, with a first field or group of fields corresponding to a first-index CORESET, and a second field or group of fields corresponding to a second-index CORESET, and so on. The indexing can be as previously described in embodiments herein, for example, predetermined CORESET indexes, such as CORESET index 1, index 2, and so on, or can be applied in ascending order of CORESET indexes configured to a UE, for example, smallest CORESET index, second smallest CORESET index, and so on.

In another example, the DL channel can include a single field or a single group of fields corresponding to only one CORESET. For example, there is a linkage or association between the DL channel and the CORESETs. For example, the linkage is explicit, such as by including a CORESET ID in the information content of the DL channel. For example, the UE applies the indication provided by the DL channel to a CORESET with CORESET ID that is indicated by the DL channel. For example, it is up to the gNB to select which CORESET ID to indicate in a certain reception occasion of the DL channel. For example, there is no prior indication or configuration or association between reception occasions and the CORESET IDs. For example, the indication can include zero symbols or zero RBs for the CORESET, or an explicit indication that the CORESET is not used, and then the search space sets associated with the CORESET are disabled.

In another example, the UE can be configured a predetermined or configured association among reception occasions of the DL channel and the CORESET IDs. For example, the UE can be configured a number of time/frequency resources (or a number of groups of time/frequency resources), as subsequently described, and each resource from the resources (or each group of resources from the number of groups of resources) corresponds to a reception occasion of the DL channel for a CORESET.

For example, an association of the resources/resource groups/reception occasions of the DL channel with the CORESET IDs can be based on a predetermined mapping patterns, such as frequency first, time second, for example, until the UE determines an association for a maximum number or a configured number of CORESETs. For example, the association can be repeated or reset with a certain periodicity, such as every radio frame, or every N slots, and so on, wherein a value N can be predetermined or configured by higher layers.

In another example, higher layers can configure an association among the resources/resource groups/reception occasions of the DL channel with the CORESET IDs. For example, first resources/resource groups/reception occasions of the DL channel are associated with a first CORESET ID, and second resources/resource groups/reception occasions of the DL channel are associated with a second CORESET ID, and so on. For example, higher layers configure a separate symbol/slot offset or periodicity or RB offset, and so on, for resources/reception occasions of the DL channel, that is associated with each CORESET index.

Similar methods can apply when an association is between the DL channel and a group of CORESETs, such as a CORESETpoolIndex, that refers to a DU or an RU or a TRP, and so on, of a cell. For example, the UE can receive first indications for first CORESETs (such as first CORESETS associated with a first CORESETpoolIndex) in a first reception occasion of the DL channel, and second indications for second CORESETs (such as second CORESETS associated with a second CORESETpoolIndex) in a second reception occasion of the DL channel. When indications are per groups of CORESETs, a same indication can apply to different CORESETs of a CORESET group, or the indication can include codepoints that jointly encode and provide multiple indications for multiple CORESETs, or separate indications can be provided for each CORESET in the CORESET group.

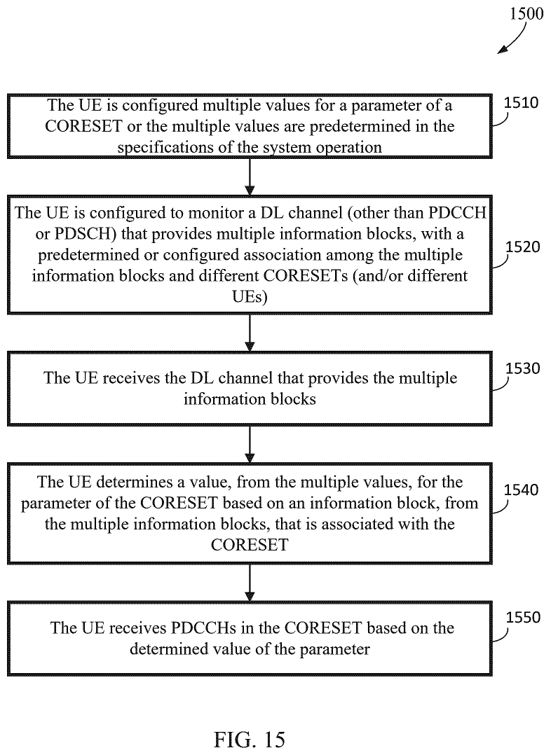

FIG. 15 illustrates an example process 1500 of using a DL channel, other than a PDCCH or PDSCH, as the signaling scheme for indication of parameters of CORESETs according to one or more embodiments of the present disclosure. The process 1500 of FIG. 15 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1500 is for illustration only and other embodiments can be used without departing from the scope of the present disclosure.

The process 1500 begins with the UE being configured multiple values for a parameter of a CORESET or the multiple values are predetermined in the specifications of the system operation, 1510. The UE is configured to monitor a DL channel (other than PDCCH or PDSCH) that provides multiple information blocks, with a predetermined or configured association among the multiple information blocks and different CORESETs (and/or different UEs), 1520. The UE receives the DL channel that provides the multiple information blocks, 1530. The UE determines a value, from the multiple values, for the parameter of the CORESET based on an information block, from the multiple information blocks, that is associated with the CORESET, 1540. The UE receives PDCCHs in the CORESET based on the determined value of the parameter, 1550.

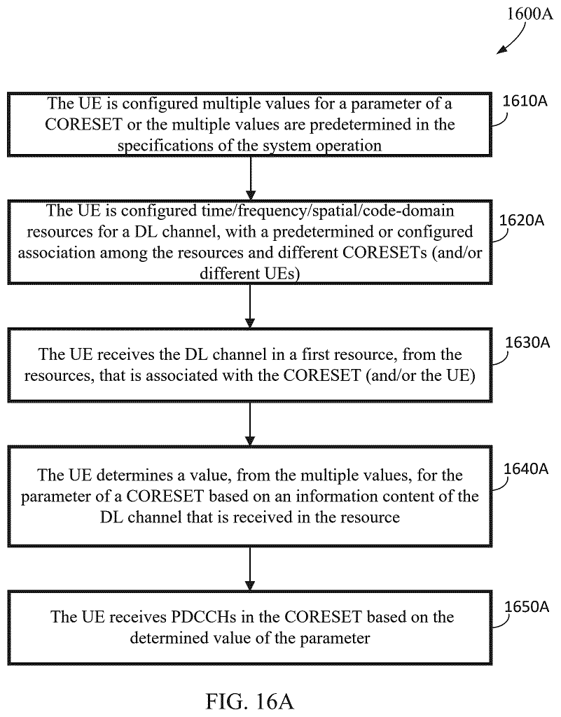

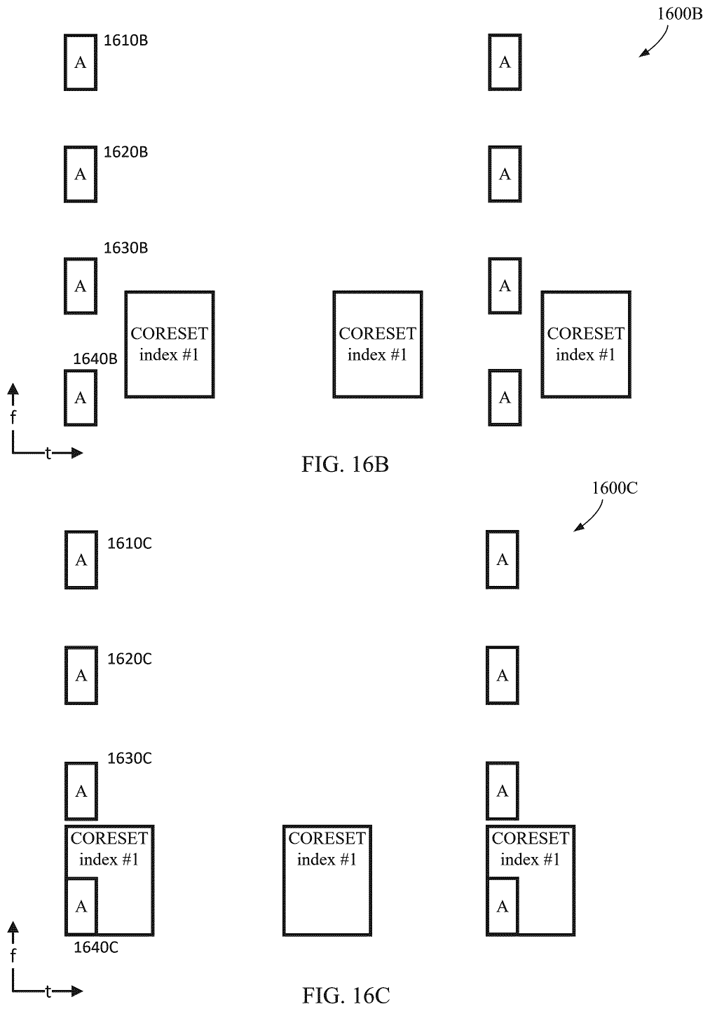

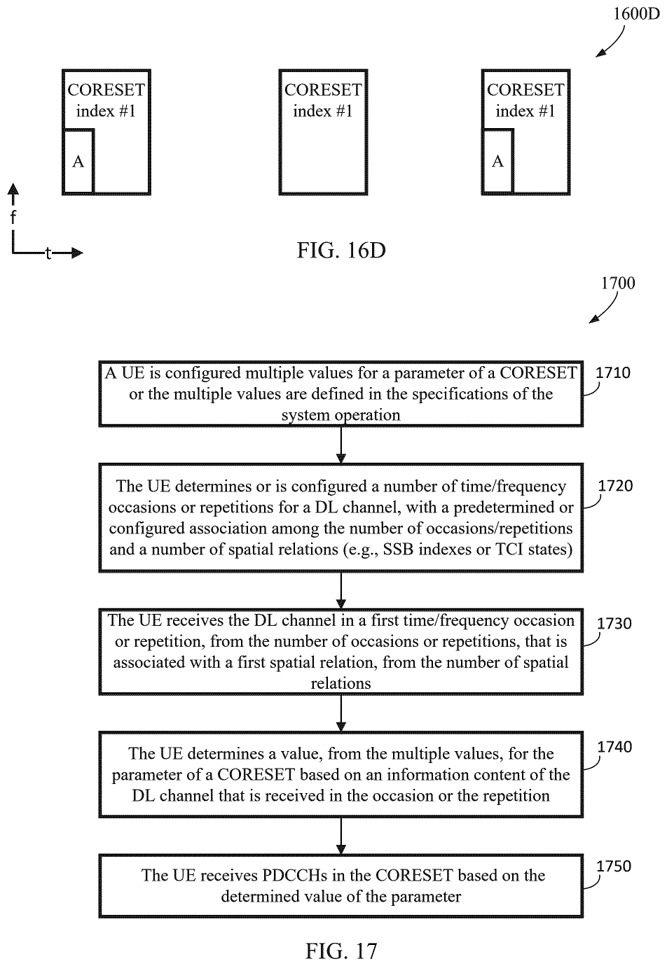

FIG. 16A illustrates an example process 1600A of using the DL channel as the signaling scheme for indication of parameters of CORESETs based on an association of reception occasions of the DL channel with different CORESETs or UEs according to one or more embodiments of the present disclosure. The process 1600A of FIG. 16A can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1600A is for illustration only and other embodiments can be used without departing from the scope of the present disclosure.

The process 1600A begins with the UE being configured multiple values for a parameter of a CORESET or the multiple values are predetermined in the specifications of the system operation, 1610A. The UE is configured time/frequency/spatial/code-domain resources for a DL channel, with a predetermined or configured association among the resources and different CORESETs (and/or different UEs), 1620A. The UE receives the DL channel in a first resource, from the resources, that is associated with the CORESET (and/or the UE), 1630A. The UE determines a value, from the multiple values, for the parameter of a CORESET based on an information content of the DL channel that is received in the resource, 1640A. The UE receives PDCCHs in the CORESET based on the determined value of the parameter, 1650A.

In one example, the DL channel can be sequence-based, and the information contents of the DL channel can be indicated using PHY properties of a base sequence, such as a pseudo-random sequence or a ZC sequence, and so on, or using different sequences from a set of predetermined sequences. For example, the information content of the DL channel can be indicated by setting different values for sequence parameters, such as the sequence length, root index, cyclic shift, and so on, or by selecting a sequence from the predetermined set of sequences. For example, no channel coding or CRC may apply to the DL channel.

For example, CRC can be appended to the information content of the DL channel, such as a CRC of 8 bits or 16 bits. In another example, the information content of the DL channel may not be protected by CRC, such as when the information content is few bits such as less than 12 bits.

For example, the information content of the DL channel (possibly also including CRC) can be encoded using Polar codes, LDPC codes, or Reed-Muller (RM) codes, and so on, or variants thereof. For example, different forward error correction codes or line codes can be used. For example, a repetition code can be used. For example, a coding rate for the DL channel can be predetermined in the specifications of system operation, or can be configurable by higher layers, such as SIB or RRC.

For example, a modulation scheme for the DL channel can be predetermined in the specifications of the system operation, such as BPSK, pi/2-BPSK or QPSK or pi/4 QPSK or 16 QAM. In another example, a modulation scheme for the DL channel can be configurable by higher layers, such as SIB or RRC.

For example, a coding rate and a modulation scheme of the DL channel can be jointly encoded into an MCS value, that is configured by higher layers, such as SIB or RRC signaling. For example, the MCS value is from a predetermined MCS table, and an indication of the MCS value is by indicating a row index from the MCS table.

For example, when redundancy version (RV) is applicable to the DL channel, the UE is predetermined to apply a RV=0 to enable self-decoding. In another example, RV=3 may be applied. In another example, an applicable RV can be configurable, for example, among values {RV=0, RV=3}.

For example, time-frequency resource allocation for the DL channel can be predetermined in the specifications. For example, the DL channel can be transmitted in a predetermined symbol, such as a first symbol of a slot, and can include a number of REs/RBs that is predetermined in the specifications of system operation, or that the UE determines based on a predetermined or configured MCS value for the DL channel.

For example, a slot where the UE receives the DL channel can be predetermined in the specifications, or can be configurable by higher layers. For example, the UE receives the new DL channel based on a slot pattern, such as a slot offset and a periodicity. For example, the offset can be relative to a reference slot, such as a first slot (slot index 0) of the radio frame. For example, the periodicity can be in terms of a number of slots. For example, the DL channel can be received in certain radio frames, referred to as, CORESET adaptation frames (CAFs). For example, for CAFs or for reception occasions of the DL channel, formulas can be predetermined in the specifications, possibly based on parameters that are configured by higher layers. For example, the UE can determine a CF to be a value for variable ‘SFN’ in the following formula:

$$( SFN + {CF}_{offset} ) mod T = ( T div N ) ,$$

wherein T and CF_{offset} are frame periodicity and frame offset parameters configured by higher layers, and N can be a total number of CFs in a periodicity of T frames. In another variation, the UE can receive the DL channel in resources that are based on a UE ID or a UE-group ID, such as ‘SFN’ values that are solutions to the following formula:

$$( SFN + {CF}_{offset} ) mod T = ( T div N ) * ( {UE}_{ID} mod N ) .$$

For example, the UE can be configured time-domain resource allocation parameters for the new DL channel, such as one or more of: a symbol offset, a slot offset, a duration, a periodicity, and so on.

For example, frequency-domain resource such as REs/RBs allocated to the DL channel can be contiguous, for example, based on a starting RE/RB index and a number of allocated REs/RBs, that can be configured separately or jointly, such as by using an RIV value, as previously described. Alternatively, frequency-domain resource allocation for the DL channel can be non-contiguous, such as based on a predetermined or configurable pattern. For example, the UE receives the new channel in RBs starting from a starting/offset RE/RB index, and in a number of RE/RB groups, such as M=2 or 4 or 8 RE/RB groups each including N=1, 2 or 4 or 8 RE/RBs, and a separation of X RE/RBs. For example, values of M, N, and X are predetermined in the specifications or configurable by higher layers.

For example, the UE receives the DL channel in the following RBs:
a first group of N=1 or 2 or 3 or 6 RBs, starting from the first RB of the carrier/BWP, offset by the RB offset for the new channel,
a second group of N=1 or 2 or 3 or 6 RBs, starting from the first RB of the second RB chunk, offset by {the RB offset for the new channel+N RBs+X RBs for separation},
. . . ,
a M-th group of N=1 or 2 or 3 or 6 RBs, starting from the first RB of the M-th RB chunk, offset by {the RB offset for the new channel+(M−1)*N RBs+(M−1)*X RBs for separation}.

In another example, the carrier bandwidth or the BWP bandwidth can be separated into a number of M contiguous parts with equal size (e.g., M=2, 4, or 8), referred to as RB chunks, and each of the M RE/RB groups can be within a respective one of the M RB chunks. For example, the UE applies the RB offset relative to a start of one of the M RB chunks.

For example, the UE receives the DL channel in the following RBs:
a first group of N=1 or 2 or 3 or 6 RE/RBs, starting from the first RB of the first RB chunk, offset by the RB offset for the new channel,
a second group of N=1 or 2 or 3 or 6 RE/RBs, starting from the first RB of the second RB chunk, offset by the RB offset for the new channel,
. . . ,
a M-th group of N=1 or 2 or 3 or 6 RE/RBs, starting from the first RB of the M-th RB chunk, offset by the RB offset for the new channel.

For example, the frequency resource allocation for the DL channel can be arbitrary, without any pattern. For example, the UE receives a bitmap that provides indexes of REs or RBs or RE groups or RB groups for the DL channel. For example, a value ‘1’ in the bitmap indicates that a corresponding frequency resource, within the bandwidth of the carrier or the active BWP of the cell, is allocated to the DL channel, and a value ‘0’ in the bitmap indicates that the corresponding frequency resource is not allocated to the new DL channel. For example, a granularity of the frequency resources in the bitmap, such as RE-level or RB-level or RBG group level, or RE group level, and so on, can be configured by higher layers such as SIB or RRC signaling.

Similar design based on bitmaps can be also used for time-domain resource allocation of the DL channel, wherein the bitmap can be within a span of N symbols or slots, wherein a value of N is predetermined in the specifications of system operation or configured by higher layers, and a granularity of the bitmap can be on the level of symbols or groups thereof. For example, a bitmap can be jointly across both time and frequency domain.

For example, the information content of the new channel is mapped to the resources in the REs/RBs of the RE/RB groups in ascending (or descending) order of the REs/RBs, or can be based on a predetermined or configurable interleaving pattern, such as an RE-level or RB-level or RE-group-level or RB-group-level interleaving pattern.

In one example, the UE expects that resources for the DL channel do not overlap with any cell-specific signals or channels, synchronization signal, system information, and so on, such as LTE CRS, LTE/NR SSB or NR CORESET #0. For example, when a UE determines that that a reception occasion of the DL channel overlaps with such receptions, the UE drops a reception of the DL channel, or the UE rate matches the DL channel around resources that overlap with such receptions.

For example, the UE does not expect that resources for the DL channel do not overlap with UL symbol or slots of a cell-specific or UE-specific TDD UL-DL configuration. For example, when a UE determines that that a reception occasion of the DL channel overlaps with UL symbol or slots of a cell-specific or UE-specific TDD UL-DL configuration, the UE drops the DL channel in the reception occasion.

In one example, the UE expects that time/frequency resources for the DL channel are separate from time/frequency resources for any CORESET. For example, the DL channel does not overlap with any CORESET configured to the UE. For example, the DL channel can be TDM or FDM with CORESETs that are configured to the UE. For example, when a CORESET parameter, such as duration or frequency allocation, can take a value from multiple values, the UE expects that such restriction applies for any/all of the multiple values configured for the CORESET. In another example, the UE expects that such restriction applies at each time instance only for an indicated/applicable value of the CORESET parameter for that time instance.

In another example, the DL channel can overlap with one or multiple CORESETs. For example, the DL channel includes first time/frequency resources that overlap with at least one CORESET configured to the UE, and second time/frequency resources that overlap with none of CORESETs configured to the UE. For example, the first resources are not empty. For example, the second resources may or may not be empty. For example, the UE does not expect to receive PDCCHs in the first time/frequency resources. For example, the first time/frequency resources puncture CCEs of PDCCH candidates in a corresponding CORESET that includes the first time/frequency resources.

For example, the DL channel can be in time/frequency resources that are a subset of time/frequency resources allocated to a CORESET. For example, the UE receives the DL channel in predetermined CCEs, such as the first 4 CCEs, of a CORESET, such as a CORESET with index #0 or in a CORESET with smallest index other than index #0. For example, the UE receives the DL channel in CCEs from a CORESET, wherein corresponding CCE indexes can be configured by higher layers. For example, the CORESET in which the UE receives the DL channel can be predetermined, as previously described, or can have a CORESET ID that is configured by higher layers. For example, the UE does not expect to receive PDCCHs in such predetermined or configured CCEs for the corresponding CORESET. For example, such CCEs puncture CCEs of PDCCH candidates in a corresponding CORESET in which the UE receives the DL channel.

Similar multiplexing behavior may hold also for DL receptions, other than CORESET/PDCCH, such as for PDSCH, as previously described in embodiments herein.

FIG. 16B illustrates an example of multiplexing 1600B between the “DL channel” used for indication of CORESET parameters, herein shown as ‘A’, and a CORESET such as CORESET with index #1, wherein the CORESET has no time/frequency overlap with the DL channel according to one or more embodiments of the present disclosure. For example, the multiplexing 1600B may be identified and/or utilized by a UE, such as the UE 116 of FIG. 3, and supported by a BS, such as BS 102 of FIG. 2. The multiplexing 1600B is for illustration only and other embodiments can be used without departing from the scope of the present disclosure.

The FDM allocations 1610B, 1620B, 1630B, and 1640B correspond to a single reception occasion of the DL channel, where the DL channel resources are distributed across 4 separate (e.g., evenly spaced) contiguous chunks of frequency-domain resources, and all 4 chunks are separate from the CORESET.

FIG. 16C illustrates another example of multiplexing 1600C between the “DL channel” used for indication of CORESET parameters, herein shown as ‘A’, and a CORESET such as CORESET with index #1, wherein the CORESET has partial time/frequency overlap with the DL channel. For example, the multiplexing 1600C may be identified and/or utilized by a UE, such as the UE 116 of FIG. 3, and supported by a BS, such as BS 102 of FIG. 2. The multiplexing 1600C is for illustration only and other embodiments can be used without departing from the scope of the present disclosure.

The FDM allocations 1610C, 1620C, 1630C, and 1640C correspond to a single reception occasion of the DL channel, wherein the DL channel resources are distributed across 4 separate (e.g., evenly spaced) contiguous chunks of frequency-domain resources, and one of the 4 chunks overlaps with the CORESET, while the other 3 chunks have no overlap with the CORESET.

FIG. 16D illustrates another example of multiplexing 1600D between the “DL channel” used for indication of CORESET parameters, herein shown as ‘A’, and a CORESET such as CORESET with index #1, wherein the DL channel is fully overlapped the CORESET according to one or more embodiments of the present disclosure. For example, the multiplexing 1600D may be identified and/or utilized by a UE, such as the UE 116 of FIG. 3, and supported by a BS, such as BS 102 of FIG. 2. The multiplexing 1600D is for illustration only and other embodiments can be used without departing from the scope of the present disclosure.

Unlike FIGS. 16B and 16C, it is assumed in FIG. 16D that the DL channel includes only one contiguous chunk of frequency-domain resources.

The DL channel can be cell-specific or UE-group-specific or UE-specific, as subsequently described.

Various embodiments of the present disclosure provide for cell-specific design of the DL channel for indication of CORESET parameters. In a first realization of the third scheme, the DL channel is cell-specific with information content that applies to any UE in the cell in an active DL BWP for the UE. The DL channel can include a number, such as 5, fields or groups of fields, corresponding to a number of 5 CORESETs, and each UE applies a first field or group of fields to a first-index CORESET, and a second field or group of fields to a second-index CORESET, and so on, for PDCCH receptions in an active DL BWP by the UE. A UE applies the indications, regardless of whether or not the first-index CORESET for a first UE is same as a first-index CORESET for a second UE, and so on. No RNTI may be applied. To accommodate different UEs, the DL channel can be repeated with multiple spatial beams (e.g., associated with multiple SSB indexes or TCI states) in multiple time/frequency resources or resource groups.

For example, no RNTI or an associated CRC is applied to the information content of the DL channel. In another example, a cell-specific RNTI is configured by higher layers such as SIB or RRC, and the CRC of the DL channel is scrambled by the cell-specific RNTI.

For example, time-frequency resource allocation for the DL channel can be predetermined in the specifications. For example, the DL channel can be an additional symbol and have a same number of RBs as a PBCH, and be part of the SS/PBCH block. In another example, an indication, such as a 1-bit flag, in the PBCH indicates whether or not the additional symbol for the DL channel is present. In another example, the DL channel can be merged with the PBCH, for example, as additional fields in the MIB.

For example, the DL channel can be repeated with a number of repetitions, such as 8 or 64 times. For example, different repetitions can be associated with same or different beams or spatial relations, such as one-to-one association with SSB indexes. For example, a number of repetitions for the new channel can be same as a maximum number of SSB indexes, or a number of actually transmitted SSB indexes in the cell. For example, a UE receives a first repetition of the DL channel with a same beam or spatial relation/filter as that for a first SSB index, or a second repetition of the DL channel with a same beam or spatial relation/filter as that for a second SSB index, and so on. For example, the UE may receive only one repetition, using, for example a best Rx beam, or may receive multiple repetitions of the DL channel using beam sweeping, possibly along with combining.

In another example, a number of repetitions for the DL channel can be independently configured, for example, regardless of a number of SSB indexes in a cell. In another example, multiple beams for multiple repetitions of the DL channel can be based on multiple TCI states, such as DL TCI states or joint DL/UL TCI states, and so on. For example, the UE can determine or can be configured an association among the number of repetitions and the TCI states, including one-to-one or one-to-many association, using explicit association or possibly based on a predetermined or configurable order, such as ascending or descending order of TCI state indexes.

For example, some or all of the repetitions can be in the frequency domain, at least, when the gNB or the UE support transmission or reception with multiple beams at the same time, using multiple antenna panels/arrays/sub-arrays or using advanced antenna technology, for example, joint phase-time array (JPTA) architecture.

For example, the DL channel can be repeated in one or both of time domain and frequency domain. For example, the UE receives a first repetition of the DL channel in a first slot, such as the first symbol of the first slot, and a second repetition of the DL channel in a second slot, such as the first symbol of the second slot, and so on. For example, a repetition pattern of the DL channel in time domain can be based on a same periodicity for different repetitions, and different slot offsets for different repetition indexes. For example, the UE is predetermined or configured a first value of a slot offset for a first repetition, and a second value of the slot offset for the second repetition, and so on.

For example, the UE receives a first repetition of the DL channel in first REs/RBs, and second repetition of the DL channel in second REs/RBs, and so on. For example, a repetition pattern of the new channel in frequency domain can be based on a same number of REs/RBs or RE-groups/RV-groups, and same number of REs/RBs in each RE/RB group for different repetitions. For example, different RB offsets or different RB separation values can be associated with different repetition indexes. For example, the UE is predetermined or configured a first value of an RB offset or RE/RB separation for a first repetition, and a second value of the slot offset or a second RE/RB separation for the second repetition, and so on.

For example, different repetitions of the DL channel are associated with different beams or spatial relations/filters. For example, there can be one-to-one association between a number of repetitions for the DL channel and a maximum number of SSB indexes, or a number of actually transmitted SSB indexes, or a number of (cell-specific or UE-specific) TCI states. For example, the UE receives a first repetition using a first spatial filter, and a second repetition using a second spatial filter, and so on. For example, the UE receives the first repetition using a same spatial filter as that for a first SSB index or a first TCI state, and the second repetition using a same spatial filter as that for a second SSB index or a second TCI state. For example, a set of TCI states associated with the repetitions can be configured by higher layers.

FIG. 17 illustrates an example process 1700 of a cell-specific design for the DL channel to indicate the CORESET parameters with different beams associated with different occasions or repetitions according to one or more embodiments of the present disclosure. The process 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1700 is for illustration only and other embodiments can be used without departing from the scope of the present disclosure.

The process 1700 begins with the UE being configured multiple values for a parameter of a CORESET or the multiple values are defined in the specifications of the system operation, 1710. The UE determines or is configured a number of time/frequency occasions or repetitions for a DL channel, with a predetermined or configured association among the number of occasions/repetitions and a number of spatial relations (e.g., SSB indexes or TCI states), 1720. The UE receives the DL channel in a first time/frequency occasion or repetition, from the number of occasions or repetitions, that is associated with a first spatial relation, from the number of spatial relations, 1730. For example, the UE determines the first spatial relation based on UE implementation, such as by beam sweeping, or based on a TCI state associated with a certain CORESET in which the UE attempts to monitor PDCCH, or based on a default beam such as an SSB index or a TCI state configured for a CORESET with smallest index. The UE determines a value, from the multiple values, for the parameter of a CORESET based on an information content of the DL channel that is received in the occasion or the repetition, 1740. The UE receives PDCCHs in the CORESET based on the determined value of the parameter, 1750.

Various embodiments of the present disclosure provide for UE-group-specific design of the DL channel for indication of CORESET parameters. In a second realization of the third scheme, the DL channel for indication of CORESET parameters is UE-group-specific, with information content that applies to any UE in a corresponding UE group. A UE-group-specific CRI-RNTI may be applied to the DL channel. To multiplex the DL channel for different groups of UEs, different time/frequency resources, such as different slot offsets or starting RB, can be configured to different groups of UEs (that is, TDM or FDM), or each group of UEs can be configured a different spatial relation (such as SSB index or TCI state), a different orthogonal cover code (OCC), or a different cyclic shift (that is, SDM or CDM).

For example, the DL channel can include a number, such as 5, fields or groups of fields, corresponding to a number of 5 CORESETs, and each UE in the UE group applies a first field or group of fields to a first-index CORESET, a second field or group of fields to a second-index CORESET, and so on. For example, a UE in the UE-group applies the indications regardless of whether or not the first-index CORESET for a first UE in the UE group is same as a first-index CORESET for a second UE in the UE group, and so on. In another example, different UEs in a UE group share the respective CORESETs. For example, CORESET index #1 for UE #1 in the UE group is same as CORESET index #1 for UE #2 in the UE group, and so on.

For example, the UEs in the UE-group can be configured a UE-group-RNTI, such as a UE-group-specific CRI-RNTI, and an information content of the DL channel or a corresponding CRC is scrambled by the CRI-RNTI.

For example, a time-frequency resource allocation for the DL channel can be as previously described in embodiments herein, for example, based on one or multiple groups of symbols/slots or REs/RBs, possibly using a certain pattern with a configurable duration, periodicity and offset, or based on a bitmap of time/frequency-domain resource allocation.

For example, a UE can determine a beam or spatial filter for reception of the DL channel based on predetermined or configured QCL properties or spatial relations. For example, the UE can receive the DL channel using same QCL properties or TCI state as the ones configured for a CORESET with lowest index (such as a CORESET with lowest index, possibly except for CORESET #0). In another example, the UE receives the DL channel based on an indicated TCI state, such a DL TCI state or a joint DL/UL TCI state, that is indicated to the UEs in the UE group for various DL receptions on the cell. The indication of the TCI state can be a UE-specific indication that is commonly indicated to UEs in the UE group, or can be a UE-group-specific indication.

For example, UEs in a UE group can be configured a spatial relation for the DL channel, such as an SSB index or a CSI-RS index or a TCI state index, and so on, and the UEs receive the DL channel based on the configured spatial relation.

For example, time/frequency allocation can be on a per-UE-group basis, with a first time/frequency allocation configuration for a first groups of UEs, and a second time/frequency allocation configuration for a second groups of UEs.

For example, the DL channel can be in a first symbol of a first slot, with first RBs or RB groups allocated to a first group of UEs, and with second RBs or RB groups allocated to a second groups of UEs, such as FDM for different groups of UEs. For example, different groups of UEs can be configured different RB offset values or different carrier chunks, as previously described in embodiments herein.

In another example, the DL channel can be TDM for different groups of UEs. For example, the DL channel can be in a first symbol of a first slot (such as slot n) for a first group of UEs, and in a first symbol of a second slot (such as slot n+1) for a second group of UEs. For example, different groups of UEs can be configured different symbol/slot offset values, or different periodicities, and so on.

For example, a same time/frequency domain resource allocation may be allocated for reception of the DL channel by multiple groups of UEs, and UEs in each group of UEs receive corresponding information based on distinction in domains other than time/frequency domain, such as distinction in spatial domain or distinction in code domain.

For example, UEs in a first UE group can receive the DL channel in the allocated (shared) time/frequency resources based on a first spatial relation, and UEs in a second UE group can receive the DL channel (with second information content, separate from that for the first UE group) in the allocated (shared) time/frequency resources based on a second spatial relation.

For example, UEs in a UE group can be configured a same sequence or cyclic shift of a sequence, or an orthogonal or non-orthogonal cover codes, for a sequence used for the DL channel. For example, UEs in a first UE group apply a first sequence, or cyclic shift of a sequence or cover code, and UEs in a second UE group apply a second sequence or cyclic shift of a sequence or cover code.

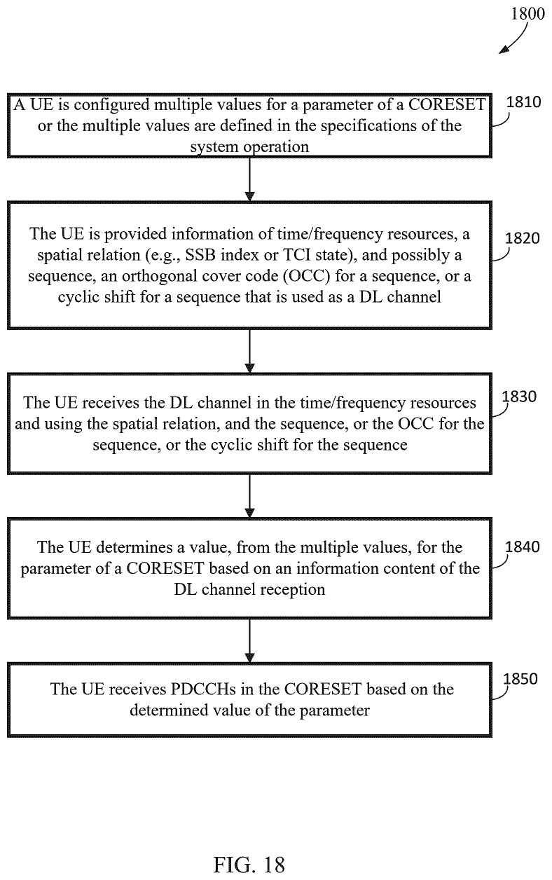

FIG. 18 illustrates an example process 1800 of a UE-group-specific design for the DL channel to indicate the CORESET parameters using different time/frequency occasions or different beams or cover codes for different groups of UEs according to one or more embodiments of the present disclosure. The process 1800 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1800 is for illustration only and other embodiments can be used without departing from the scope of the present disclosure.

The process 1800 begins with the UE being configured multiple values for a parameter of a CORESET or the multiple values are defined in the specifications of the system operation, 1810. The UE is provided information of time/frequency resources, a spatial relation (e.g., SSB index or TCI state), and possibly a sequence, or an orthogonal cover code (OCC) for a sequence, or a cyclic shift for a sequence that is used as a DL channel, 1820. The UE receives the DL channel in the time/frequency resources and using the spatial relation, and the sequence, or the OCC for the sequence, or the cyclic shift for the sequence, 1830. The UE determines a value, from the multiple values, for the parameter of a CORESET based on an information content of the DL channel reception, 1840. The UE receives PDCCHs in the CORESET based on the determined value of the parameter, 1850.

Various embodiments of the present disclosure provide for UE-specific design of the DL channel for indication of CORESET parameters. In a third realization of the third scheme, the DL channel is UE-specific with information content that applies only to an associated UE. Various design aspects can be similar to those in embodiments herein, except that corresponding configurations and indication can be UE-specific, such as for RNTI, time/frequency resource allocation, beam determination, sequence, cyclic shift or cover code, and so on, possibly with some UE-specific modifications. For example, the UE can determine time/frequency resources for the DL channel using a formula with a hash function based on one or more of a slot index, a UE ID or a UE group ID to randomize a location of time/frequency resources for the DL channel reception for the UE.

For example, a CRC for information content of the DL channel can be scrambled with a UE-specific RNTI, such as and RNTI used for other purposed, for example, C-RNTI, or a new UE-specific RNTI, such as CRI-C-RNTI.

For example, a UE can use a configured or default beam as previously described in embodiments herein. For example, the UE can receive the DL channel using a same spatial filter as that used for reception of an SSB in a most recent initial access procedure or in a most recent random access procedure.

Various embodiments of the present disclosure provide for energy saving aspects for the DL channel for indication of CORESET parameters. In one embodiment, the UE can receive higher layer configuration or L1/L2 signaling or other information that indicates whether the DL channel is enabled or disabled, or whether certain reception occasions of the DL channel can be skipped. Such designs can prevent the DL channel to be an always-on channel, and therefore, provide UE power saving gains and/or network energy saving gains. When the DL channel is disabled or skipped, the UE monitors PDCCH in the configured CORESETs based on the last configured/indicated values or based on default/fallback values for the CORESET parameters.

For example, an RRC information element (IE) indicates whether the DL channel is enabled/present or disabled/absent. For example, when the DL channel is indicated to be disabled for a CORESET, the UE receives PDCCH based on a default/fallback assumption for the CORESET parameters, as previously descried in embodiments herein. Such indication can be common for all CORESET IDs, or separately provided per CORESET ID or per group of CORESETs, such as per CORESETpoolIndex.

For example, the UE follows UE DRX for reception of the DL channel. For example, outside UE DRX active time, the UE does not expect to receive the DL channel. For example, the UE receives the DL channel only within the UE DRX active time. Similar considerations apply with cell DTX/DRX, instead of or in addition to UE DRX.

For example, the UE can be configured a separate DRX pattern for the DL channel, for example, referred to as R-DRX pattern. For example, an R-DRX pattern for the DL channel can be an extension of a DRX pattern applicable for PDCCH reception. For example, an active time of the R-DRX is a subset of the UE DRX pattern. For example, HARQ-related timers are not applicable to the R-DRX pattern.

For example, the UE can be indicated to skip a number of reception occasions of the DL channel, or skip a time duration, such as X msec, or a number of slots. For example, a field with 1 or 2 bits in a DCI format, such as a scheduling DCI format can indicate, respectively, one of 2 or 4 values for the number of reception occasions or slots that the UE can skip reception of the DL channel.

For example, a UE can also apply for the DL channel a PDCCH skipping indication that is provided by a field in a scheduling DCI format. In another example, such skipping indication for the DL channel can be provided by a DL MAC-CE or a by DCI format, such as a GC-DCI format that is associated with a CSS set and a UE-group RNTI, such as skipping CORESET indication RNTI (s-CRI-RNTI), for scrambling a CRC of the GC-DCI. For example, the GC-DCI format can include, for UEs associated with a same s-SRI-RNTI, a first skipping indication for a first CORESET, and a second skipping indication for a second CORESET, and so on, or the skipping indication can apply for all CORESETs/USS sets at least for some UE-specific DCI formats. For example, the GC-DCI can include a first skipping indication for a first UE associated with s-CRI-RNTI, and a second skipping indication for a second UE associated with the same s-CRI-RNTI, and so on. For example, a grouping for the GC-DCI format associated with s-CRI-RNTI to indicate skipping of the DL channel can be same as UE-group that is configured a UE-group-specific DL channel.

In another example, a skipping indication for the DL channel can be provided by the DL channel. For example, information content of the DL channel can include a skipping indication field of 1 or 2 bits to indicate one or respective 2 or 4 number of reception occasions or slots for reception of the DL channel. For example, the DL channel provides, in a first reception occasion, an indication of the CORESET parameters for one or multiple CORESETs, and also indicates a number of receptions occasions or slots to be skipped, before a next/second reception occasion of the DL channel. Such skipping indication can be per CORESET, or commonly apply for different CORESETs.

For example, when the UE does not receive the DL channel in one or more reception occasions, for example, due to RRC disabling the DL channel or due to skipping indication for the DL channel, the UE monitors PDCCHs in the CORESETs based on a last/latest higher layer configuration or L1/L2 indication provided to the UE for the CORESET parameters before the one or more reception occasions. Alternatively, the UE may apply default/fallback values for the CORESET parameters, as previously described in embodiments herein. Alternatively, the UE may not monitor PDCCH between the two reception occasions (or for an indicated duration of skipping of the DL channel) at least for some UE-specific DCI formats.

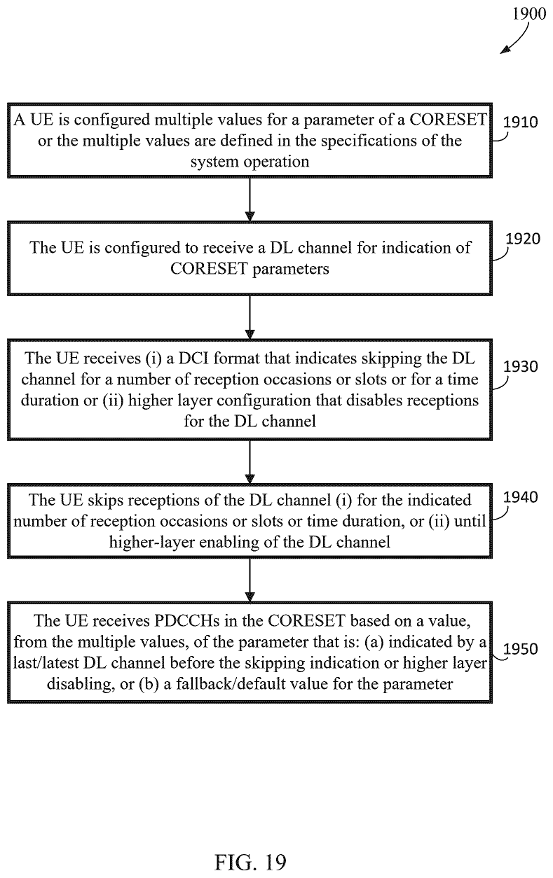

FIG. 19 illustrates an example process 1900 of energy saving for the DL channel by higher layer disabling or L1-based skipping of the DL channel reception occasions according to one or more embodiments of the present disclosure. The process 1900 of FIG. 19 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1900 is for illustration only and other embodiments can be used without departing from the scope of the present disclosure.

The process 1900 begins with the UE being configured multiple values for a parameter of a CORESET or the multiple values are defined in the specifications of the system operation, 1910. The UE is configured to receive a DL channel for indication of CORESET parameters, 1920. The UE receives (i) a DCI format that indicates skipping the DL channel for a number of reception occasions or slots or for a time duration (ii) higher layer configuration that disables receptions for the DL channel, 1930. The UE skips receptions of the DL channel (i) for the indicated number of reception occasions or slots or time duration, or (ii) until higher-layer enabling of the DL channel, 1940. The UE receives PDCCHs in the CORESET based on a value, from the multiple values, of the parameter that is: (a) indicated by a last/latest DL channel before the skipping indication or higher layer disabling, or (b) a fallback/default value for the parameter, 1950.

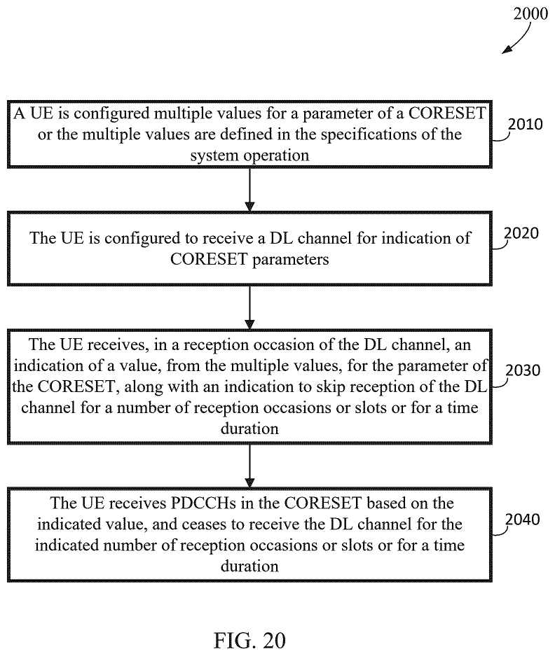

FIG. 20 illustrates an example process of energy saving for the DL channel by skipping indication provided within the information content of the new DL channel according to one or more embodiments of the present disclosure. The process 2000 of FIG. 20 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 2000 is for illustration only and other embodiments can be used without departing from the scope of the present disclosure.

The process 2000 begins with the UE being configured multiple values for a parameter of a CORESET or the multiple values are defined in the specifications of the system operation, 2010. The UE is configured to receive a DL channel for indication of CORESET parameters, 2020. The UE receives, in a reception occasion of the DL channel, an indication of a value, from the multiple values, for the parameter of the CORESET, along with an indication to skip reception of the DL channel for a number of reception occasions or slots or for a time duration, 2030. The UE receives PDCCHs in the CORESET based on the indicated value, and ceases to receive the DL channel for the indicated number of reception occasions or slot or for the indicated time duration, 2040.

Various embodiments of the present disclosure provide for UE determination of PDCCH/CORESET parameters without gNB indication. In a fourth scheme, the UE determines the PDCCH/CORESET parameters without any indication or signaling from the gNB, such as by blind decoding respective values of the CORESET parameters among predetermined or configured respective sets of values. For example, the UE is configured a CORESET with multiple values for the CORESET duration. For example, the UE considers multiple hypotheses for the CORESET duration, and determines a number of available CCEs and indexes of CCEs corresponding to different PDCCH candidates based on the multiple hypotheses. For example, upon blind decoding the corresponding PDCCH candidates (or at least one or some PDCCH candidates) for the associated DCI format based on the multiple hypotheses, the UE determines an actual value of the CORESET duration. For example, the UE can apply the determined value of the CORESET duration for monitoring other PDCCHs in a same PDCCH MO (or possibly also in future PDCCH MOs).

Similar can hold for blind decoding based on multiple hypotheses for frequency allocation of the CORESET, or for other parameters of the CORESET, as previously described in embodiments herein.

For example, the UE can report a capability whether or not the UE supports the fourth scheme. For example, when a UE supports the fourth scheme, a UE budget for a number of blind decoding for PDCCH candidates or for non-overlapping CCEs can be increased compared to a UE without such support, for example, to account for the additional blind decoding that the UE performs to resolve the multiple hypotheses for the CORESET parameters. For example, such increase can be in terms of a multiplicative factor, such as a linear scaling, based on a number of hypothesis for the CORESET parameters.

Various embodiments of the present disclosure provide for UE determination of PDCCH/CORESET parameters using physical properties of PDCCH such as phase rotation. In a fifth scheme, the UE determines the PDCCH/CORESET parameters based on physical properties of PDCCHs that the UE receives, such phase rotation applied to PDCCH REs relative to that for PDCCH DMRS REs.

For example, the UE is predetermined or configured an association among phase rotation values of PDCCH REs and CORESET parameter values or indexes of configuration/sub-configuration for a CORESET.

For example, the UE compares a phase of PDCCH REs relative to that of PDCCH DMRS REs to determine an applied phase rotation, thereby determining an indicated value for the CORESET parameters or an indicated index for a configuration or sub-configuration of a CORESET. For example, the UE monitor and receives a PDCCH in a CORESET based on:
an assumption for the CORESET parameters, such as union of all time/frequency resources for the CORESET based on different configured values for CORESET duration or CORESET frequency allocation, or
a previously indicated value of the CORESET parameters, or an initial high layer configuration for the CORESET parameter.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving, via a first radio resource control (RRC) information element, first information for a number of control resource sets (CORESETs), wherein each CORESET is associated with:
a respective index from a set of indexes, and
a respective set of parameters for reception of a physical downlink control channel (PDCCH);
receiving, via a first downlink control information (DCI) or a first medium access control (MAC) control element (CE), second information for a first number of indexes from the set of indexes;
determining, based on the second information, first CORESETs, from the number of CORESETs, that are associated with the first number of indexes; and
receiving a first PDCCH in a first CORESET, from the first CORESETs, based on a respective set of parameters.

2. The method of claim 1, further comprising:
receiving a second PDCCH in a second CORESET, wherein:
the second CORESET is not in the number of CORESETs, and
the second PDCCH provides the first DCI or schedules a physical downlink shared channel (PDSCH) that provides the first MAC CE.

3. The method of claim 1, further comprising:
receiving a second PDCCH in a second CORESET, wherein:
the second PDCCH provides the first DCI or schedules a physical downlink shared channel (PDSCH) that provides the first MAC CE,
the second CORESET is in second CORESETs from the number of CORESETs,
the second CORESETs are indicated by third information in a second DCI, a second MAC CE, or a second RRC information element, and
the second DCI is received before the first DCI or the first MAC CE.

4. The method of claim 1, further comprising:
receiving, via a second RRC information element, third information for a common search space (CSS) set, wherein the first DCI is received according to the CSS set.

5. The method of claim 1, further comprising:
receiving, via a second RRC information element, third information for a number of combinations of indexes, wherein:
a combination of indexes is a subset of the set of indexes, and
the first number of indexes is a first combination of indexes, from the number of combination of indexes.

6. The method of claim 1, wherein:
the first DCI schedules a physical downlink shared channel (PDSCH) or a physical uplink shared channel (PUSCH),
the first DCI includes a field that provides a bitmap associated with the number of CORESETs, in ascending order of indexes in the set of indexes,
first bits of the bitmap associated with the first CORESETs are set to 1, and
remaining bits of the bitmap, other than the first bits, are set to 0.

7. The method of claim 1, wherein:
first fields in the first DCI have reserved values,
the first fields include at least a frequency domain resource allocation (FDRA) field,
second fields in the first DCI provide a bitmap associated with the number of CORESETs, in ascending order of indexes in the set of indexes,
first bits of the bitmap associated with the first CORESETs are set to 1, and
remaining bits of the bitmap, other than the first bits, are set to 0.

8. A user equipment (UE) comprising:
a transceiver configured to:
receive, via a first radio resource control (RRC) information element, first information for a number of control resource sets (CORESETs), wherein each CORESET is associated with:
a respective index from a set of indexes, and
a respective set of parameters for reception of a physical downlink control channel (PDCCH), and
receive, via a first downlink control information (DCI) or a first medium access control (MAC) control element (CE), second information for a first number of indexes from the set of indexes; and
a processor operably coupled with a transceiver, the processor configured to determine, based on the second information, first CORESETs, from the number of CORESETs, that are associated with the first number of indexes,
wherein the transceiver is further configured to receive a first PDCCH in a first CORESET, from the first CORESETs, based on a respective set of parameters.

9. The UE of claim 8, wherein:
the transceiver is further configured to receive a second PDCCH in a second CORESET,
the second CORESET is not in the number of CORESETs, and
the second PDCCH provides the first DCI or schedules a physical downlink shared channel (PDSCH) that provides the first MAC CE.

10. The UE of claim 8, wherein:
the transceiver is further configured to receive a second PDCCH in a second CORESET,
the second PDCCH provides the first DCI or schedules a physical downlink shared channel (PDSCH) that provides the first MAC CE,
the second CORESET is in second CORESETs from the number of CORESETs,
the second CORESETs are indicated by third information in a second DCI, a second MAC CE, or a second RRC information element, and
the second DCI is received before the first DCI or the first MAC CE.

11. The UE of claim 8, wherein:
the transceiver is further configured to receive, via a second RRC information element, third information for a common search space (CSS) set, and
the first DCI is received according to the CSS set.

12. The UE of claim 8, wherein:
the transceiver is further configured to receive, via a second RRC information element, third information for a number of combinations of indexes,
a combination of indexes is a subset of the set of indexes, and
the first number of indexes is a first combination of indexes, from the number of combination of indexes.

13. The UE of claim 8, wherein:
the first DCI schedules a physical downlink shared channel (PDSCH) or a physical uplink shared channel (PUSCH),
the first DCI includes a field that provides a bitmap associated with the number of CORESETs, in ascending order of indexes in the set of indexes,
first bits of the bitmap associated with the first CORESETs are set to 1, and
remaining bits of the bitmap, other than the first bits, are set to 0.

14. The UE of claim 8, wherein:
first fields in the first DCI have reserved values,
the first fields include at least a frequency domain resource allocation (FDRA) field,
second fields in the first DCI provide a bitmap associated with the number of CORESETs, in ascending order of indexes in the set of indexes,
first bits of the bitmap associated with the first CORESETs are set to 1, and
remaining bits of the bitmap, other than the first bits, are set to 0.

15. A base station comprising:
a transceiver configured to:
transmit, via a first radio resource control (RRC) information element, first information for a number of control resource sets (CORESETs), wherein each CORESET is associated with:
a respective index from a set of indexes, and
a respective set of parameters for transmission of a physical downlink control channel (PDCCH), and
transmit, via a first downlink control information (DCI) or a first medium access control (MAC) control element (CE), second information for a first number of indexes from the set of indexes; and
a processor operably coupled with a transceiver, the processor configured to determine, based on the second information, first CORESETs, from the number of CORESETs, that are associated with the first number of indexes;
wherein the transceiver is further configured to transmit a first PDCCH in a first CORESET, from the first CORESETs, based on a respective set of parameters.

16. The base station of claim 15, wherein:
the transceiver is further configured to transmit a second PDCCH in a second CORESET,
the second CORESET is not in the number of CORESETs, and
the second PDCCH provides the first DCI or schedules a physical downlink shared channel (PDSCH) that provides the first MAC CE.

17. The base station of claim 15, wherein:
the transceiver is further configured to transmit a second PDCCH in a second CORESET,
the second PDCCH provides the first DCI or schedules a physical downlink shared channel (PDSCH) that provides the first MAC CE,
the second CORESET is in second CORESETs from the number of CORESETs,
the second CORESETs are indicated by third information in a second DCI, a second MAC CE, or a second RRC information element, and
the second DCI is transmitted before the first DCI or the first MAC CE.

18. The base station of claim 15, wherein:
the transceiver is further configured to transmit, via a second RRC information element, third information for a number of combinations of indexes,
a combination of indexes is a subset of the set of indexes, and
the first number of indexes is a first combination of indexes, from the number of combination of indexes.

19. The base station of claim 15, wherein:
the first DCI schedules a physical downlink shared channel (PDSCH) or a physical uplink shared channel (PUSCH),
the first DCI includes a field that provides a bitmap associated with the number of CORESETs, in ascending order of indexes in the set of indexes,
first bits of the bitmap associated with the first CORESETs are set to 1, and
remaining bits of the bitmap, other than the first bits, are set to 0.

20. The base station of claim 15, wherein:
first fields in the first DCI have reserved values,
the first fields include at least a frequency domain resource allocation (FDRA) field,
second fields in the first DCI provide a bitmap associated with the number of CORESETs, in ascending order of indexes in the set of indexes,
first bits of the bitmap associated with the first CORESETs are set to 1, and
remaining bits of the bitmap, other than the first bits, are set to 0.
